(19) United States
(12) Patent Application Publication
(10) Pub. No.: US 2008/0137206 A1
(43) Pub. Date: Jun. 12, 2008

(54) Film, Manufacturing Method Thereof, Polarization Plate Using the Film, and Liquid Crystal, and Display Device Using the Polarizing Plate

(75) Inventors: Kazuhiro Nakamura, Kanagawa (JP); Katsumi Inoue, Kanagawa (JP); Yuuzou Muramatsu, Kanagawa (JP); Rikio Inoue, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/794,985

(22) PCT Filed: Feb. 22, 2006
(86) PCT No.: PCT/JP06/03808

§ 371 Date: Jul. 10, 2007

(30) Foreign Application Priority Data
Feb. 22, 2005 (JP) 2005-045993
Feb. 28, 2005 (JP) 2005-053986
Mar. 14, 2005 (JP) 2005-071287
Jul. 5, 2005 (JP) 2005-196514
Jul. 8, 2005 (JP) 2005-200401
Jul. 11, 2005 (JP) 2005-201923

(51) Int. Cl. G02B 1/11; B05D 5/06; G02B 5/30

(52) U.S. Cl. 359/601; 427/162; 359/493

(57) ABSTRACT

A film comprises: a transparent support; and an anti-glare layer having a haze value due to internal scattering of from 0 to 40% and a haze value due to surface scattering of from 0.3 to 20%.

### TECHNICAL FIELD

The present invention concerns an anti-glare film, an anti-reflection film, a manufacturing method thereof, a polarizing plate and an image display device and, more specifically, it relates to an anti-glare film having an anti-glare layer with a predetermined internal scattering property and a predetermined surface scattering property, an anti-reflection film having the anti-glare layer and a low refractive index layer, a manufacturing method thereof, a polarizing plate using the anti-reflection film as a surface protective film, and an image display device using the anti-glare film, the anti-reflection film or the polarizing plate.

### BACKGROUND ART

The anti-glare film has normally a surface scattering property and is disposed to the extreme surface of a display for preventing transfer of images due to reflection of external light in display devices such as CRT, plasma display (PDP), electroluminescent display (ELD), field emission display (FED), surface-conduction Electron-emitter display (SED) or liquid crystal display device (LCD) for preventing transfer of images by the reflection of external light. Further, along with increasing fineness in recent display devices, a technique relating to an anti-glare or light-scattering film having internal scattering property in addition to surface scattering property, has been disclosed as means for improving fine unevenness in the brightness (referred to as dazzling) or as means for improving view field angle characteristics of LCD by the anti-glare film (Japanese Patent No. 3507719 and JP-A No. 2003-270409).

In a case where the light scattering film is used for the uppermost surface of the display device, it has been known that a film also having an anti-reflection function of suppressing surface reflection of an external light in a bright room is preferred.

In recent years, markets for application in which a display device having a large screen is visually observed at a relatively remote position as typically represented by liquid crystal television sets has been extended rapidly. In such application, since the size of pixels at an identical fineness is enlarged and since the distance capable of visually recognized is made longer, the problem of the dazzling described above is mitigated. On the other hand, while an anti-glare film having a high internal scattering property used generally as means for improving the dazzling described above is used also to such application, since high internal scattering property brings about a problem of lowering the contrast in the dark room, this is not always optimal to such application. Further, the display device is often used in a bright room for such application and when a film having the existent anti-glare layer is applied to the surface of the display device, this has resulted in a problem that the surface glistens white entirely in a bright room (hereinafter referred to as white blurring).

On the other hand, in a case of using a display device having a large screen as typically represented by a liquid crystal television set in a wide space such as in a home living room, the screen is viewed not at the front but often from a position at an angle. In a case of using an anti-glare and anti-reflection film for the surface of a liquid crystal television set for home use, since the surface whitening is strengthened when the scattering property of the reflection light at the surface (surface haze value) is increased, it is desirable that the surface haze value is decreased to some extent. On the other hand, in a case of decreasing the surface haze value to less than a predetermined value, images are reflected to the surface of the display device to result in a problem of lowering the contrast in a bright place. In this case, while it is necessary to lower the reflectivity and prevent image reflection, an anti-reflection film capable of satisfying the performances simultaneously has not yet been proposed.

### DISCLOSURE OF THE INVENTION

In summary, it has not yet been present at present an anti-glare film or an anti-reflection film capable of satisfying prevention of the degradation of the anti-glare property and the contrast in a dark room, improving the dazzling, suppressing the whitening at the surface in a bright room, and preventing the image reflecting in the surface.

Accordingly, an object of the present invention is to provide an anti-glare film or an anti-reflection film capable of decreasing the worsening of the contrast in a dark room, improving the dazzling, suppressing the whitening at the surface in a bright room, and preventing the image reflection in the surface.

Another object of the invention is to provide a manufacturing method capable of manufacturing the film at a high productivity.

Further, it is other object of the invention to provide a polarizing plate and a liquid crystal display device using the film.

The present inventors have made an earnest study in order to overcome the foregoing subjects and, as a result, have found that the foregoing subjects can be solved to attain the object by adopting the following constitution, and have accomplished the invention.

That is, the invention includes the followings.

1. An anti-glare film comprising: a transparent support; and an anti-glare layer having a haze value due to internal scattering of from 0 to 40% and a haze value due to surface scattering of from 0.3 to 20%.
2. An anti-reflective film comprising: a transparent support; an anti-glare layer having a haze value due to internal scattering of from 0 to 40% and a haze value due to surface scattering of from 0.3 to 20%; and a low refractive layer, in this order.
3. A film according to 1 or 2 described above, wherein the anti-glare layer has the haze value due to the internal scattering of from 5 to 30% and the haze value due to surface scattering of from 1 to 15%.
4. A film according to any one of 1 to 3 described above, which has Roughness Average Ra of from 0.03 to 0.35 μm.
5. A film according to 4 described above, wherein the Roughness Average Ra of the film is from 0.08 to 0.30 μm.
6. A film according to any one of 1 to 5, described above, which has an average top-to-bottom distance Sm of from 50 to 150 μm.
7. A film according to any one of 1 to 6 described above, which has an image clarity, according to JIS K 7105, of from 5 to 90% as measured at an optical comb width of 0.5 mm.
8. A film according to 7 described above, wherein the image clarity according to JIS K 7105 is from 5 to 30% as measured at an optical comb width of 0.5 mm.
9. A film according to any one of 1 to 8 described above, wherein the anti-glare layer comprises a translucent resin and fine translucent particles, and the translucent resin comprises three or higher functional (meth)acrylate monomer as a main ingredient.
10. A film according to 9 described above, wherein at least one kind of fine translucent particles with an average particle size of from 0.5 to 10 μm are dispersed in the translucent resin.
11. A film according to 9 or 10 described above, wherein the fine translucent particles are contained by 3 to 30 mass % in the entire solid content of the anti-glare layer.
12. A film according to any one of 9 to 11 described above, wherein an absolute value for the difference in refractive index between the fine translucent particles and the translucent resin is from 0.001 to 0.050.
13. A film according to any one of 9 to 12 described above, wherein the fine translucent particles are acrylic particles, styrene particles, or acrylic-styrene particles.
14. A film according to 13 described above, wherein the fine translucent particles comprise a crosslinked poly(meth)acrylate polymer with an acrylic content of from 50 to 100 mass %.
15. A film according to any one of 9 to 14 described above, wherein at least one kind of fine inorganic particles are contained in the anti-glare layer, and at least one of said at least one kind of the fine inorganic particles has a refractive index higher than that of the translucent resin.
16. A film according to any one of 6 to 9 described above, wherein at least one kind of fine inorganic particles are contained in the anti-glare layer, and at least one of said at least one kind of the fine inorganic particles has a refractive index lower than that of the translucent resin.
17. A film according to any one of 1 to 16 described above, wherein the anti-glare layer is formed by using a solvent comprising plural kinds of solvents, the plural kinds of solvents comprise a main solvent not dissolving the transparent support and a small amount solvent, and weight ratio between the main solvent and the small amount solvent is between 99:1 and 50:50.
18. A film according to any one of 1 to 13 described above, wherein the anti-glare layer has a refractive index (na) of 1.50 or more.
19. A film according to 18 described above, wherein the anti-glare layer has the refractive index (na) of 1.55 or more.
20. A film according to any one of 9 to 19 described above, wherein the fine translucent particles comprise a crosslinked poly(styrene-acryl) copolymer with a styrene content of from 50 to 100 mass %.
21. A film according to any one of 2 to 20 described above, wherein the low refractive index layer comprises a fluoro-containing compound containing fluorine atoms within a range from 35 to 80 mass % and containing a crosslinkable or polymerizable functional group.
22. A film according to any one of 2 to 21 described above, wherein a curing composition used upon forming the low refractive index layer is a composition containing at least two of a fluoro-containing compound, fine inorganic particles and an organosilane compound.
23. A film according to 22 described above, wherein the low refractive index layer comprises fine inorganic particles, and the fine inorganic particles has an average particle size of 10% or more and 100% or less of a thickness of the low refractive index layer.
24. A film according to 22 or 23 described above, wherein the fine inorganic particles comprises, as a main ingredient, silicon oxide having a hollow structure and having a refractive index of from 1.17 to 1.40.
25. A film according to any one of 2 to 24 described above, wherein the low refractive index layer has an refractive index (nb) of 1.45 or less.
26. A film according to any one of 1 to 25 described above, wherein at least one of the anti-glare layer and the low refractive index layer comprises at least one member selected from the group consisting of organosilane, hydrolyze of the organosilane and partial condensate of the hydrolyzate of the organosilane.
27. A film according to any one of 1 to 26 described above, wherein the transparent conductive layer is present between the anti-glare layer and the transparent support, or between the anti-glare layer and the low refractive index layer.
28. A film according to any one of 1 to 27 described above, further comprising a transparent conductive layer between the anti-glare layer and the transparent support, wherein the anti-glare layer comprises conductive particles.
29. A film according to any one of 2 to 28 described above, wherein a difference na−nb between a refractive index (na) of the anti-glare layer and a refractive index (nb) of the low refractive index layer is 0.08 or more and 0.35 or less.
30. A film according to any one of 2 to 29 described above, wherein a light amount I^{45°} reflected in a direction inclined at +45°relative to a light amount 10 which is incident being inclined at −60° relative to a vertical direction from the side of the low refractive index layer satisfies the following equation (1):

5.0≧−LOG₁₀(I^{45°}/I₀)≧3.8 Equation (1)

31. A film according to 30 described above, wherein a light amount I^{50°} reflected in a direction inclined at +50° and a light amount I^{40°} reflected in the direction being inclined at +40° relative to the light amount I₀ satisfy the following equations (2) and (3):

4.0≧LOG₁₀(I^{50°}/I₀)≧3.0 Equation (2)

5.5≧LOG₁₀(I^{40°}/I₀)≧4.5 Equation (3)

32. A method of manufacturing a film according to any one of 1 to 31 described above comprising: coating a coating composition for use in an anti-glare layer containing fine translucent particles, a translucent resin and a solvent and/or a coating composition for use in a low refractive index layer while bringing a land at a top end lip of a slot die closer to a surface of a web of the transparent support running continuously being supported by a back-up roll, from a slot of the top end lip, to coat the anti-glare layer and/or low refractive index layer on the transparent support.
33. A polarizing plate comprising: a polarization film; and two protective films attached to both of a front face and a rear face of the polarization film to protect the front and rear faces, wherein one of the two protective films is a film according to any one of 1 to 31.
34. A polarizing plate according to 33 described above, wherein one of the two protective films is a film according to any one of claims 1 to 31 and the other one of the two protective films is an optical compensation film.
35. An image display device comprising a film according to any one of 1 to 31 described above or a polarizing plate according to 33 or 34 described above.
36. A liquid crystal display device comprising at least one of a film according to 1 to 31 and a polarizing plate according to 33 or 34 described above.

In the invention, the following embodiments are also preferred.

37. A film according to any one of 1 to 31 described above, wherein the haze value due to internal scattering of the anti-glare layer is from 5 to 20% and the haze value by the surface scattering is from 1 to 10%.
38. A film according to any one of 1 to 31 described above, wherein the haze value due to internal scattering of the anti-glare layer is from 5 to 30% and the haze value by the surface scattering is from 2 to 7%.
39. A film according to any one of 1 to 31 described above, wherein the haze value due to internal scattering of the anti-glare layer is from 5 to 15% and the haze value by the surface scattering is from 2 to 7%.
40. A film according to any one of 9 to 31 described above, wherein the absolute value for the difference of refractive index between the fine translucent particles and the translucent resin is from 0.001 to 0.030.
41. A film according to any one of 9 to 31 described above, wherein the difference nc−nd between the refractive index (nc) of the fine translucent particle contained in the anti-glare layer and the refractive index (nd) of the fine translucent particle is 0.04 or more and the refractive index nc of the translucent resin is 1.54 or more.
42. A film according to any one of 9 to 31 described above, wherein the fine translucent particle is a crosslinked poly(styrene-acryl) copolymer with the acryl content of from 50 to 100 mass %.
43. A film according to 17 described above, wherein the vapor pressure of the small amount solvent is lower than that of the main solvent at any optional temperature within a range from 20 to 30° C.
44. A film according to 29 described above, wherein the difference na−nb between the refractive index (na) of the anti-glare layer and the refractive index (nb) of the low refractive index layer is 0.17 or more and 0.35 or less.
45. A polarizing plate according to 34 described above, wherein a film not containing the film according to any one of 1 to 31 described above in the two protective films for forming the polarizing plate is an optical compensation film comprising a plurality of layers and containing an optically anisotropic film on the surface opposite to the surface bonded with the polarization film, the optically isometric layer is a layer comprising a compound having a discotic structural unit, the disc surface of the discotic structural unit is inclined to the surface of the protective film, and the angle formed between the disc surface of the discotic structural unit and the surface of the protective film changes in the direction of the depth of the optically isometric layer.
46. A liquid crystal display device according to 36 described above, wherein the diagonal size of the display screen is 20 inch is more.

### BRIEF DESCRIPTION OF THE INVENTION

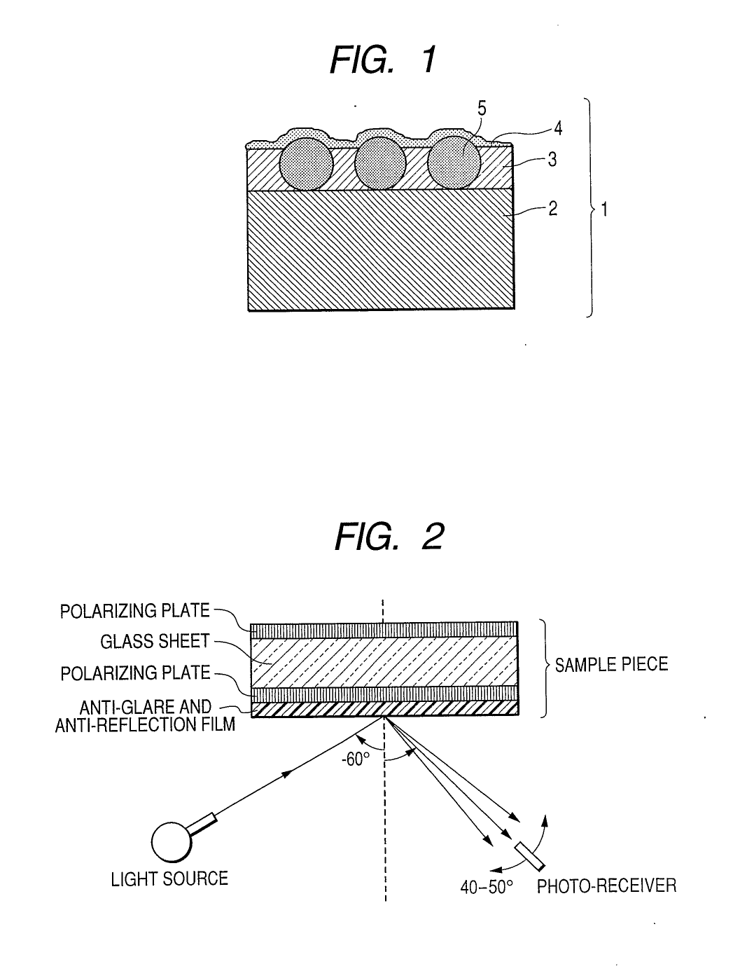

FIG. 1 is a cross sectional view schematically showing a preferred embodiment of an anti-glare and anti-reflection film having anti-glare property;

FIG. 2 is a schematic view of a device for measuring the amount of reflection light in the direction of 40 to 50° upon incidence from the direction of −60° relative to the anti-glare and anti-reflection film of the invention;

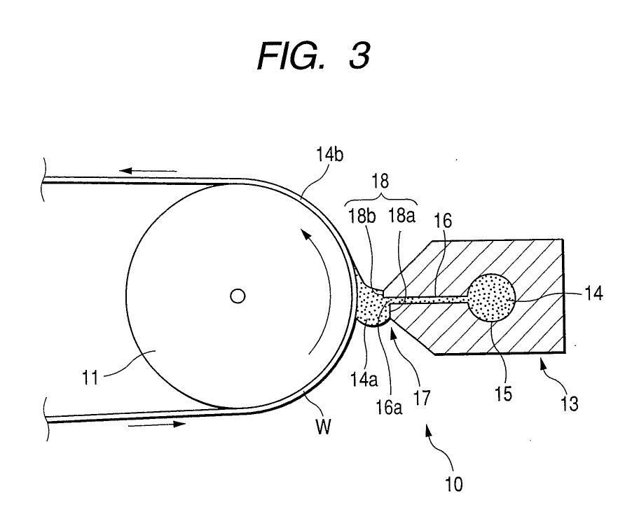

FIG. 3 is a cross sectional view of a coater using a slot die for practicing the invention;

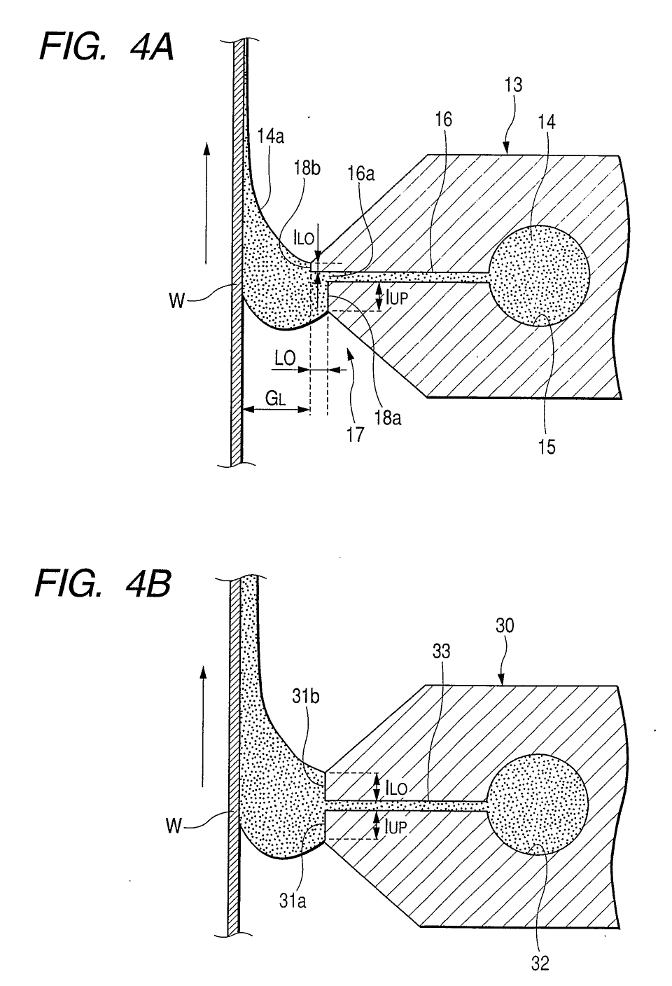

FIG. 4A shows a cross sectional shape of a slot die according to the invention;

FIG. 4B is a view showing a cross sectional shape of an existent sloe die;

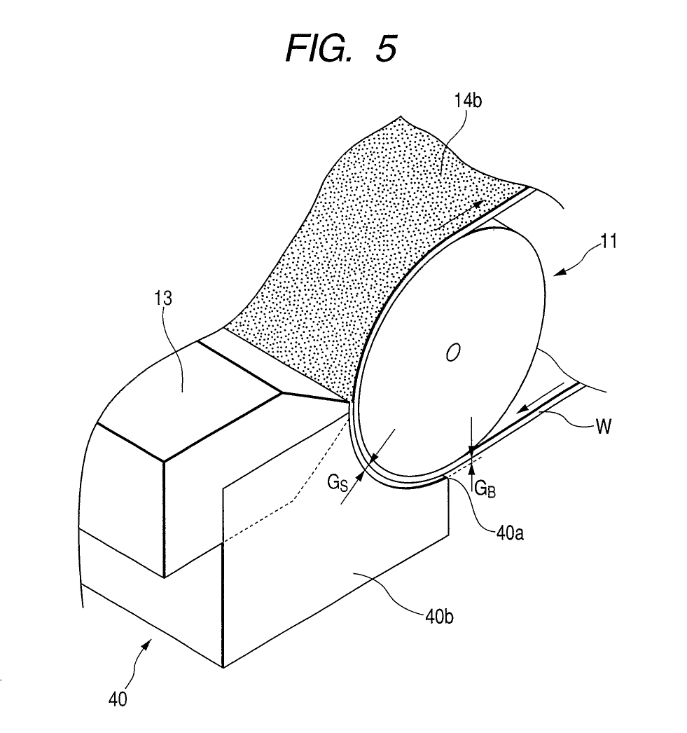

FIG. 5 is a perspective view showing a slot die and the vicinity thereof in a coating step for practicing the invention;

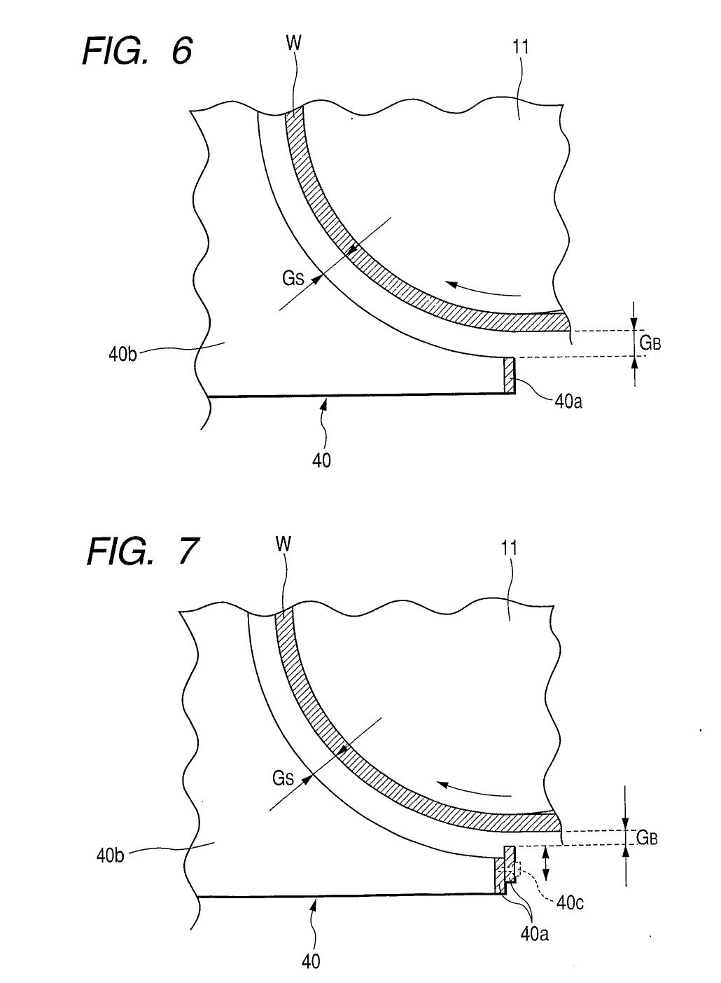

FIG. 6 is a cross sectional view showing a pressure reduction chamber and a web W adjacent with each other (back plate 40a being integrated with chamber 40);

FIG. 7 is a cross sectional view showing a pressure reduction chamber and a web W adjacent with each other (back plate 40a retained by a screw 40c to chamber 40).

1 denotes an anti-glare film (anti-reflection film); 2 denotes a transparent support; 3 denotes an anti-glare layer; 4 denotes a low refractive index layer; 5 denotes a translucent particle; 10 denotes a coater; 11 denotes a back-up roll; W denotes a web; 13 denotes a slot die; 14 denotes a coating solution; 14a denotes a bead; 14b denotes a coating film; 15 denotes a pocket; 16 denotes a slot; 16a denotes a slot opening; 17 denotes a top end lip; 18 denotes a land; 18a denotes an upstream lip land; 18b denotes a downstream lip land; I_{UP} denotes a land length of upstream lip land 18a; I_{LO} denotes a land length of downstream lip land 18b; LO denotes an overbite length (difference between the distance from the down stream lip land 18b to the web W and that from the upstream lip land 18a to the web W); G_{L} denotes a gap between the top end lip 17 and the web W (gap between the downstream lip land 18b and the web W); 30 denotes an existent slot die; 31a denotes an upstream lip land; 31b denotes a downstream lip land; 32 denotes a pocket; 33 denotes a slot; 40 denotes a pressure reduction chamber; 40a denotes a back plate; 40b denotes a side plate; 40c denotes a screw; G_{B} denotes a gap between the back plate 40a and web W; and G_{S} denotes a gap between the side plate 40a and web W

### BEST MODE FOR CARRYING OUT THE INVENTION

The present invention is to be described more specifically. In the present specification, in a case where numerical values represent physical property values, characteristic values, etc., “(numerical value 1) to (numerical 2)” means “(numerical value 1) or more and (numerical value 2) or less”. Further, in the present specification, description “(meth)acrylate” means “at least one of acrylate and methacrylate”. This also applies to “(meth)acrylic acid”, etc.

A fundamental constitution of a preferred embodiment is to be described for the film of the invention with reference to the drawings.

FIG. 1 is a cross sectional view schematically showing a preferred embodiment of a film according to the invention.

A film 1 of this embodiment shown in FIG. 1 comprises a transparent support 2, an anti-glare layer 3 formed on the transparent support 2, and a low refractive index layer 4 formed on the anti-glare layer 3. By forming a low refractive index layer at a film thickness of about ¼ of the wavelength of a light on the anti-glare layer, surface reflection can be decreased due to the principle of thin film interference. Additionally, the anti-glare film of the invention has at least an anti-glare layer 3 on the transparent support 2. Also, the anti-reflection film of the invention has at least an anti-glare layer 3 and a low refractive index layer 4 on the transparent support 2. Hereinafter, a film having both the anti-glare layer 3 and the low refractive index layer 4 is referred to as “an anti-glare and anti-reflection film”.

The anti-glare layer 3 preferably comprises a translucent resin and fine translucent particles 5 dispersed in the translucent resin.

The refractive index for each of the layers constituting the anti-glare and anti-reflection film in the invention preferably satisfies the following relation:

Refractive index of anti-glare layer>refractive index of transparent support>refractive index of low refractive index layer

In the invention, the anti-glare layer having the anti-glare property preferably has both the anti-glare property and a hard coating property together and while an example formed of one layer is shown in this embodiment, it may be comprised of plural layers, for example, two to four layers. Further, for anti-static purpose, a transparent conductive layer is preferably provided with the anti-glare layer 3 and the transparent support 2 or between the anti-glare layer 3 and the low refractive index layer 4 and it is particularly preferred that the transparent conductive layer is provided between the anti-glare layer 3 and the transparent support 2. Further, it is particularly effective for the antistatic purpose to have a transparent conductive layer between the anti-glare layer 3 and the transparent support 2 and have conductive particles in the anti-glare layer. Between the anti-glare layer 3 and the transparent support 2, a functional layer such as an anti-moistening layer may also be provided in addition to the transparent conductive layer.

Further, the difference na−nb between the refractive index (na) of the anti-glare layer and the refractive index (nb) of the low refractive index layer is 0.04 or more and is preferably from 0.08 or more and 0.35 or less, more preferably, 0.17 or more and 0.35 or less and, even more preferably, 0.20 or more and 0.30 or less. Within the range of the difference of the refractive index, the reflectivity can be lowered sufficiently to prevent transfer of reflected images to the surface sufficiently, the film strength is increased, and increase of color can be prevented.

The refractive index (na) of the anti-glare layer is preferably 1.50 or more. In order to reduce transfer of images and improve image contrast in a bright room, the refractive index (na) of the anti-glare layer is more preferably, 1.55 or more, further preferably, 1.57 or more and 1.70 or less and, further more preferably, 1.59 or more and 1.66 or less. By increasing the refractive index of the anti-glare layer to the specified value or more, the difference of the refractive index from that of the low refractive index layer can be increased to decrease the reflectivity. On the other hand, in a case of excessively increasing the refractive index, the difference of the refractive index between the translucent particle and the translucent resin increases excessively to increase the internal haze value and, accordingly, this is not preferred. Further, since this restricts the usable material and increases the cost, it is not preferred. In the invention, the refractive index of the anti-glare layer is a value determined from the refractive index of a coated film including the solid content except for translucent particles.

The refractive index (nb) of the low refractive index layer is 1.5 or less, preferably 1.45 or less, more preferably, 1.30 or more and 1.40 or less and, further preferably, 1.33 or more and 1.37 or less. By lowering the refractive index of the low refractive index layer to a specified value or lower, the difference of the refractive index relative to that of the anti-glare layer can be increased to decrease the reflectivity. On the other hand, in a case of decreasing the refractive index excessively, the strength of the low refractive index layer is lowered, which is not preferred. Since the usable material is limited and the cost is increased this is not preferred.

In the anti-glare and anti-reflection film of the invention, the light amount 145 reflected in the direction being inclined at 45° relative to the light amount Iₒ incident being inclined at −60° relative to the vertical direction from the side of the low refractive index layer preferably satisfies the formula (1) described above. FIG. 2 is a schematic view for an optical system for measuring such scattering characteristics. As shown in FIG. 2, it is defined that the direction perpendicular to the surface of the anti-glare and anti-reflection film is 0°, and levorotation relative to the vertical direction is defined as negative and dextrorotation thereto is defined as positive. I₀ in the equation (1) represents the amount of light which is incident in the direction at −60° relative to the low refractive index layer of the anti-glare and anti-reflection film. The amount of incident light can be controlled by a light source.

On the other hand, the light amount of a reflection light measured by a photo-receiver in a case of locating the photo-receiver in +45° direction is defined as I^{45°} (also I^{50°} in the formula (2) and I^{40°} in the formula (3) are values for the amount of light measured in the same manner while locating the photo-receiver in the +50° direction and +40° direction respectively). As the measuring apparatus described above, “Goniophotometer” manufactured by Murakami Shikizai Institute, Co. can be used for example.

In FIG. 2, while I₀ and I^{45°} are measured in a state of bonding the anti-glare and anti-reflection film to the polarizing plate for approaching the condition of black indication of the display device, they may also be measured by using the anti-glare and anti-reflection film alone and treating the surface opposite to the surface having the anti-reflection layer with a black ink into a state with no rear face reflection.

As the value for (−LOG₁₀(I^{45°}/I₀)) in the formula (1) is larger, this means that the scattered light in the 45° direction is decreased and white blurring is improved when observed visually from the 45°. As shown in the formula (1), the value (−LOG₁₀(I^{45°}/I₀)) is preferably from 3.8 to 5.0 and, more preferably, 4.2 to 4.7. Within the range, it is possible to prevent the worsening of white blurring and the insufficiency of the anti-glare property in a bright room.

In a case where the light amount I^{50°} reflected in the direction inclined at 50°, the light amount I^{45°} reflected in the direction inclined at 45° and the light amount I^{40°} reflected in the direction inclined at 40° relative to the light of optical amount I₀ which is incident being inclined at −60° relative to the vertical direction satisfy the formulae (2) and (3) respectively, this can improve the white blurring in a wider range of view angle, which is more preferred.

The anti-glare and anti-reflection film of the invention is designed preferably for the surface unevenness shape such that Roughness Average Ra is from 0.03 to 0.35 μm, preferably from 0.08 to 0.3 μm, more preferably from 0.08 to 0.22 μm, even more preferably from 0.08 to 0.18 μm, the 10 point average roughness Rz is 10 times or less Ra, the average top-to-bottom distance Sm is from 50 to 150 μm, preferably, from 50 to 120 μm, the standard deviation for the height of the convex portion from the deepest concave/convex portion is 0.5 μm or less, the standard deviation for the average top-to-bottom distance is 20 μm or less based on the centerline, and the surface at an angle of inclination from 0 to 5° is 10% or more, since sufficient anti-glare property, suppressing the whitening and uniform matt feeling are attained when observed visually. In the present invention, Roughness Average Ra is defined according to “ANSI/ASME B46, 1-1985”. Particularly, a sufficient anti-glare property can be obtained at Ra of 0.08 or more, and occurrence of the problem such as dazzling, surface whitening, etc. upon reflection of an external light can be prevented as Ra of 0.3 or less decreases, which is preferred.

Further, it is preferred that the color of the reflection light in the CIE 1976 L*a*b* color space is: a* value −2 to 2, and b* value −3 to 3 under a C light source, and the ratio between the minimum value and the maximum value of the reflectivity within a range from 380 nm to 780 nm is 0.5 to 0.99 since the color of the reflection light becomes neutral. Further, in a case where b* value of the transmission light under the C light source is 0 to 3, yellowing in the white expression in the application to the display device is decreased preferably.

Further, the anti-glare and anti-reflection film of the invention preferably has optical characteristics such that the haze caused by internal scattering (hereinafter referred to as internal haze) is from 0 to 40%, preferably, from 5% to 30%, further preferably, from 5% to 20% and, particularly preferably from 5 to 15%. In a case of the internal haze of less than 5%, combination of the usable materials is restricted and balance for the anti-glare property and other characteristic values is difficult, as well as this increases the cost. In a case where the internal haze exceeds 40%, the contrast in a dark room is worsened remarkably. Further, tight black feeling is also decreased. Further, the haze caused by surface scattering (hereinafter referred to as surface haze) is from 0.3% to 20%, for example, from 1 to 15%, preferably from 1% to 10%, more preferably from 2% to 7%, and, further preferably, from 2% to 5%. In a case where the surface haze is less than 1%, the anti-glare property is insufficient. In a case where it exceeds 15%, it is not preferred since a problem such as surface whitening occurs upon reflection of the external light.

The combination of the internal haze and the surface haze is, from 0 to 40% of the internal haze and from 0.3 to 20% of the surface haze, for example, preferably, from 5 to 30% of the internal haze and from 1 to 15% of the surface haze, more preferably, from 5 to 30% of the internal haze and from 2 to 7% of the surface haze, further preferably, from 5 to 20% of the internal haze and from 1 to 10% of the surface haze and, most preferably, from 5 to 15% of the internal haze and from 2 to 5% of the surface haze.

The surface haze and the internal haze can be measured by the following procedures.

(1) The entire haze value (H) is measured according to JIS-K7136.
(2) Haze is measured by adding several droplets of a silicone oil to the surface of the film on the side of the low refractive index layer and the rear face thereof, sandwiching the same at the rear face and the surface by using two glass sheets each of 1 mm thickness (micro slide glass No. S 9111, manufactured by MATUNAMI) to completely adhere the two sheets of glass and film optically in a state of removing the surface haze, and a value obtained by subtracting the haze separately measured by sandwiching only the silicone oil between the two glass sheets is calculated as the internal haze (Hi) of the film.
(3) The value obtained by subtracting the internal haze (Hi) calculated according to (2) from the entire haze (H) measured according to (1) above is calculated as the film surface haze (Hs).

In the anti-glare and anti-reflection film of the invention, it is preferred that the image clarity according to JIS K 7105 is from 5% to 90%, preferably, from 5% to 80%, more preferably from 5% to 60%, more preferably from 5% to 30%, most preferably from 12% to 30%, when measured at an optical comb width of 0.5 mm since sufficient anti-glare property can be made compatible with improvement for image blurring and lowering of the contrast in a dark room. Further, it is preferred that the specular reflectivity is 2.5% or less and the transmittance is 90% or more since the reflection of the external light can be suppressed to improve the visibility. The specular reflectivity is in particular preferably 2.0% or less, more preferably 1.5% or less, most preferably 1.0% or less.

The anti-glare layer is to be described below.

### [Anti-Glare Layer]

The anti-glare layer is formed with an aim of providing a film with the anti-glare property due to surface scattering and, preferably, the hard coating property for improving the scratch resistance of the film. Accordingly, it preferably contains a translucent resin capable of providing the hard coating property, fine translucent particles for providing the anti-glare property and a solvent.

### <Fine Translucent Particles>

The average grain size of the fine translucent particle is, preferably, from 0.5 to 10 μm and, more preferably, 2.0 to 6.0 μm. At an average grain size of 0.5 μm or more, the distribution of the scattering angle of light is satisfactory with no worry of bringing about character blurring in the display. Further, at 10 μm or less, since the thickness of the anti-glare layer is not increased as well, curl does not increase and the material cost can be suppressed.

Specific examples of the fine translucent particles include resin particles such as acrylic particles, styrenic particles or acrylic-styrenic particles, inorganic particles including silica as a main component and preferred are, for example, resin particles such as poly((meth)acrylate) particles, crosslinked poly((meth)acrylate) particles, polystyrene particles, crosslinked polystyrene particles, crosslinked poly(acryl-styrene) particles, melamine resin particles, and benzoguanamine resin particles. Among them, crosslinked resin particles are preferred and crosslinked polystyrene particles, crosslinked poly((meth)acrylate) particles and crosslinked (acryl-styrene) particles are used preferably. By controlling the refractive index of the translucent resin conforming to the refractive index of each of the fine translucent particles selected from the particles described above, the internal haze, the surface haze, and the average centerline roughness of the invention can be attained. Specifically, a combination of a translucent resin comprising 3- or higher functional (meth)acrylate monomer as a main ingredient (refractive index after curing of from 1.50 to 1.53) used preferably for the anti-glare layer of the invention as will be described later and fine translucent particles comprising the crosslinked poly(meth)acrylate polymer with the acryl content of 50 to 100 mass % is preferred and, particularly, a combination of the translucent resin described above and fine translucent particles comprising the crosslinked poly(styrene-acryl) copolymer (refractive index from 1.48 to 1.54) is preferred.

Further, in the case of using a translucent resin having a refractive index after curing of from 1.55 to 1.70, preferably from 1.56 to 1.70, more preferably from 1.58 to 1.65 for the anti-glare layer as described later, the translucent resin is preferably combined with fine translucent particles comprising a crosslinked poly(meth)acrylate polymer having the styrene content of from 50 to 100 mass % and/or benzoguanamine particles and, a combination of the translucent resin described above and fine translucent particles comprising a crosslinked poly(styrene-acryl) copolymer with the styrene content of from 50 to 100 mass % (refractive index; 1.54 to 1.59) is particularly preferred.

Further, two or more kinds of fine translucent particles of different particle sizes may also be used together. It is possible to provide the anti-glare property by the fine translucent particles of a larger grain size and decrease the rough feeling at the surface by the fine translucent particles of a smaller particle size.

The refractive index of the translucent resin and the fine translucent particle in the invention is preferably, from 1.45 to 1.70 and, more preferably, from 1.48 to 1.65. The refractive index can be made in the range described above by properly selecting the kind and the ratio of amount for the translucent resin and the fine translucent particle. It is preferred that how to select them is previously determined experimentally.

Further, the difference of the refractive index between the translucent resin and the fine translucent particle (refractive index of the fine translucent particle—refractive index of the translucent resin) in the invention is, from 0.001 to 0.100, preferably from 0.001 to 0.050, more preferably from 0.001 to 0.040, further preferably from 0.001 to 0.030 and, particularly preferably from 0.001 to 0.020 and, optimally from 0.001 to 0.015 as the absolute value. Within the range described above, problems such as blurring of characters on a film, lowering of the contrast in a dark room and surface turbidity, etc. do not occur.

The refractive index of the translucent resin can be evaluated quantitatively by direct measurement by an Abbe refractometer, or by measurement for spectral reflection spectrum or spectral ellipsometry. The refractive index of the fine translucent particle is measured by dispersing fine translucent particles in an equal amount to a solvent the refractive index of which is changed by changing the mixing ratio of two kinds of solvents of different refractive indexes, measuring the turbidity, and measuring the refractive index of the solvent by the Abbe refractometer when the turbidity is minimized.

The translucent particles are blended so as to be contained by 3 to 30 mass % in the entire solid content of the anti-glare layer in the thus formed anti-glare layer. It is more preferably, 5 to 20 mass %. At 3 mass % or more, a sufficient anti-glare property can be obtained and, at 30 mass % or less, problems such as images blurring, surface turbidity and dazzling do not occur.

Further, the density of the fine translucent particles is, preferably, from 10 to 1000 mg/m² and, more preferably, from 100 to 700 mg/m².

The thickness of the anti-glare layer is from 1 to 30 μm, for example, preferably from 1 to 10 μm, more preferably from 1.2 to 8 μm, and, particularly preferably from 2.0 to 7 μm. Within the range, insufficiency of the hardness, worsening of curl or fragility, and lowering of fabricability can be prevented.

### <Translucent Resin>

The refractive index of the translucent resin is 1.50 or more, preferably 1.51 or more, more preferably, 1.56 or more and 1.70 or less and, further preferably, 1.58 or more 1.65 or less. The refractive index can be within the range described above by properly selecting the kind and the ratio of the amount of the translucent resin. Inorganic particles having a higher refractive index than that of the translucent resin discussed later can be used for increasing the refractive index. It is preferred that how to select them is experimentally determined beforehand.

The translucent resin is preferably a binder polymer having a saturated hydrocarbon chain or polyether chain as a main chain and a binder polymer having the saturated hydrocarbon chain as the main chain is further preferred. Further, the binder polymer preferably has a crosslinked structure.

As the binder polymer having the saturated hydrocarbon chain as the main chain, a polymer of ethylenically unsaturated monomers is preferred. As the binder polymer having the unsaturated hydrocarbon chain as the main chain and having the crosslinked structure, a (co)polymer monomer having two or more ethylenically unsaturated groups is particularly preferred.

The monomer having two or more ethylenically unsaturated groups includes esters of polyhydric alcohols and (meth)acrylic acid [for example, ethylene glycol di(meth)acrylate, butanediol di(meth)acrylate, hexanediol di(meth)acrylate, 1,4-cyclohexane diacrylate, pentanerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, and polyester polyacrylate], ethylene oxide modified products or caprolacton modified products of the esters described above, vinylbenzene, and derivatives thereof [for example, 1,4-divinylbenzene, 4-vinyl benzoic acid-2-acryloyl ethyl ester, 1,4-divinyl cyclohexanone], vinyl sulfone (for example, divinyl sulfone), acrylamide [for example, methylene bis acrylamide), and methacrylamide. Two or more of the monomers may be used in combination.

For reducing the surface reflection of the anti-glare and anti-reflection film sufficiently, it is desirable to make the difference of refractive index larger between the anti-glare layer and the low refractive index layer and it is preferred to make the refractive index of the anti-glare layer higher. As will be described later, while the refractive index may be increased by a method of dispersing fine inorganic particles of high refractive index in the binder of the anti-glare layer, this involves various drawbacks such that the transmission light is scattered to result in unnecessary internal haze unless the particle size of the fine inorganic particles is sufficiently small, the starting material is expensive to increase the cost depending on the kind of the fine inorganic particles, and drawbacks such as increase of defects due to agglomeration of the fine inorganic particles, and change of the surface haze due to the change of the agglomerated state of the resin particles caused by the increase of the binder viscosity before curing due to the fine inorganic particles. In view of the above, it is desirable to increase the refractive index of the anti-glare layer by making the refractive index of the binder polymer per se higher, without using fine inorganic particles of high refractive index. The refractive index of the binder polymer can be made higher by selecting and using a monomer or an oligomer of high refractive index containing an aromatic ring or at least one of atoms selected from halogen atoms other than fluorine, sulfur atom, phosphorus atom and nitrogen atom in the monomer structure, or a monomer or an oligomer having a fluorene skeleton in the molecule. Specific examples of the high refractive index monomer include (meth)acrylates having a fluorene skeleton, (meth)acrylates having a urethane structure, bis(4-methacryloyl thiophenyl)sulfide, vinyl naphthalene, vinyl phenylsulfide, 4-methacryloxyphenyl-4′-methoxyphenyl thioether, etc. Two or monomers may also be used in combination.

Further the translucent resin preferably comprises a tri- or higher functional (meth)acrylate monomer as the main ingredient. By forming the translucent resin with such a monomer, hardness of the anti-glare layer can be increased to provide an effect capable of providing a hard coating property at a less film thickness.

“Light permeable resin comprising 3- or higher functional (meth)acrylate monomer as the main ingredient” means that a resin component comprising tri or higher functional (meth)acrylate monomer are contained by 40 to 100 mol % in the translucent resin. The content of the recurring unit comprising the 3- or higher (meth)acrylate monomer is, preferably, from 60 to 100 mol %.

The polymerization of the monomer having the ethylenically unsaturated groups can be conducted by irradiation of ionization radiation or heating under the presence of a photo-radical initiator or a thermo-radical initiator.

Accordingly, the anti-glare layer can be formed by preparing a coating solution containing a monomer for forming the translucent resin such as the ethylenically unsaturated monomer described above, a photo-radical initiator or thermo-radical initiator, fine translucent particles and, optionally, an inorganic filler as will be described later, the coating solution on a transparent support and then curing the same by polymerizing reaction by ionization radiation or under heating.

The photo-radical (polymerization) initiator includes acetophenons, benzoins, benzophenons, phosphine oxides, ketals, anthraquinones, thioxantones, azo compound, peroxides, 2,3-dialkyldione compounds, disulfide compounds, fluoroamine compounds; and aromatic sulfoniums. Examples of the acetophenons include 2,2-diethoxyacetophenone, p-dimethylacetophenone, 1-hydroxy dimethylphenyl ketone, 1-hydroxy cyclohexylphenyl ketone, 2-methyl-4-methylthio-2-morpholino propiophenone, and 2-benzyl-2-dimethylamino-1-(4-morpholinophenyl)-butanone. Examples of the benzonins include, benzoin benzene sulfonate ester, benzoin toluene sulfonate ester, benzoin methyl ether, benzoin ethyl ether, and benzoin isopropyl ether. Examples of the benzophenons include benzophenone, 2,4-dichlorobenzophenone, 4,4-dichlorobenzophenone, and p-chlorobenzophenone. Examples of the phosphine oxides include, 2,4,6-trimethyl benzoylphenyl phosphine oxide.

Modern UV Curing Technique (p. 159, published by Kazuhiro Takausu, published from Gijutsu Joho Kyokai Co., in 1991) also describes various examples which are useful for the invention.

Commercially available photo-cleaving type photo-radical (polymerization) initiator includes ILUGACURE (651, 184, 907), etc. manufactured by Ciba Speciality Chemical Co. as a preferred example.

The photo-radical (polymerization) initiator is used, preferably, within a range from 0.1 to 15 mass part and, more preferably, with a range from 1 to 10 mass parts based on 100 mass parts of the polyfunctional monomer.

In addition to the photo-radical (polymerization) initiator, a photosensitizer may also be used. Specific examples of the photosensitizer include n-butylamine, triethylamine, tri-n-butylphosphine, Michler's ketone, and thioxantone.

As the thermo-radical initiator, organic or inorganic peroxides, organic azo and diazo compounds, etc. can be used.

Specifically, they include, for example, benzoyl peroxide, halogen benzoyl peroxide, lauroyl peroxide, acetyl peroxide, dibutyl peroxide, cumene hydroperoxide, and butyl hydroperoxide as the organic peroxides, hydrogen peroxide, ammonium persulfate, and potassium persulfate as inorganic peroxides, and 2-azo-bis-isobutylonitrile, 2-azo-bis-propionitrile, and 2-azo-bis-cyclohexane dinitrile as the azo compounds, and diazoamino benzene and p-nitrobenzene diazonium as the diazo compounds.

As the binder polymer having the polyether as the main chain, ring-opened polymers of polyfunctional epoxy compounds are preferred. The ring-opening polymerization of the polyfunctional epoxy compound can be conducted by irradiation of ionization radiation or heating under the presence of a photo-acid generator or thermo-acid generator.

Accordingly, the anti-glare layer can be formed by preparing a coating solution containing a polyfunctional epoxy compound, a photo-acid generator or thermal acid generator, fine translucent particles and fine inorganic particles and curing the coating solution by polymerizing reaction by ionization radiation or heating on a transparent support.

Instead of or in addition to the monomer having two or more ethylenically unsaturated groups, a crosslinking functional group may be introduced into the polymer by using a monomer having the crosslinkable functional group and introducing the crosslinked structure into the binder polymer by way of the reaction of crosslinking functional groups.

Examples of the crosslinkable functional groups include isocyanate group, epoxy group, aziridine group, oxazoline group, aldehyde group, arbonyl group, hydrozine group, carboxyl group, methylol group, and activated methylene group. Vinyl sulfonic acid, acid anhydride, cyanoacrylate derivative, melamine, etherified methylol, ester and urethane, and metal alkoxide such as tetramethoxy silane can also be utilized as the monomer for introducing the crosslinked structure. A functional group showing the crosslinkability as a result of the decomposing reaction such as a blocked isocyanate group may also be used. That is, the crosslinkable functional group in the invention may be those showing the reactivity as a result of decomposition although not showing the reactivity instantly.

The binder polymer having the crosslinkable functional groups can form a crosslinked structure by heating after coating.

### (Fine Inorganic Particles)

For improving the hardness and controlling the haze value due to internal scattering by controlling the refractive index of the layer, the anti-glare layer may also be incorporated, in addition to the fine translucent particles described above, with fine inorganic particles comprising as a main component an oxide of at least one of metals selected from silicon, titanium, zirconium, aluminum, indium, zinc, tin, and antimony and having an average particle size of 10 μm or less, for example 2 μm or less, preferably 0.2 μm or less, particularly 0.1 μm or less and, more preferably, 0.06 μm or less. Since the fine inorganic particles generally have higher specific gravity than organic materials and can increase the density of the coating solution, they also have an effect of retarding the precipitation rate of the fine translucent particles.

Further, since the fine inorganic particles comprising as a main component the oxide of at least one of metals selected from titanium, zirconium, aluminum, indium, zinc, tin, and antimony have high refractive index, use of such fine organic particles is preferred in order to make the refractive index of the anti-glare layer higher and sufficiently decrease the surface reflection of the anti-glare and anti-reflection film. Further, at least one of the fine inorganic particles preferably has a refractive index higher than that of the translucent resin.

As the inorganic particles, for making the refractive index higher, it is particularly preferred to use oxide of at least one of metals selected from metal oxides comprising as a main component oxides of at least one of metals selected from titanium, zirconium, indium, lead, tin, and antimony and it is particularly preferred to use the oxide of at least one of metals selected from metal oxides comprising as a main component the oxides of at least one of metals selected from titanium and zirconium. Further, for both of them, while zirconium with no photocatalytic effect is preferred in view of the light fastness of the anti-glare layer, it is also preferred to use titanium with suppressed photocatalytic effect.

Further, with a view point of preventing static charges, use of fine conductive inorganic particles is preferred and it is preferred to use an oxide of at least one of metals selected from metal oxides comprising as a main component oxides of at least one of metals selected from indium, zinc, tin, and antimony.

Also, for the purpose of improving hardness and adjusting the refractive index, at least one inorganic particles having a refractive index lower than that of the aforesaid translucent resin may be added. As the inorganic particles having a lower refractive index, silica particles are preferably used. As the silica particles, particles having a particle size of 0.2 μm or less, preferably 0.1 μm or less, more preferably 0.06 μm or less are preferably used.

As another embodiment of the silica particles, there may be used a silica agglomerate (agglomerated silica). It is preferred for the silica particles of a given primary particle size to agglomerate and form fine pores like a continuous network. The agglomerate is particularly preferably formed by particles of several ten nm in primary particle size. The agglomeratable silica can stably provide an appropriate surface haze without increasing internal scattering, thus also being preferably used as the aforesaid translucent particles capable of imparting anti-glare properties. The agglomeratable silica can be used independently or together with other translucent particles or inorganic particles. The agglomeratable silica can be obtained by the so-called wet process of synthesizing them by, for example, the neutral reaction between sodium silicate and sulfuric acid, though the process not being limited to this. The wet process is further roughly classified into two groups: one being a sedimentation process; and the other a gelation process. Either of them may be employed in the invention. The secondary particle size of the agglomerated silica is in the range of preferably from 0.1 to 10.0 μm, and is selected in consideration of the thickness of the hard coat layer containing them. The secondary particle size is controlled in the course of formation of agglomerated silica, or can be controlled by adjusting dispersion degree of the particles (according to mechanical dispersion using a sand mill or the like, or chemical dispersion using a dispersant). It is particularly preferred that the value obtained by dividing the secondary particle size of the agglomerated silica particles by the thickness of the hard coat layer containing them is from 0.1 to 2.0, with 0.3 to 1.0 being more preferred. In the invention, surface-treated agglomeratable silica can also be preferably used.

For the fine inorganic particles used for the anti-glare layer, the surface thereof is also preferably applied with a silane coupling treatment or a titanium coupling treatment, and a surface treating agent having a functional group capable of reacting with binder species is used preferably for the filler surface. The surface treating agent may be mixed into the coating composition in place of previously using for coupling treatment.

In a case of using the fine inorganic particles, the addition amount is, preferably, from 10 to 90%, more preferably, from 20 to 80% and, particularly preferably, from 30 to 75%, based on the total mass of the anti-glare layer.

Such fine inorganic particles do not cause scattering since the grain size thereof is sufficiently smaller than the wavelength of the light and a dispersion in which the filler is dispersed in the binder polymer behaves as an optically uniform substance.

Further, an organosilane compound and derivatives thereof usable in the low refractive index layer to be described later can be used for the anti-glare layer. The addition amount of the organosilane compound and the derivatives thereof is, preferably, from 0.001 to 50 mass %, more preferably, from 0.01 to 20 mass %, further preferably, from 0.3 to 18 mass % and, particularly preferably, from 3 to 15 mass % based on the entire solid content in the anti-glare layer.

### <Surfactant for Use in Anti-Glare Layer>

The anti-glare layer of the invention preferably contains a surfactant of any of fluoro series or silicon series, or both of them in a coating solution for forming the anti-glare layer in order to ensure planar uniformity with no coating unevenness, drying unevenness and spot defects. Particularly, since the fluoro surfactant provides an effect of improving the planar failures such as coating unevenness, drying unevenness, spot defects of the anti-glare and anti-reflection film of the invention, it is used preferably.

It is an object to enhance the productivity by providing high speed coatability while improving the planar uniformity.

Preferred examples of the fluoro surfactant include fluoro aliphatic group-containing polymers (sometimes simply referred to as “fluoro polymers”). For the fluoro polymer, acrylic resins, methacrylic resins and copolymers having vinylic monomers copolymerizable therewith containing recurring units corresponding to the following monomer (i) and recurring units corresponding to the following monomer (ii) are useful.

(i) A fluoro aliphatic group-containing monomer represented by the following general formula (1)

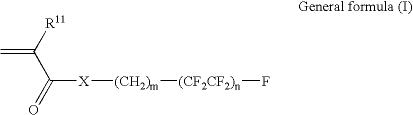

In the general formula (1), R¹¹ represents a hydrogen atom or a methyl group, X represents an oxygen atom, sulfur atom, or —N—(R¹²)—, m represents an integer 1 or greater and 6 or smaller and n represents an integer of from 2 to 4. R¹² represents a hydrogen atom or an alkyl group of 1 to 4 carbon atoms, specifically, a methyl group, ethyl group, propyl group, or butyl group and, preferably, the hydrogen atom or the methyl group. X is preferably an oxygen atom.

(ii) A monomer represented by the following general formula (II) copolymerizable with (i) described above

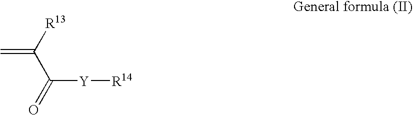

In the general formula (II), R¹³ represents a hydrogen atom or a methyl group, Y represents an oxygen atom, sulfur atom or —N(R¹⁵)—, R¹⁵ represents a hydrogen atom or an alkyl group of 1 to 4 carbon atoms, specifically, a methyl group, ethyl group, propyl group or butyl group, preferably, the hydrogen atom or the methyl group. Y is preferably an oxygen atom, —N(H)—, and —N(CH₃)—.

R¹⁴ represents a linear, branched or cyclic alkyl group or an alkyl group containing a poly(alkyleneoxy) group with 4 or more and 20 or less of carbon atoms.

The substituent for the alkyl group R¹⁴ includes, for example, a hydroxyl group, alkylcarbonyl group, arylcarbonyl group, carboxyl group, alkyl ether group, aryl ether group, a halogen atom such as fluorine atom, chlorine atom, or bromine atom, nitro group, cyano group, or amino group with no particular restriction to them. For the linear, branched or cyclic alkyl groups of 4 or more and 20 or less carbon atoms, butyl group, pentyl group, hexyl group, heptyl group, octyl group, nonyl group, decyl group, undecyl group, dodecyl group, tridecyl group, tetradecyl group, pentadecyl group, octadecyl group, or eicosanyl group, monocyclic cycloalkyl group such as a cyclohexyl group or cycloheptyl group and polycyclic cycloalkyl group such as cycloheptyl group, bicyclodecyl group, tricycloundecyl group, tetracyclododecyl group, adamantyl group, norbonyl group, or tetracyclodecyl group which may be linear or branched can be used suitably.

The amount of the fluoro aliphatic group-containing monomer represented by the general formula (1) used in the fluoro-polymer used in the anti-glare layer of the invention is within a range of 10 mol % or more, preferably, from 15 to 70 mol % and, more preferably, from 20 to 60 mol % based on each monomer of the fluoro polymer.

A preferred mass average molecular weight of the fluoro-polymer used in the anti-glare layer of the invention is, preferably, from 3,000 to 100,000 and, more preferably, 5,000 to 80,000.

Further, a preferred addition amount of the fluoro-polymer used in the anti-glare layer of the invention is within a range from 0.001 to 5 mass %, preferably, within a range from 0.005 to 3 mass % and, more preferably, within a range from 0.1 to 1 mass % based on the coating solution. The effect is sufficient at the addition amount of the fluoro-polymer of 0.001 mass % or more and, at 5 mass % or less, drying of the coating film is conducted sufficiently to obtain a satisfactory performance as the coating film (for example, reflectivity and scratch resistivity).

Now, examples of the specific structure of the fluoro-polymer containing recurring units corresponding to the fluoro aliphatic group-containing monomer represented by the general formula (1) are shown with no particular restriction thereto. Numerical values in the formulae show the molar ratio for each of the monomer ingredients. Mw represents a mass average molecular weight.

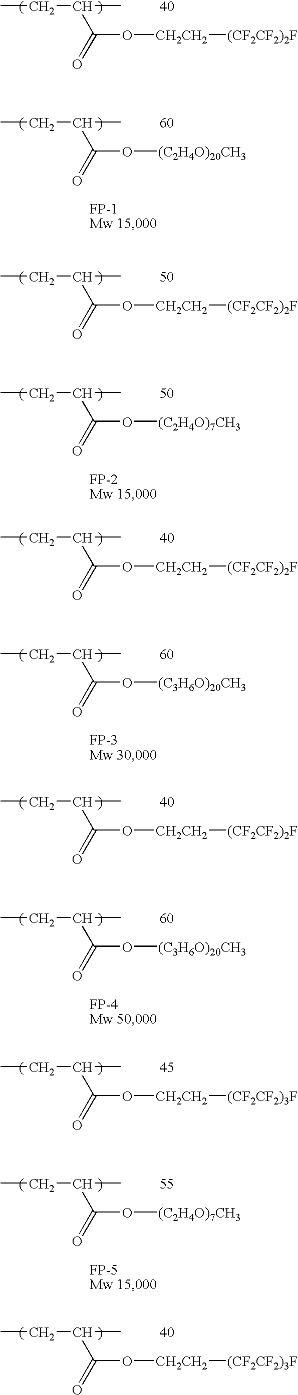

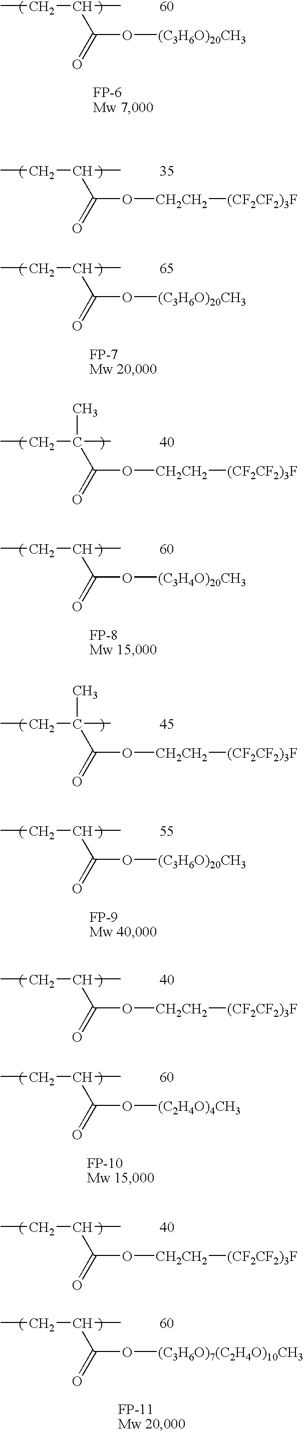

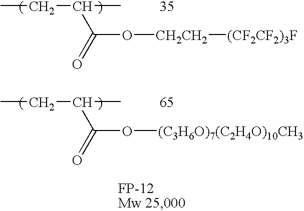

However, use of the fluoro-polymer as described above, may sometimes lower the surface energy of the anti-glare layer by segregation of F atom-containing functional groups to the surface of the anti-glare layer to result in a problem of worsening the anti-reflection performance when the low refractive index layer is overcoated on the anti-glare layer. It is assumed to be attributable to that the wettability of the curable composition used for forming the low refractive index layer is worsened and, accordingly, fine unevenness not detectable with naked eyes is worsened in the low refractive index layer. In order to solve such a problem, it is effective to control the surface energy of the anti-glare layer, preferably, to 20 mN·m⁻¹ to 50 mN·m⁻¹ and more preferably, from 30 mN·m⁻¹ to 40 mN·m⁻¹ by controlling the structure and the addition amount of the fluoro-polymer. For attaining the surface energy as described above, it is necessary that F/C as the ratio of the peak derived from the fluoro-atom and the peak derived from carbon atom is from 0.1 to 1.5.

Further, the purpose can also be attained by selecting the fluoro-polymer that is extracted into the solvent forming the upper layer when the upper layer is coated, whereby it is no more localized to the surface of the lower layer (=boundary layer) to provide close adhesion between the upper layer and the lower layer thereby preventing lowering of the surface free energy capable of keeping the planar uniformity also during high speed coating and providing an anti-reflection film of high scratch resistance to control the surface energy of the anti-glare layer before coating the low refractive index layer to the range described above. Examples of such a material is acrylc resins, methacrylic resins and copolymers with vinylic monomers copolymerizable therewith having a feature of containing recurring units corresponding to the aliphatic group-containing monomer represented by the following general formula (III).

(iii) fluoro aliphatic group-containing monomer represented by the following general formula (III)

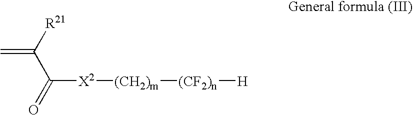

In the general formula (III), R²¹ represents a hydrogen atom or halogen atom, or a methyl group, the hydrogen atom, and the methyl group being more preferred. X² represents an oxygen atom, sulfur atom or —N(R²²)—, the oxygen atom or —N(R²²)— being more preferred and the oxygen atom being further preferred. m represents an integer of 1 or more and 6 or less (more preferably, from 1 to 3, further preferably 1), and n represents an integer of 1 or more and 18 or less (more preferably, from 4 to 12 and, further preferably, 6 to 8). R²² represents a hydrogen atom or an alkyl group of 1 to 8 carbon atoms which may have a substituent, the hydrogen atom or the alkyl group of 1 to 4 carbon atoms being more preferred and the hydrogen atom or a methyl group being further preferred.

Further, two or more of the fluoro aliphatic group-containing monomers represented by the general formula (III) may also be contained as the constituent.

(iv) A monomer copolymerizable with (iii) described above shown by the following general formula (IV) can also be used.

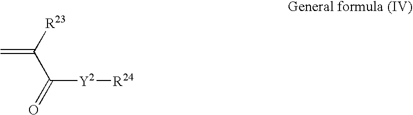

In the general formula (IV), R²³ represents a hydrogen atom, halogen atom or a methyl group, the hydrogen group and the methyl group being are preferred. Y² represents an oxygen atom, sulfur atom, or —N(R²⁵)—, the oxygen atom or —N(R²⁵)— being more preferred and the oxygen atom being further preferred. R²⁵ represents a hydrogen atom or an alkyl group of 1 to 8 carbon atoms, the hydrogen group or the alkyl group of 1 to 4 carbon atoms being more preferred, and the hydrogen group or the methyl group being further preferred.

R²⁴ represents a linear, branched or cyclic alkyl group, of from 1 to 20 carbon atoms which may have a substituent, a poly(alkyleneoxy) group-containing alkyl group, or aromatic group which may have a substituent (for example, phenyl group or naphthyl group). A linear, branched or cyclic alkyl group of 1 to 12 carbon atoms or an aromatic group of 6 to 18 carbon atoms in total is more preferred, a linear, branched or cyclic group of 1 to 8 carbon atoms being further preferred.

Now, examples of the specific structure of the fluoro-polymer containing recurring units corresponding to the fluoro aliphatic group-containing monomer represented by the general formula (III) are shown with no particular restriction thereto. Numerical values in the formulae show the molar ratio for each of the monomer ingredients. Mw represents a mass average molecular weight.

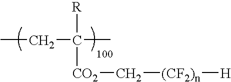

| | R | n | Mw |
|---|---|---|---|
| P-1 | H | 4 | 8000 |
| P-2 | H | 4 | 16000 |
| P-3 | H | 4 | 33000 |
| P-4 | CH₃ | 4 | 12000 |
| P-5 | CH₃ | 4 | 28000 |
| P-6 | H | 6 | 8000 |
| P-7 | H | 6 | 14000 |
| P-8 | H | 6 | 29000 |
| P-9 | CH₃ | 6 | 10000 |
| P-10 | CH₃ | 6 | 21000 |
| P-11 | H | 8 | 4000 |
| P-12 | H | 8 | 16000 |
| P-13 | H | 8 | 31000 |
| P-14 | CH₃ | 8 | 3000 |

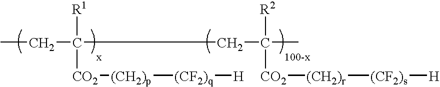

| | x | R¹ | p | q | R² | r | s | Mw |
|---|---|---|---|---|---|---|---|---|
| P-15 | 50 | H | 1 | 4 | CH₃ | 1 | 4 | 10000 |
| P-16 | 40 | H | 1 | 4 | H | 1 | 6 | 14000 |
| P-17 | 60 | H | 1 | 4 | CH₃ | 1 | 6 | 21000 |
| P-18 | 10 | H | 1 | 4 | H | 1 | 8 | 11000 |
| P-19 | 40 | H | 1 | 4 | H | 1 | 8 | 16000 |
| P-20 | 20 | H | 1 | 4 | CH₃ | 1 | 8 | 8000 |
| P-21 | 10 | CH₃ | 1 | 4 | CH₃ | 1 | 8 | 7000 |
| P-22 | 50 | H | 1 | 6 | CH₃ | 1 | 6 | 12000 |
| P-23 | 50 | H | 1 | 6 | CH₃ | 1 | 6 | 22000 |
| P-24 | 30 | H | 1 | 6 | CH₃ | 1 | 6 | 5000 |

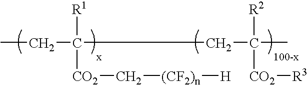

| | x | R¹ | n | R² | R³ | Mw |
|---|---|---|---|---|---|---|
| FP-148 | 80 | H | 4 | CH₃ | CH₃ | 11000 |
| FP-149 | 90 | H | 4 | H | C₄H₉(n) | 7000 |
| FP-150 | 95 | H | 4 | H | C₆H₁₃(n) | 5000 |
| FP-151 | 90 | CH₃ | 4 | H | CH₂CH(C₂H₅)C₄H₉(n) | 15000 |
| FP-152 | 70 | H | 6 | CH₃ | C₂H₅ | 18000 |
| FP-153 | 90 | H | 6 | CH₃ | 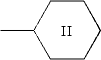 | 12000 |
| FP-154 | 80 | H | 6 | H | C₄H₉(sec) | 9000 |
| FP-155 | 90 | H | 6 | H | C₁₂H₂₅(n) | 21000 |
| FP-156 | 60 | CH₃ | 6 | H | CH₃ | 15000 |
| FP-157 | 60 | H | 8 | H | CH₃ | 10000 |
| FP-158 | 70 | H | 8 | H | C₂H₅ | 24000 |
| FP-159 | 70 | H | 8 | H | C₄H₉(n) | 5000 |
| FP-160 | 50 | H | 8 | H | C₄H₉(n) | 16000 |
| FP-161 | 80 | H | 8 | CH₃ | C₄H₉(iso) | 13000 |
| FP-162 | 80 | H | 8 | CH₃ | C₄H₉(t) | 9000 |
| FP-163 | 60 | H | 8 | H | 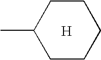 | 7000 |
| FP-164 | 80 | H | 8 | H | CH₂CH(C₂H₅)C₄H₉(n) | 8000 |
| FP-165 | 90 | H | 8 | H | C₁₂H₂₅(n) | 6000 |
| FP-166 | 80 | CH₃ | 8 | CH₃ | C₄H₉(sec) | 18000 |
| FP-167 | 70 | CH₃ | 8 | CH₃ | CH₃ | 22000 |
| FP-168 | 70 | H | 10 | CH₃ | H | 17000 |
| FP-169 | 90 | H | 10 | H | H | 9000 |

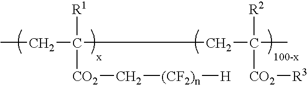

| | x | R¹ | n | R² | R³ | Mw |
|---|---|---|---|---|---|---|
| FP-170 | 95 | H | 4 | CH₃ | —(CH₂CH₂O)₂—H | 18000 |
| FP-171 | 80 | H | 4 | H | —(CH₂CH₂O)₂—CH₃ | 16000 |
| FP-172 | 80 | H | 4 | H | —(C₃H₆O)₇—H | 24000 |
| FP-173 | 70 | CH₃ | 4 | H | —(C₃H₆O)₁₃—H | 18000 |
| FP-174 | 90 | H | 6 | H | —(CH₂CH₂O)₂—H | 21000 |
| FP-175 | 90 | H | 6 | CH₃ | —(CH₂CH₂O)₈—H | 9000 |
| FP-176 | 80 | H | 6 | H | —(CH₂CH₂O)₂—C₄H₉(n) | 12000 |
| FP-177 | 80 | H | 6 | H | —(C₃H₆O)₇—H | 34000 |
| FP-178 | 75 | F | 6 | H | —(C₃H₆O)₁₃—H | 11000 |
| FP-179 | 85 | CH₃ | 6 | CH₃ | —(C₃H₆O)₂₀—H | 18000 |
| FP-180 | 95 | CH₃ | 6 | CH₃ | —CH₂CH₂OH | 27000 |
| FP-181 | 80 | H | 8 | CH₃ | —(CH₂CH₂O)₈—H | 12000 |
| FP-182 | 95 | H | 8 | H | —(CH₂CH₂O)₉—CH₃ | 20000 |
| FP-183 | 90 | H | 8 | H | —(C₃H₆O)₇—H | 8000 |
| FP-184 | 95 | H | 8 | H | —(C₃H₆O)₂₀—H | 15000 |
| FP-185 | 90 | F | 8 | H | —(C₃H₆O)₁₃—H | 12000 |
| FP-186 | 80 | H | 8 | CH₃ | —(CH₂CH₂O)₂—H | 20000 |
| FP-187 | 95 | CH₃ | 8 | H | —(CH₂CH₂O)₉—CH₃ | 17000 |
| FP-188 | 90 | CH₃ | 8 | H | —(C₃H₆O)₇—H | 34000 |
| FP-189 | 80 | H | 10 | H | —(CH₂CH₂O)₃—H | 19000 |
| FP-190 | 90 | H | 10 | H | —(C₃H₆O)₇—H | 8000 |
| FP-191 | 80 | H | 12 | H | —(CH₂CH₂O)₇—CH₃ | 7000 |
| FP-192 | 95 | CH₃ | 12 | H | —(C₃H₆O)₇—H | 10000 |

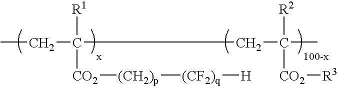

| | x | R¹ | p | q | R² | R³ | Mw |
|---|---|---|---|---|---|---|---|
| FP-193 | 80 | H | 2 | 4 | H | C₄H₉(n) | 18000 |
| FP-194 | 90 | H | 2 | 4 | H | —(CH₂CH₂O)₉—CH₃ | 16000 |
| FP-195 | 90 | CH₃ | 2 | 4 | F | C₆H₁₃(n) | 24000 |
| FP-196 | 80 | CH₃ | 1 | 6 | F | C₄H₉(n) | 18000 |
| FP-197 | 95 | H | 2 | 6 | H | —(C₃H₆O)₇—H | 21000 |
| FP-198 | 90 | CH₃ | 3 | 6 | H | —CH₂CH₂OH | 9000 |
| FP-199 | 75 | H | 1 | 8 | F | CH₃ | 12000 |
| FP-200 | 80 | H | 2 | 8 | H | CH₂CH(C₂H₅)C₄H₉(n) | 34000 |
| FP-201 | 90 | CH₃ | 2 | 8 | H | —(C₃H₆O)₇—H | 11000 |
| FP-202 | 80 | H | 3 | 8 | CH₃ | CH₃ | 18000 |
| FP-203 | 90 | H | 1 | 10 | F | C₄H₉(n) | 27000 |
| FP-204 | 95 | H | 2 | 10 | H | —(CH₂CH₂O)₉—CH₃ | 12000 |
| FP-205 | 85 | CH₃ | 2 | 10 | CH₃ | C₄H₉(n) | 20000 |
| FP-206 | 80 | H | 1 | 12 | H | C₆H₁₃(n) | 8000 |
| FP-207 | 90 | H | 1 | 12 | H | —(C₃H₆O)₁₃—H | 15000 |
| FP-208 | 60 | CH₃ | 3 | 12 | CH₃ | C₂H₅ | 12000 |
| FP-209 | 60 | H | 1 | 16 | H | CH₂CH(C₂H₅)C₄H₉(n) | 20000 |
| FP-210 | 80 | CH₃ | 1 | 16 | H | —(CH₂CH₂O)₂—C₄H₉(n) | 17000 |
| FP-211 | 90 | H | 1 | 18 | H | —CH₂CH₂OH | 34000 |
| FP-212 | 60 | H | 3 | 18 | CH₃ | CH₃ | 19000 |

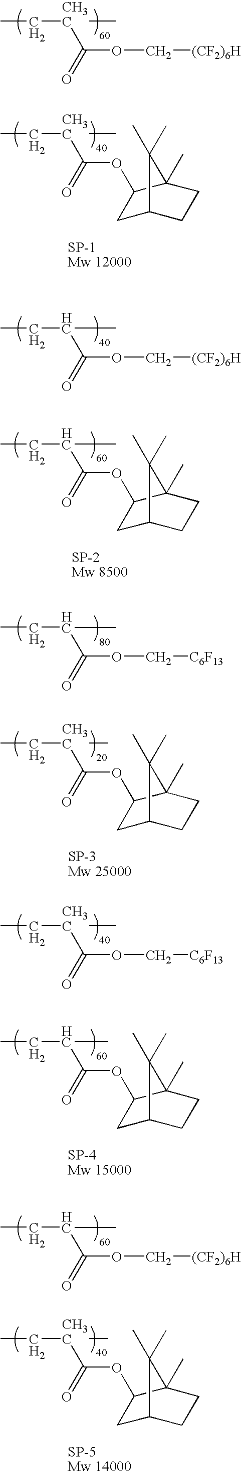

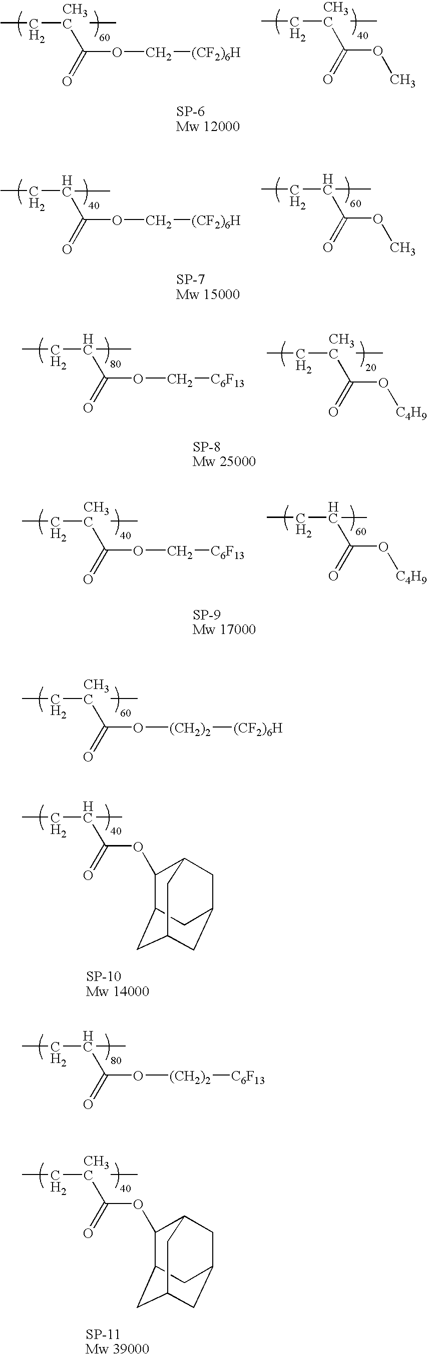

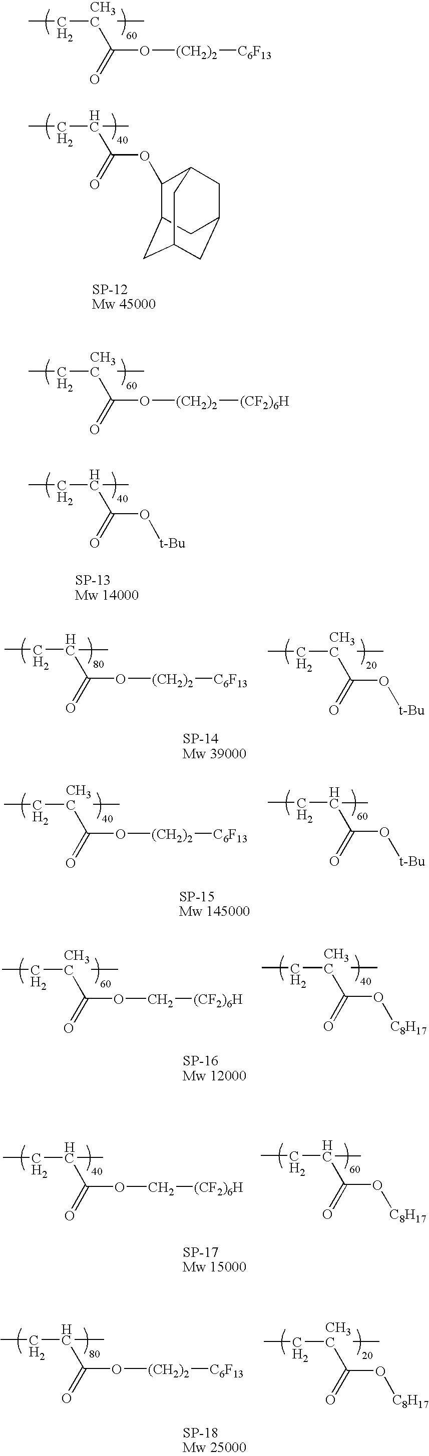

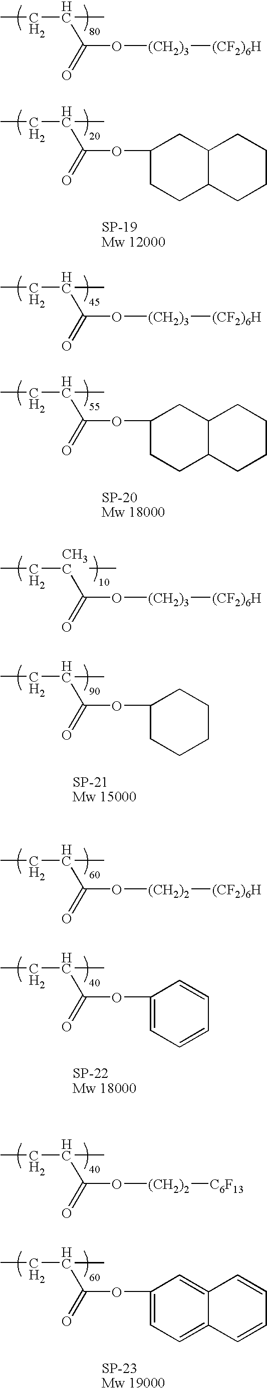

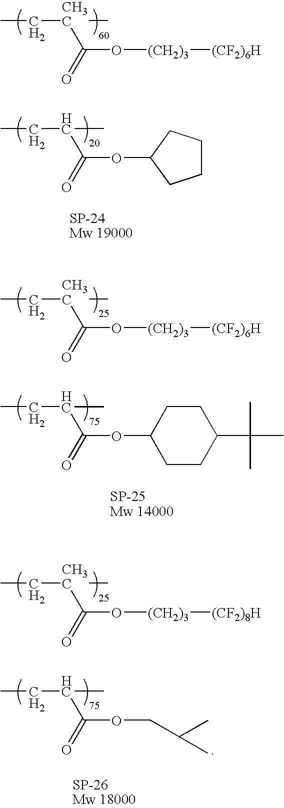

The content of the polymerization unit of a fluoro aliphatic group-containing monomer constituting the fluorine-containing polymer is preferably more than 10% by weight, more preferably from 50 to 100% by weight. In considering it important to prevent unevenness of the hard coat layer, the content is most preferably from 75 to 100% by weight. In a case when a low refractive index layer is coated on the hard coat layer, the content is most preferably from 50 to 75% by weight. (The contents are based on the whole polymerization units constituting the fluorine-containing polymer).

Degradation of the anti-reflection performance can be prevented by preventing the lowering of the surface energy at the instance the low refractive index layer is overcoated on the anti-glare layer. The purpose can be attained also by controlling the surface energy of the anti-glare layer within the range described above before coating the low refractive index layer by increasing the planar uniformity by lowering the surface tension of the coating solution using a fluoro-polymer upon coating the anti-glare layer, thereby maintaining the high productivity due to high speed coating and preventing the lowering of the surface free energy after the coating of the anti-glare layer by using a surface treating method such as a corona treatment, UV treatment, heat treatment, saponifying treatment or solvent treatment, particularly preferably, by the corona treatment.

A mass average molecular weight of the fluoro-polymer is, preferably, from 3,000 to 100,000 and, more preferably, 5,000 to 80,000.

Further, a desired addition amount of the fluoro-polymer is preferably, within a range from 0.001 to 5 mass %, more preferably, within a from 0.005 to 3 mass % and, further preferably, within a range from 0.01 to 1 mass % based on the coating solution. In a case where the addition amount of the fluoro-polymer is less than 0.001 mass %, the effect is insufficient. Further, in a case where it is more than 5 mass %, the coating film may not sometimes be dried sufficiently or it may give undesired effects on the performance as the coating film (for example, reflectivity and scratch resistance).

A thickening agent may be used in the film of the invention in order to adjust viscosity of the coating solution. The thickening agent as used herein means a compound which can increase viscosity of a solution when added to the solution. The degree of an increase in viscosity of the coating solution attained by adding the thickening agent is preferably from 1 to 50 cP, more preferably from 3 to 20 cP, most preferably from 5 to 10 cP.

Examples of such thickening agent include the following ones which, however, are not limitative at all.

Poly-ε-caprolactone
Poly-ε-caprolactone diol
Poly-ε-caprolactone triol
Polyvinyl acetate
Poly(ethylene adipate)
Poly(1,4-butylene adipate)
Poly(1,4-butylene glutarate)
Poly(1,4-butylene succinate)
Poly(1,4-butylene terephthalate)
Poly(ethylene terephthalate)
Poly(2-methyl-1,3-propylene adipate)
Poly(2-methyl-1,3-propylene glutarate)
Poly(neopentylglycol adipate)
Poly(neopentylglycol sebacate)
Poly(1,3-propylene adipate)
Poly(1,3-propylene glutarate)
Polyvinyl butyral
Polyvinyl formal
Polyvinyl acetal
Polyvinyl propanal
Polyvinyl hexanal
Polyvinyl pyrrolidone

### Polyacrylate

### Polymethacrylate

Cellulose acetate
Cellulose propionate
Cellulose acetate butyrate

In addition to these materials, known viscosity-adjusting agents or thixotropy-imparting agents, such as layered compounds (e.g., smectite, mica, bentonite, silica and montmorillonite) and sodium acrylate described in JP-A-8-325491, and ethyl cellulose, polyacrylic acid and organic clay described in JP-A-10-219136, can be used. As the thixotropy-imparting agents, those which are obtained by treating the layered compound of 0.3 μm or less in particle size with an organic compound are particularly preferred. Those of 0.1 μm or less in particle size are more preferred. The particle size of the layered compound can be the length of the longer axis of the particle. It is usually preferred to incorporate the agent in an amount of from about 1 to about 10 parts by weight per 100 parts by weight of the UV ray-curable resin.

Since the anti-glare layer of the invention is often wet-coated directly on a transparent support, the solvent used for the coating composition is particularly an important factor. The required conditions includes that the solvent dissolves various solutes such as the translucent resin sufficiently, does not dissolve the fine translucent particle, causes less coating unevenness or drying unevenness in the coating to drying process. It is also preferred propertied that the solvent does not dissolve the support (necessary for the prevention of failure such as worsening of the planarity, whitening, etc.) and, on the other hand, swells the support about to a minimum extent (necessary for close adhesion), etc. The solvent may be used independently, but it is particularly preferred to use two or more solvents and adjust the swelling properties of the support, dissolving properties and drying properties of the materials, and agglomerating properties of the particles.

As specific examples, various kinds of ketones (methyl ethyl ketone, acetone, methyl isobutyl ketone, cyclohexanone, etc.) and various kinds of cellosolves (ethyl cellosolve, butyl cellosolve, propylene glycol monomethyl ether, etc.) are used preferably in a case of using triacetyl cellulose for the support. In addition, various kinds of alcohols (propylene glycol, ethylene glycol, ethanol, methanol, isopropyl alcohol, 1-butanol, 2-butanol, etc.), and toluene are used preferably. As other solvents, various alcohols (e.g., propylene glycol, ethylene glycol, ethanol, methanol, isopropyl alcohol, 1-butanol and 2-butanol) and toluene are preferably used.

As specific examples, various ketones (e.g., methyl ethyl ketone, acetone, methyl isobutyl ketone and cyclohexanone) and toluene are preferably used as main solvents in the case where triacetyl cellulose is used as a support. Also, addition of a small amount of a solvent having a hydroxyl group to a main solvent selected from among the above-described solvents enables one to adjust anti-glare properties, thus being particularly preferred. The solvent added in a small amount can enhance anti-glare properties by remaining later than the main solvent in the step of drying the coating composition, and therefore it is preferred for the solvent added in a small amount to have a lower vapor pressure than that of the main solvent at any temperature within the range of from 20 to 30° C. For example, a preferred combination is a main solvent of methyl isobutyl ketone (vapor pressure at 21.7° C.: 16.5 mmHg) and a solvent to be added in a small amount of propylene glycol (vapor pressure at 20.0° C.:0.08 mmHg). The mixing ratio of the main solvent to the solvent having a hydroxyl group to be added in a small amount is preferably from 99:1 to 50:50, more preferably from 95:5 to 70:30 in terms of the ratio of the former to the latter. A good stability of the coating solution can be obtained when the ratio is within the above-mentioned range. In a case of using three or more kinds of solvents, it is preferred to adjust the ratio of a solvent used in the largest amount to the sum of the other solvents to a level within the above-mentioned range.

Further, by adding a small amount of a highly swelling solvent to the main solvent of less swelling the transparent support selected from the solvent described above, close adhesion with the transparent support can be improved without worsening other performance and planar shape. Specifically, methyl isobutyl ketone, toluene, or various cellosolves (e.g., ethyl cellosolve, butyl cellosolve and propylene glycol monomethyl ether) can be used as the main solvent and methyl ethyl ketone, acetone, cyclohexanone, propylene glycol, ethylene glycol, ethanol, methanol, isopropyl alcohol, 1-butanol, 2-butanol, etc. can be used as the small amount solvent. Use of methyl isobutyl ketone or toluene as the main solvent and methyl ethyl ketone or cyclohexanone as the small amount solvent is particularly preferred. Further, for controlling the hydrophilic property of the solvent, propylene glycol, ethylene glycol, ethanol, methanol, isopropyl alcohol, 1-butanol, 2-butanol, etc. can be added and used. Particularly, propylene glycol or ethylene glycol can be used preferably.

The mixing ratio of the main solvent and the small amount solvent is, preferably, from 99:1 to 50:50 and, more preferably, from 95:5 to 60:40 by weight ratio. Within the range described above, scattering of the surface quality in the drying step after coating can be prevented. In a case of using three or more kinds of solvents, it is preferred to adjust the ratio of the solvent to be added in the largest amount to sum of the other solvents to the above-described range.

Then, the low refractive index layer is to be described below.

### [The Low Refractive Index Layer]

The low refractive index layer used in the invention is preferably formed by coating a composition having a thermosetting property and/or photo-setting property mainly comprising a fluoro-polymer containing fluorine atoms within a range from 35 to 80 mass % and containing crosslinking or polymerizable functional groups.

The refractive index of the low refractive index layer in the anti-glare and anti-reflection film of the invention is, preferably, 1.45 or less, more preferably, 1.30 or more and 1.40 or less and, further preferably, 1.33 or more and 1.37 or less.

Further, the low refractive index layer preferably satisfies the following equation (I) in view of lowering the reflectivity.

(m/4)×0.7<n1×d1<(m/4)×1.3 Equation (I)

in which, m is a positive odd number, n1 is a refractive index of the low refractive index layer and d1 is a film thickness (nm) of the low refractive index layer. Further, λ is a wavelength as a value within a range from 500 to 550 nm.

Satisfying the formula (1) means that m (positive odd number, usually 1) satisfying the formula (1) is present within the range of the wavelength.

The low refractive index layer is a cured film formed by coating, drying and curing a curable composition containing, for example, a fluorine-containing compound as a major component. The curable composition to be used upon formation of the low refractive index layer is preferably a composition containing at least two of (A) a fluorine-containing compound, (B) inorganic particles and (C) an organosilane compound, particularly preferably a composition containing all of the three components. It is preferred to use, as the fluorine-containing compound, a fluorine-containing polymer or a fluorine-containing sol gel material having a low refractive index. As the fluorine-containing polymer or the fluorine-containing sol gel, those materials are preferred which can be cross-linked by heat or ionizing radiation to form a low refractive index layer whose surface has the kinetic friction coefficient of from 0.03 to 0.30 and a contact angle for water of from 85 to 120°.

Materials for forming the low refractive index layer are to be described below.

### <Fluoro-Containing Polymer for Low Refractive Index Layer>

The fluoro-containing polymer described above is preferably a polymer having a dynamic friction coefficient of from 0.03 to 0.20, an angle of contact to water of from 90 to 120° and a dripping angle of purified water of 70° or less for the coating film in a case of being formed as a cured film and crosslinked by heat or ionization radiation with a view point of improving the productivity, for example, in a case of coating and curing while transporting a rolled film as a web.

Further, in a case of attaching the anti-glare film or the anti-glare and anti-reflection film of the invention to an image display device, since it tends to be released more after bonding a seal or a memo pad as the releasing strength with a commercial adhesive tape is lower, the releasing strength is preferably 500 gf (4.9 N) or less, more preferably, 300 gf (2.9 N) or less and, most preferably, 100 gf (0.98 N) or less. Further, since it is less scratched as the surface hardness is higher when measured by a micro-hardness meter, the surface hardness is, preferably, 0.3 GPa or more and, more preferably, 0.5 GPa or more.

The fluorine-containing polymer used for the low refractive index layer preferably includes fluorine atom in an amount of 35 to 80% by mass, and is preferably a fluoro-containing polymer containing polymerizable crosslinking functional groups and includes, for example, hydrolyzates or dehydration condensates of perfluoroalkyl group-containing silane compounds [for example (heptadecafluoro-1,1,2,2-tetrahydrodecyl)triethoxysilane], as well as fluoro-containing copolymers having fluoro-containing monomer units and crosslinking reactive units as constituent units. In a case of the fluoro-containing copolymer, the main chain preferably consists only of the carbon atoms. That is, it is preferred that the main chain skeleton has no oxygen atoms, nitrogen atoms, etc.

Specific examples of the fluoro-containing monomer include, for example, fluoro olefins (for example, fluoroethylene, vinylidene fluoride, tetrafluoroethylene, perfluorooctyl ethylene, hexafluoro propylene, and perfluoro-2,2-dimethyl 1,3-dioxanol), partially or completely fluorinated alkyl ester derivatives of (meth)acrylic acid (for example, Biscoat 6 FM (manufactured by Osaka Yuki Kagaku) or M-2020 (manufactured by Daikin), etc.), and completely or partially fluorinated vinyl ethers. Perfluoro olefins are preferred and hexafluoro propylene is particularly preferred with a view point of refractive index, solubility, transparency and availability.

The crosslinking reactive unit includes constitutional units obtained by polymerizing monomers previously having self-crosslinking functional group having self-crosslinking functional group in the molecule such as glycidyl(meth)acrylate or glycidyl vinyl ether; and constitutional units formed by introducing crosslinking reactive group such as (meth)acryloyl group by polymeric reaction to the constitutional unit obtained by polymerization of monomers having carboxyl group, hydroxyl group, amino group, sulfo group, etc. [for example, (meth)acrylic acid, methylol(meth)acrylate, hydroxyalkyl(meth)acrylate, allyl acrylate, hydroxyethyl vinyl ether, hydroxybutyl vinyl ether, maleic acid, and crotonic acid,] (which can be introduced, for example, by a method of reacting acrylic acid chloride to the hydroxyl group).

Further, with a view point of the solubility to the solvent, the transparency of the film, etc., other polymerization unit can also be introduced by properly copolymerizing a monomer not containing a fluorine atom in addition to the fluoro-containing monomer unit and the crosslinking reactive unit. The monomer unit that can be used together has no particular restriction and includes, for example, olefins [ethylene, propylene, isoprene, vinyl chloride, vinylidene chloride, etc.], acrylic acid esters [methyl acrylate, methyl acrylate ???-ethyl acrylate, 2-ethylhexyl acrylate, etc.], methacrylic acid esters [methyl methacrylate, ethyl methacrylate, butyl methacrylate, ethylene glycol dimethacrylate, etc.], styrene derivatives [styrene, divinyl benzene, vinyl toluene, α-methylstyrene, etc.], vinyl ethers [methyl vinyl ether, ethyl vinyl ether, cyclohexyl vinyl ether, etc.], vinyl esters [vinyl acetate, vinyl propionate, vinyl succinate, etc.], acrylamides [N-tert-butyl acrylamide, N-cyclohexyl acrylamide, etc.], methacrylamides, and acrylonitrile derivatives.

As described in JP-A Nos. 10-25388 and 10-147739, a curing agent may be used properly in combination with the fluoro-containing polymer.

The fluoro-containing polymer particularly useful in the invention is a random copolymer of perfluoro olefin and vinyl ethers or vinyl esters. It is particularly preferred to have a group capable of crosslinking reaction alone [radical reactive group such as (meth)acryloyl group, ring-opening polymerizable group such as epoxy group or oxetanyl group, etc.].

The polymerization unit containing the crosslinking reactive group is, preferably, from 5 to 70 mol % and, particularly preferably from 30 to 60 mol % based on the entire polymerization units of the polymer.

A preferred form of the fluoro-containing polymer for use in the low refractive index layer used in the invention includes the copolymer represented by the general formula 1.

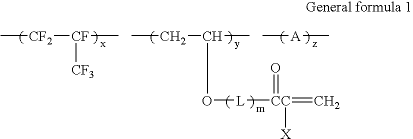

In the general formula 1, L represents a connection group of 1 to 10 carbon atoms, more preferably, a connection group of 1 to 6 carbon atoms and, particularly preferably a connection group of 2 to 4 carbon atoms, which may have a linear or branched structure or may have a ring structure, or it may have a hetero atom selected from O, N and S.

Preferred examples includes, for example, *—(CH₂)₂—O—**, *—(CH₂)₂—NH—**, *—(CH₂)₄—O—**, *—(CH₂)₆—O—**, *—(CH₂)₂—O—(CH₂)₂—O—**, *—CONH—(CH₂)₃—O—**, *—CH₂CH(OH)CH₂—O—**, *—CH₂CH₂OCONH(CH₂)₃—*,

(in which * represents the connection portion on the side of the polymer main chain and ** represents the connection portion on the side of (meth)acryloyl group), and m represents 0 or 1.

In the general formula 1, X represents a hydrogen atom or methyl group. With a view point of the curing reaction, the hydrogen atom is more preferred.

In the general formula 1, A represents a recurring unit derived from an optional vinyl monomer which is not particularly limited so long as this is a constituent ingredient of a monomer copolymerizable with hexafluoro propylene and can be selected properly with various points of view such as close adhesion to the substrate, Tg of polymer (contributing to film hardness), solubility to the solvent, transparency, sliding property, dust proofing and anti-foul property, and it may be constituted with a single or a plurality of vinyl monomers in accordance with the purpose.

Preferred examples include vinyl ethers such as methyl vinyl ether, ethyl vinyl ether, t-butyl vinyl ether, cyclohexyl vinyl ether, isopropyl vinyl ether, hydroxyethyl vinyl ether, hydroxybutyl vinyl ether, glycidyl vinyl ether, and allyl vinyl ether, vinyl esters such as vinyl acetate, vinyl propionate, and vinyl butyrate, (meth)acrylates such as methyl(meth)acrylate, ethyl(meth)acrylate, hydroxyethyl(meth)acrylate, glycidyl(meth)acrylate, allyl(meth)acrylate, and (meth)acryloyloxy propyl trimethoxy silane, styrene derivatives such as styrene and p-hydroxymethyl styrene, unsaturated carboxylic acids such as crotonic acid, maleic acid, and itaconic acid, and derivatives thereof. More preferred are vinyl ether derivatives and vinyl ester derivatives and particularly preferred are vinyl ether derivatives.

x, y, z each represents the mol % for each of the constituent ingredients, in which 30≦x≦60, 5≦y≦70, and 0≦z≦65 are preferred, 35≦x≦55, 30≦y≦60, and 0≦z≦20 are more preferred and 40≦x≦55, 40≦y≦55, and 0≦z≦10 are particularly preferred. In this case, x+y+z=100.

A particularly preferred form of the copolymer used in the invention includes the general formula 2.

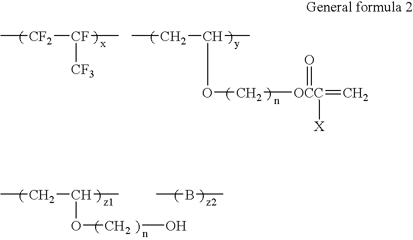

In the general formula 2, X represents the same meaning as in the general formula 1 and a preferred range is also identical.

n represents an integer of: 2≦n≦10, 2≦n≦6 is preferred and 2≦n≦4 is particularly preferred.

B represents a recurring unit derived from optional vinyl monomers, which may be constituted either with a single composition or plural compositions. Those described as examples for A in the general formula 1 are applied as the example.

x, y, z1 and z2 each represents mol % for each of the recurring units and x and y preferably satisfies 30≦x≦60 and 5≦y≦70 and, more preferably, 35≦x≦55 and 30≦y≦60 and, particularly preferably, 40≦x≦55 and 40≦y≦55. z1 and z2 satisfy preferably 0≦z≦65 and 0≦z2≦65 and, more preferably, 0<z1≦30 and 0≦z≦10 and, particularly preferably 0≦z1≦10, and 0≦z2≦5 respectively. In this case, x+y+z1+z2=100.

The copolymer represented by the general formula 1 or 2 can be synthesized, for example, by introducing the (meth)acryloyl group to a copolymer containing a hexafluoro propylene ingredient and a hydroxyalkyl vinyl ether ingredient by any of the methods described above. The re-precipitating solvent used in this case is preferably isopropanol, hexane, methanol, etc.

Preferred specific examples of the copolymer represented by the general formula 1 or 2 include those described in [0035] to [0047] in JP-A No. 2004-45462, which can be synthesized by the method described in the publication.

### <Fine Inorganic Particle for Low Refractive Index Layer>

The blending amount of the fine inorganic particle is, preferably, from 1 mg/m² to 100 mg/m², more preferably, from 5 mg/m² to 80 mg/m² and, further preferably from 10 mg/m² to 60 mg/m². In a case where the amount is insufficient, the effect of improving the scratch resistance is reduced and, in a case where it is excessive, fine unevenness is formed to the surface of the low refractive index layer to sometimes worsen the appearance such as tight blackness or integrated reflectivity, so that it is preferably within the range described above.

The fine inorganic particle preferably has a low refractive index since it is incorporated in the low refractive index layer. It includes, for example, fine particles of magnesium fluoride or silicon oxide (silica). Particularly, fine silica particles are preferred in view of the refractive index, dispersion stability and the cost.

The average particle size of the inorganic particle is, for example, 10% or more and 100% or less, preferably, 30% or more and 100% or less, more preferably, 35% or more and 80% or less and, further preferably, 40% or more and 60% or less for the thickness of the low refractive index layer. That is, for the thickness of 100 nm of the low refractive index layer, the particle size of the fine silica particle is, preferably, 30 nm or more and 100 nm or less, more preferably, 35 nm or more and 80 nm or less and, further preferably, 40 nm or more and 60 nm or less.

In a case where the particle size of the fine inorganic particle is excessively small, since the effect of improving the scratch resistance is reduced and in a case where it is excessively large, fine unevenness is formed to the surface of the low refractive index layer to sometimes worsen the appearance such as tight blackness and integrated reflectivity, the range described above is preferred. The fine inorganic particle may be either crystalline or amorphous and may be single dispersion particle or agglomerated particle so long as it can satisfy a predetermined particle size. The shape is most preferably spherical but it may be even in an indefinite shape with no problem.

The average particle size of the fine inorganic particle is measured by a coltar counter.

For further decreasing the increase of the refractive index of the low refractive index layer, the fine inorganic particle preferably has a hollow structure and the refractive index of the fine inorganic particle is, preferably, from 1.17 to 1.40, more preferably, 1.17 to 1.35 and, further preferably, from 1.17 to 1.30. The refractive index represents the refractive index as the entire particles and, in a case of fine inorganic particles of a hollow structure, it does not represents the refractive index only for the inorganic material of the outer shell. Assuming the radius of a cavity in the particle as a and radius of the particle in the outer shell as b, porosity x is represented by the following formula (II):

x=(4πa³/3)/4πb³/3)×100 (Formula II)

which is preferably from 10 to 60%, more preferably, from 20 to 60%, and, most preferably, 30 to 60%.

In a case of intending to further lower the refractive index and further increase the porosity of the hollow fine inorganic particle, since the thickness of the outer shell is reduced and the strength as the particle is weakened, a particle with a low refractive index of less than 1.17 can not be obtained with a view point of the scratch resistance.

The refractive index of the fine inorganic particle can be measured by using an Abbe refractometer (manufactured by Atago Co.).

Further, at least one of fine inorganic particles with the average particle size of less than 25% for the thickness of the low refractive index layer (hereinafter referred to as “small sized-fine inorganic particle”) may be used in combination with the fine inorganic particle with the particle size within the preferred range described above (hereinafter referred to as “large-sized fine inorganic particle”).

Since the small-sized fine inorganic particle can be present in the space between the large-sized fine inorganic particles to each other, it can contribute as a retaining agent for the large-sized fine inorganic particle.

The average particle size of the small-sized fine inorganic particle, in a case of the low refractive index layer of 100 nm, is preferably 1 nm or more and 20 nm or less, more preferably, 5 nm or more and 15 nm or less and, particularly preferably, 10 nm or more and 15 nm or less. Use of such fine inorganic particle is preferred in view of the material cost and the effect of the retaining agent.

As described above, the fine inorganic particle with the average particle size of from 30 to 100% for the thickness of the low refractive index layer as described above, having a hollow structure, and with a refractive index of from 1.17 to 1.40 as described above is used particularly preferably.

For stabilizing dispersion in the liquid dispersion or in the coating solution or improving the affinity and the bondability with the binder ingredient, a physical surface treatment such as a plasma discharging treatment or a corona discharging treatment, or a chemical surface treatment by a surfactant or a coupling agent may be applied to the fine inorganic particles. Among all, use of the coupling agent is particularly preferred. As the coupling agent, alkoxy metal compound (for example, titanium coupling agent, silane coupling agent) are used preferably. Among all, the silane coupling agent is particularly effective.

The coupling agent is used for previously applying the surface treatment before preparation of the layer coating solution as the surface treating agent for the fine inorganic particle of the low refractive index layer and it is preferred to further add the agent as the additive upon preparation of the layer coating solution and incorporate the same in the layer.

It is preferred that the fine inorganic particles are previously disposed in a medium before the surface treatment in order to mitigate the burden on the surface treatment.

Then, (C) organosilane compound are to be described.

### <Organosilane Compound for Use in Low Refractive Index Layer>

It is preferred in view of the scratch resistance, particularly, for compatibilizing the anti-reflectivity and the scratch resistance, to incorporate at least one member selected from organosilane compounds, hydrolyzates of the organosilane, partial condensates of the hydrozates of the organosilane to the curable composition (hereinafter the obtained reaction solution is also referred to as “sol ingredient”).

The ingredients function as a binder for the low refractive index layer by forming curing products after coating the curable composition by condensation in drying and heating steps. Further, in the invention, since the fluoro-containing polymer is preferably present as the fluoro-containing compound, a binder having a three dimensional structure is formed by the irradiation of actinic rays.

As the organosilane compound those represented by the following general formula (1) are preferred.

(R¹⁰)ₘ—Si(X)₄₋m General formula (1)

In the general formula (1), R¹⁰ represents a substituted or not substituted alkyl group or a substituted or not-substituted aryl group. The alkyl group includes, for example, methyl, ethyl, propyl, isopropyl, hexyl, decyl, and hexadecyl. The alkyl group includes preferably those of 1 to 30 carbon atoms, more preferably, from 1 to 16 carbon atoms and, particularly preferably, from 1 to 6 carbon atoms. The aryl group includes, for example, phenyl and naphthyl, phenyl group being preferred.

X represents a hydroxyl group or hydrolyzable group and, for example, an alkoxy group (alkoxy group of 1 to 5 carbon atoms is preferred and include, for example, methoxy group and ethoxy group), halogen atom (for example, Cl, Br and I), and R²COO (R² is preferably hydrogen atom or alkyl group of 1 to 5 carbon atoms including, for example, CH₃COO, and C₂H₅COO), which is preferably, alkoxy group and, particularly preferably, methoxy group or ethoxy group.

m represents an integer of from 1 to 3, preferably, 1 or 2 and, particularly preferably, 1.

In a case where R¹⁰ or X is present in plurality, plural R¹⁰ or X may be identical or different with each other.

The substituent contained in R¹⁰ has no particular restriction and includes a halogen atom (fluorine, chlorine, bromine, etc.), hydroxyl group, mercapto group, carboxyl group, epoxy group, alkyl group (methyl, ethyl, i-propyl, propyl, t-butyl, etc.), aryl group (phenyl, naphthyl, etc.), aromatic heterocyclic group (furyl, pyrazoyl, pyridyl, etc.), alkoxy group (methoxy, ethoxy, i-propoxy, hexyloxy, etc.), aryloxy (phenoxy, etc.), alkylthio group (methylthio, ethylthio, etc.), arylthio group (phenylthio, etc.), alkenyl group (vinyl or 1-propenyl, etc.), acyloxy groups (acetoxy, acryloyloxy, methacryloyloxy, etc.), alkoxycarbonyl groups (methoxycarbonyl, ethoxycarbonyl, etc.), aryloxycarbonyl group (phenoxycarbonyl, etc.), carbamoyl group (carbamoyl, N-methylcarbamoyl, N,N-dimethylcarbamoyl, N-methyl-N-octylcarbamoyl, etc.), and acylamino groups (acetylamino, benzoylamino, acrylamino, methacrylamino, etc.) in which the substituents may further be substituted.

In a case where R¹⁰ is present in plurality, it is preferred that at least one of them is a substituted alkyl group or a substituted aryl group.

Among the organosilane compounds represented by the general formula (1), an organosilane compound having a vinyl polymerizable substituent represented by the following general formula (2) is preferred.

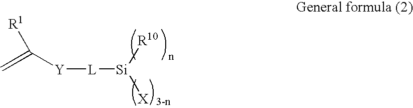

In the general formula (2), R¹ represents a hydrogen atom, methyl group, methoxy group, alkoxycarbonyl group, cyano group, fluorine atom, or chlorine atom. The alkoxycarbonyl group includes a methoxycarbonyl group or ethoxycarbonyl group. The hydrogen atom, methyl group, methoxy group, methoxycarbonyl group, cyano group, fluorine atom, and chlorine atom are preferred, and hydrogen atom, methyl group, methoxycarbonyl group, fluorine atom, and chlorine atom are further preferred, and the hydrogen atom, and the methyl group is particularly preferred.

Y represents a single bond or represents *—COO—**, *—CONH—**, or *—O—**, the single bond, *—COO—**, and *—CONH—** are preferred and the single bond and *—COO—** are more preferred and * COO—** is particularly preferred. * represents a position bonding with ═C(R¹) and ** represents a position bonding with L.

L represents a bivalent connection chain. Specifically, it includes a substituted or not substituted alkylene group, a substituted or not-substituted arylene group, a substituted or not-substituted alkylene group having a connection group in the inside (for example, ether, ester, and amide), the substituted or not-substituted arylene group having a connection group in the inside, the substituted or not-substituted alkylene group, the substituted or not-substituted arylene group and the alkylene group having the connection group in the inside are preferred, the not-substituted alkylene group, the not-substituted arylene group, and alkylene group having the ether or the ester connection group in the inside are more preferred, and the not-substituted alkylene group or the alkylene group having the ether or the ester connection group in the inside are particularly preferred. The substituent includes a halogen, hydroxyl group, mercapto group, carboxyl group, epoxy group, alkyl group, aryl group, etc. in which the substituent may further be substituent.

n represents 0 or 1. In a case where X is present in plurality, plural X may be identical or different with each other. n is preferably 0.

R¹⁰ has the same meanings as those in the general formula (1) and the substituted or the not-substituted alkyl group, and the not-substituted aryl group are preferred, and the not-substituted alkyl group or the not-substituted aryl group are more preferred.

X has the same meanings as those in the general formula (1), the halogen atom, hydroxyl group, not-substituted alkoxy group are preferred, and the chlorine atom, hydroxyl group, not-substituted alkoxy group of 1 to 6 carbon atoms are more preferred, the hydroxyl group, alkoxy group of 1 to 3 carbon atoms is further preferred, and the methoxy group is particularly preferred.

Two or more of the compounds of the general formula (1) and the general formula (2) may be used in combination. Specific examples of the compound represented by the general formula (1) and the general formula (2) are shown below with no particular restriction to them.

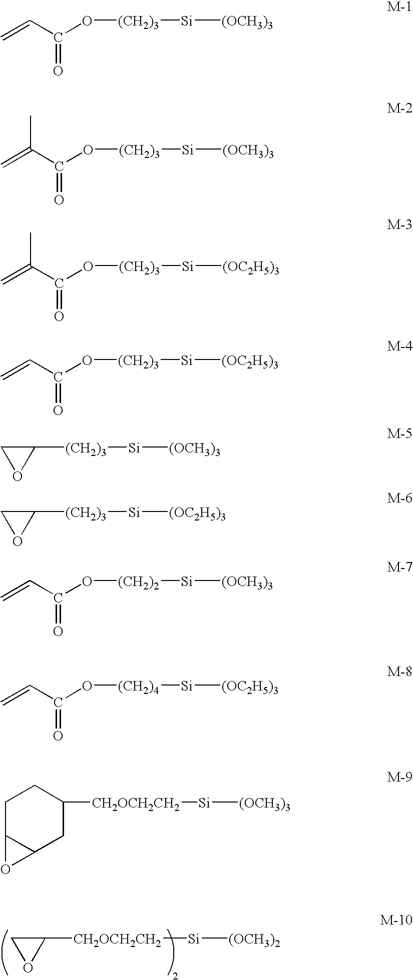

Among them, (M−1), (M−2), and (M−5) are particularly preferred.

The hydrolyzates and/or partial condensates of the organosilane compound are generally produced by treating the organosilane compound under the presence of a catalyst. The catalyst includes inorganic salts such as hydrochloric acid, sulfuric acid, and nitric acid; organic acids such as oxalic acid, acetic acid, formic acid, methane sulfonic acid, or toluene sulfonic acid; inorganic basis such as sodium hydroxide, potassium hydroxide, or ammonia, organic basis such as triethylamine or pyridine; metal alkoxides such as triisopropoxy aluminum or tetrabutoxy zirconium; and metal chelating compounds each having a metal such as Zr, Ti or Al as the center metal. In the invention, use of the metal chelating compounds, and acid catalysts of the inorganic acids and the organic acids is preferred. In the inorganic acids, hydrochloric acid and sulfuric acid are preferred. In the organic acids, those having an acid dissociation constant (pKa value (25° C.)) in water of 4.5 or less are preferred and, further, hydrochloric acid, sulfuric acid and organic acids with the acid dissociation constant in water of 3.0 or less are preferred and, particularly, hydrochloric acid, sulfuric acid and organic acids with the acid dissociation constant in water of 2.5 or less are particularly preferred, and the organic acids with the acid dissociation constant in water of 2.5 or less are further preferred and, specifically, methane sulfuric acid, oxalic acid, phthalic acid, and malonic acid are further preferred, and oxalic acid is particularly preferred.

Metal chelate compounds having alcohols represented by the general formula R³OH (in which R³ represents an alkyl group of 1 to 10 carbon atoms) and a compound represented by R⁴COCH₂COR⁵ (in which R⁴ represents an alkyl group of 1 to 10 carbon atoms and R⁵ represents an alkyl group of 1 to 10 carbon atoms or an alkoxy group of 1 to 10 carbon atoms) as the ligand and the metal selected from Zr, Ti and Al as the center metal can be used preferably with no particular restriction. The metal chelating compounds used in the invention are preferably those selected from the group of the compounds represented by the general formulae:

Zr(OR³)ₚ₁(R⁴COCHCOR⁵)ₚ₂, Ti(OR³)_{q1}(R⁴COCHCOR⁵)_{q2}, and Al(OR³)ᵣ₁(R⁴COCHCOR⁵)ᵣ₂,

which have a function of promoting the condensation reaction of hydrolyzates and/or partial condensates of the organosilane compounds.

R³ and R⁴ in the metal chelate compound may be identical or different with each other and they include alkyl groups of 1 to 10 carbon atoms, specifically, ethyl group, n-propyl group, i-propyl group, n-butyl group, sec-butyl group, t-butyl group, n-pentyl group, and phenyl group, etc. Further, R⁵ represents the same alkyl group of 1 to 10 carbon atoms as described above, as well as an alkoxy group of 1 to 10 carbon atoms, for example, methoxy group, ethoxy group, n-propoxy group, i-propoxy group, n-butoxy group, sec-butoxy group, and t-butoxy group. Further, p1, p2, q1, q2, r1, and r2 in the metal chalate compound each represents an integer determined so as to provide p1+p2=4, q1+q2=4, and r1+r2=3, respectively.

Specific examples of the metal chelate compounds include, for example, zirconium chelate compounds such as tri-n-butoxyethyl acetoacetate zirconium, di-n-butoxybis(ethyl acetoacetate) zirconium, n-butoxytris(ethyl acetoacetate) zirconium, tetrakis(n-propyl acetoacetate) zirconium, tetrakis(acetyl acetoacetate) zirconium, and tetrakis(ethyl acetoacetate) zirconium; titanium chelate compounds such as diisopropoxy•bis(ethyl acetoacetate) titanium, diisopropoxy•bis(acetyl acetate) titanium, and diisopropoxy•bis(acetyl acetone) titanium; and aluminum chelate compounds such as diisopropoxy ethyl acetoacetate aluminum, diisopropoxy acetyl acetonate aluminum, isopropoxybis(ethyl acetoacetonate) aluminum, isopropoxybis(acetyl acetonate) aluminum, tris(ethyl acetoacetate) aluminum, tris(acetyl acetonate) aluminum, and monoacetyl acetonate bis(ethyl acetoacetate) aluminum.

Among the metal chelates compounds, preferred are tri-n-butoxyethyl acetoacetate zirconium, diisopropoxybis(acetyl acetonate) titanium, diisopropoxyethyl acetoacetate aluminum, and tris(ethyl aceotoacetate) aluminum. The metal chelate compounds may be used each alone or as a mixture of two or more of them. Further, partial hydrolyzates of the metal chelate compounds can also be used.

Further, in the invention, a β-diketone compound and/or a β-ketoester compound is further added preferably to the curable composition described above. Description is to be made further.

The β-diketone compound and/or β-ketoester compound represented by the general formula R⁴COCH₂COR⁵ is used in the invention, which act as a stability improver for the curable composition used in the invention. R⁴ represents an alkyl group of 1 to 10 carbon atoms and R⁵ represents an alkyl group of 1 to 10 carbon atoms or an alkoxy group of 1 to 10 carbon atoms. That is, it is considered that coordination to the metal atom in the metal chelating compound (zirconium, titanium and/or aluminum compound) provides a function of suppressing the promotion of condensation reaction of the hydrolyzates and/or partial condensates of an organosilane compound by the metal chelating compound and improving the store stability of the obtained composition. R⁴ and R⁵ constituting the β-diketone compound and/or β-ketoester compound have the same meanings as R⁴ and R⁵ constituting the metal chelate compounds.

Specific examples of the β-diketone compound and/or β-ketoester compound include, for example, acetylacetone, methyl acetoacetate, ethyl acetoacetate, n-propyl acetoacetate, i-propyl acetoacetate, n-butyl acetoacetate, sec-butyl acetoacetate, t-butyl acetoacetate, 2,4-hexane-dione, 2,4-heptane-dione, 3,5-heptane-dione, 2,4-octane-dione, 2,4-nonane-dione, and 5-methyl-hexane-dione. Among them, ethyl acetoacetate and acetyl acetone are preferred and acetyl acetone is particularly preferred. The β-diketone compound and/or β-ketoester compound may be used each alone or as a mixture of two or more of them. The β-diketone compound and/or β-ketoester compound is used by preferably, 2 mol or more and, more preferably, from 3 to 20 mol based on one mol of the metal chelate compound in the invention. A favorable stability can be obtained within the range described above.

The blending amount of the organosilane compounds is preferably from 0.01 to 50 mass % and, more preferably, 0.5 to 20 mass % and, most preferably, from 1 to 10 mass % based on the entire solid content of the low refractive index layer.

While the organosilane compound may be added directly to the curable composition (coating solution for use in anti-glare layer and low refractive index layer), it is preferred to prepare hydrolyzates or partial condensates of the organosilane compound by treating the organosilane compound previously under the presence of a catalyst and prepare the curable composition by using the obtained reaction solution (sol solution). In the invention, it is preferred to at first prepare a composition containing the hydrolyzates and/or partial condensates of the organosilane compound and a metal chelate compound, add a β-diketone compound and/or β-ketoester compound to the composition incorporate the liquid in the coating solution for at least one of the anti-glare layer or the low refractive index layer, and apply coating.

In the invention, it is preferred that both of the anti-glare layer and the low refractive index layer are hardened films formed by coating and curing the curable coating composition containing the hydrolyzates and/or partial condensates thereof of the organosilane represented by general formula (1).

The amount of use of the sol ingredient of the organosilane to the fluoro-containing polymer in the low refractive index layer is, preferably, from 5 to 100 mass %, more preferably, 5 to 40 mass %, further preferably, from 8 to 35 mass % and, particularly preferably, from 10 to 30 mass %. In a case where the amount of use is insufficient, the effect of the invention is less obtained and, in a case where the amount of use is excessive, the refractive index increases or the shape or surface property of the film is worsened, which is not preferred.

In the curable composition, an inorganic filler other than the fine inorganic particle described above can be added by the addition amount within such a range as not impairing the desired effect of the invention. As the inorganic filler, fine inorganic particle described in the anti-glare layer is preferred and it is preferred to add those capable of providing conductivity such as indium, tin or antimony within a range not giving a significant effect on the refractive index.

### (Sol-Gel Material)

Various kinds of sol-gel materials can also be used as the material for the low refractive index layer. As the sol-gel material, metal alcoholates (alcoholates such as silane, titanium, aluminum, and zirconium), organo alkoxy metal compounds and hydrolyzates thereof can be used. Particularly, alkoxy silane, organo alkoxy silane and hydrolyzates thereof are preferred. Examples of them include, for example, tetraalkoxy silane (tetramethoxy silane, tetraethoxy silane, etc.), alkyltrialkoxy silane (methyl trimethoxy silane, ethyl trimethoxy silane, etc.), aryltrialkoxy silane (phenyl trimethoxy silane, etc.), and dialkyl dialkoxy silane and diaryl dialkoxy silane. Further, it is also preferred to use organo alkoxy silanes having various functional groups (vinyl trialkoxy silane, methyl vinyl dialkoxy silane, γ-glycidyloxy propyl trialkoxy silane, γ-glycidyloxy propyl methyl dialkoxy silane, β-(3,4-epoxydicyclohexyl)ethyl trialkoxy silane, γ-methacryloyloxy propyltrialkoxy silane, γ-aminopropyl trialkoxy silane, γ-mercaptopropyl trialkoxy silane, γ-chloropropyl trialkoxy silane, etc.), and perfluoro alkyl group-containing silane compounds (for example, heptadecafluoro-1,1,2,2-tetradecyl)trialkoxy silane and 3,3,3-trifluoropropyl trimethoxy silane). Particularly, use of the fluoro-containing silane compound is preferred with a view point of lowering the refractive index of the layer and providing water * oil repellency, and is preferably included as the fluoro-containing compound described above

### [Other Substance Contained in Curable Composition for Use in Low Refractive Index Layer]

The curable composition is prepared by optionally adding various kinds of additives and radical polymerization initiator, or cationic polymerization initiator to (A) a fluoro-containing compound, (B) a fine inorganic particle and (C) an organosilane compound, and dissolving them in an appropriate solvent. While the concentration of the solid content is properly selected depending on the application use, it is generally about from 0.01 to 60 mass %, preferably, from 0.5 to 50 mass % and, particularly preferably, about from 1% to 20 mass %.

With the view point of the boundary adhesion between the low refractive index layer and the lower layer directly adjacent therewith, a curing agent such as a polyfunctional (meth)acrylate compound, polyfunctional epoxy compound, a polyisocyanate compound, an aminoplast, a polybasic acid or anhydride thereof can be added each in a small amount. In a case of adding them, it is, preferably, within a range of 30 mass % or less, more preferably, within a range of 20 mass % or less and, particularly preferably, within a range of 10 mass % or less based on the entire solid content of the film of the low refractive index layer.

Further, with an aim of providing characteristics such as anti-fouling property, water proofness, chemical resistance, and slipping property, an anti-fouling agent, a slipping agent, etc. of known silicon compounds or fluoro-compounds can also be added properly. In a case of adding the additives, it is added, preferably, within a range from 0.01 to 20 mass %, more preferably, within a range from 0.05 to 10 mass % and, particularly preferably, from 0.1 to 5 mass % based on the entire solid content of the low refractive index layer.

Preferred examples of the silicone compound include those having substituents on the terminal ends and/or side chains of the compound chain containing a plurality of dimethyl silyloxy units as the recurring units. Structural units other than dimethyl silyloxy may also be contained in the compound chain containing dimethyl silyloxy as the recurring unit. The substituent may be identical or different with each other and preferably present in plurality. Examples of preferred substituents include those containing acryloyl group, methacryloyl group, vinyl group, aryl group, sinnamoyl group, epoxy group, oxetanyl group, hydroxyl group, fluoroalkyl group, polyoxyalkylene group, carboxyl group, and amino group. While the molecular weight is not particularly limited, it is, preferably, 100,000 or less, particularly preferably 50,000 or less and, most preferably, from 3,000 to 30,000. While the content of the silicon atoms in the silicone compound is not particularly limited, it is, preferably, 18.0 mass % or more, particularly preferably, from 25.0 to 37.8 mass % and, most preferably, from 30.0 to 37.0 mass %. Examples of preferred silicone compounds include, for example, X-22-174DX, X-22-2426, X-22-164B, X22-164C, X-22-170DX, X-22-176D, and X-22-1821 (commercial names, manufactured by Shinetsu Chemical Co.), and FM-0725, FM-7725, FM-4421, FM-5521, FM-6621, and FM-1121, manufactured by Chisso Co., and DMS-U22, RMS-033, RNS-083, UMS-182, DMS-H21, DMS-H31, HMS-301, FMS121, FMS123, FMS131, FMS141, and FMS 221 (commercial names) manufactured by Gelest with no particular restriction to them.

As the fluoro-compound, compounds having a fluoroalkyl group are preferred. The fluoroalkyl group has, preferably, from 1 to 20 carbon atoms and, more preferably, 1 to 10 carbon atoms, which may have a linear structure (for example, —CF₂CF₃, —CH₂(CF₂)₄H, —CH₂(CF₂)₈CF₃, and —CH₂CH₂(CF₂)₄H), a branched structure (for example, —CH(CF₃)₂, —CH₂CF(CF₃)₂, —CH(CH₃)CF₂CF₃, and —CH(CH₃)(CF₂)₅CF₂H), or cycloaliphatic structure (preferably, 5-membered ring or 6-membered ring, for example, perfluorocyclohexyl group, perfluorocyclopentyl group, or an alkyl group substituted therewith), or may have an ether bond (for example, —CH₂OCH₂CF₂CF₃, —CH₂CH₂OCH₂C₄F₈H, —CH₂CH₂OCH₂CH₂C₈F₁₇, and —CH₂CH₂OCF₂CF₂OCF₂CF₂H). The fluoro alkyl group may be contained in plurality in one identical molecule.

Further, the fluoro-compound preferably has a substituents contributing to the formation of bonding or compatibility with the film of the low refractive index layer. The substituents may be identical or different with each other and preferably present in plurality. Examples of preferred substituent include, for example, acryloyl group, methacryloyl group, vinyl group, aryl group, sinnamoyl group, epoxy group, oxetanyl group, hydroxyl group, polyoxyalkylene group, carboxyl group, and amino group. The fluoro-compound may be a polymer or an oligomer with a compound not containing the fluorine atom with no particular restriction in view of the molecular weight. While the content of the fluorine atom in the fluoro-compound has no particular restriction, it is, preferably, 20 mass % or more, particularly preferably, from 30 to 70 mass % and, most preferably, from 40 to 70 mass %. Preferred examples of the fluoro-compound include R-2020, M-2020, R-3838, and M-3833 (commercial names) manufactured by Dai Nippon Ink Chemical Industry, Co., and Megafac F-171, F-172, F-179A, and Difenser MCF-300 (commercial name) manufactured by Dai-Nippon Ink Co. with no particular restrictions to them.

Also, with the aforesaid silicone-based compound or the fluorine-containing compound which can properly be added for the purpose of imparting characteristic properties such as stain-proof properties, water resistance, chemical resistance and sliding properties, its molecular structure may preferably be incorporated in the molecular structure of (A) fluorine-containing compound to be incorporated in the curable composition for forming the low refractive index layer. That is, the structure is desirably incorporated in the form of block or graft in the molecular structure of the aforesaid fluorine-containing polymer or the fluorine-containing sol gel.

With an aim of providing characteristics such as dust proofness and antistatic property, a dust proofing agent and an antistatic agent such as of non-cationic surfactant or polyoxyalkyl compound can be added properly. The structural unit of the dust proofing agent and the antistatic agent may also be incorporated in the silicone compound or the fluoro-compound as a portion of the function. In a case of adding the additives, it is added, preferably, within a range from 0.01 to 20 mass % and, more preferably, within a range from 0.05 to 10 mass %, in particular preferably, within a range from 0.1 to 5 mass % based on the entire solid content of the low refractive index layer. Examples of the preferred compounds include Megafac F-150 (commercial name) manufactured by Dai-Nippon Ink Co. and SH-3748 (commercial name) manufactured by Toray Dow-Corning, with no restriction to them.

### [Solvent for Use in Low Refractive Index Layer]

As the solvent used in the coating composition for forming the low refractive index layer of the invention, various kinds of solvents selected with a view point that they can dissolve or disperse each of ingredients, tend to form a uniform planar shape in the coating step and the drying step, can ensure the liquid storability, and has an appropriate saturated vapor pressure. With the view point of the load on drying, it preferably comprises a solvent with a boiling point at a normal pressure and a room temperature of 100° C. or lower as the main ingredient and it more preferably further comprises a small amount of a solvent with the boiling point of 100° C. or higher for controlling the drying speed.

The solvent with the boiling point of 100° C. or lower includes, for example, hydrocarbons such as hexane (boiling point: 68.7° C.), heptane (98.4° C.), cyclohexane (80.7° C.) and benzene (80.1° C.), halogenated hydrocarbons such as dichloromethane (39.8° C.), chloroform (61.2° C.), carbon tetrachloride (76.8° C.), 1,2-dichloroethane (83.5° C.), and trichloroethylene (87.2° C.), ethers such as diethyl ether (34.6° C.), diisopropyl ether (68.5° C.), dipropyl ether (90.5° C.), tetrahydrofuran (66° C.), esters such as ethyl formate (54.2° C.), methyl acetate (57.8° C.), ethyl acetate (77.1° C.), isopropyl acetate (89° C.), ketones such as acetone (56.1° C.), 2-butanone (identical with methyl ethyl ketone, 79.6° C.), alcohols such as methanol (64.5° C.), ethanol (78.3° C.), 2-propanol (82.4° C.), 1-propanol (97.2° C.), cyano compounds such as acetonitrile (81.6° C.), and propionitrile (97.4° C.), and carbon disulfice (46.2° C.). Among them, the ketones and the esters are preferred and the ketones are particularly preferred. Among the ketones, 2-butanone is particularly preferred.

The solvent with a boiling point of 100° C. or higher includes, for example, octane (125.7° C.), toluene (110.6° C.), xylene (138° C.), tetrachloroethylene (121.2° C.), chlorobenzene (131.7° C.), dioxane (101.3° C.), dibutyl ether (142.4° C.), isobutyl acetate (118° C.), cyclohexanone (155.7° C.), 2-methyl-4-pentanone (identical with MIBK, 115.9° C.), 1-butanol (117.7° C.), N,N-dimethylformamide (153° C.), N,N-dimethylacetoamide (166° C.), and dimethylsulfoxide (189° C.). Cyclohexanone and 2-methyl-4-pentanone are preferred.

### [Transparent Conductive Layer]

For the anti-glare and anti-reflection film of the invention, a transparent conductive layer is preferably provided with an antistatic purpose for preventing static charges on the film surface. The transparent conductive layer is effective in a case where it is required to lower the surface resistance value in view of the display or in a case where dust deposition to the surface results in a problem. The method of forming the transparent conductive layer includes known methods, for example, a method of coating a conductive coating solution containing conductive particles and a reactive curable resin, or a method of forming a thin conductive film by vapor deposition or sputtering of a metal or metal oxide forming a transparent film. In the case of coating, the method is not particularly limited and coating may be conducted by selecting an optimal method from the known methods such as roll coating, gravure coating, bar coating, or extrusion coating in accordance with the property and the coating amount of the coating solution.

The transparent conductive layer can be formed over the transparent support or the anti-glare layer directly or by way of a primer layer for forming strong adhesion therewith.

The thickness of the transparent conductive layer is, preferably from 0.01 to 10 μm, preferably, from 0.03 to 7 μm and, further preferably, from 0.05 to 5 μm. In a case of use for the layer near the uppermost surface layer, antistatic property can be obtained sufficiently even when the thickness of the film is thin. The surface resistance of the transparent conductive layer is, preferably, from 10⁵ to 10¹² Ω/sq, more preferably, from 10⁵ to 10⁹ Ω/sq and, most preferably, from 10⁵ to 10⁸ Ω/sq. The surface resistance of the transparent conductive layer can be measured by a four probe method.

The transparent conductive layer is preferably transparent substantially. Specifically, the haze of the transparent conductive layer is preferably 10% or less and, more preferably, 5% or less, further preferably, 3% or less and, most preferably, 1% or less. The light transmittance at a wavelength of 550 nm is, preferably, 50% or more, more preferably, 60% or more, further preferably, 65% or more and, most preferably, 70% or more.

It is preferred that the transparent conductive layer is excellent in the strength and a specific strength of the antistatic layer by the pencil hardness is, preferably, H or higher, more preferably, 2H or higher, further preferably, 3H or higher and, most preferably, 4H or higher at 1 kg load (according to JIS-K-5400).

### (Conductive Particle)

Average particle size of the primary particle of the conductive particle used in the transparent conductive layer, is, preferably, from 1 to 150 nm, more preferably, from 5 to 100 nm, most preferably, from 5 to 70 nm. The average particle size of the conductive particle in the transparent conductive layer to be formed is from 1 to 200 nm, preferably, from 5 to 150 nm, more preferably, from 10 to 100 nm and, most preferably, from 10 to 80 nm. The average particle size of the conductive particle is an average size being weighted by the mass of the particle and can be measured by a light scattering method or an electron microscopic photograph.

The specific surface area of the conductive particle is, preferably, from 10 to 400 m²/g, more preferably, from 20 to 200 m²/g and, most preferably, from 30 to 150 m²/g.

The conductive particle is preferably a fine inorganic particle comprising a metal oxide or nitride.

Examples of the metal oxide or nitride include tin oxide, indium oxide, zinc oxide, and titanium nitride. Tin oxide and indium oxide are particularly preferred.

The conductive particle comprises the metal oxide or nitride as the main ingredient and can further contain other elements. The main ingredient means an ingredient with the greatest content (mass %) in the ingredients constituting the particle. Examples of other elements include Ti, Zr, Sn, Sb, Cu, Fe, Mn, Pb, Cd, As, Cr, Hg, Zn, Al, Mg, Si, P, S, B, Nb, In, V and a halogen atom. For increasing the conductivity of tin oxide and indium oxide, it is preferred to add Sb, P, B, Nb, In, V, and a halogen atom. Tin oxide containing Sb (ATO) and indium oxide containing Sn (ITO) are particularly preferred. The ratio of Sb in ATO is, preferably, from 3 to 20 mass %. The ratio of Sn in ITO is, preferably, from 5 to 20 mass %.

The conductive particle may also be applied with a surface treatment. The surface treatment may be conducted by using an inorganic compound or an organic compound. Examples of the inorganic compounds used for the surface treatment include alumina and silica. A silica treatment is particularly preferred. Examples of the organic compounds used for the surface treatment include polyol, alkanolamine, stearic acid, a silane coupling agent, and a titanate coupling agent. The silane coupling agent is most preferred. Two or more of the surface treatments may be conducted in combination.

The shape of the conductive particle is preferably granular, spherical, cuboidal, spindle or indefinite shape.

The ratio of the fine conductive inorganic particle in the transparent conductive layer is, preferably, from 20 to 90 mass %, more preferably, 25 to 85 mass % and, further preferably, from 30 to 80 mass %.

Two or more of conductive particles may be used in combination in the transparent conductive layer.

The conductive particle can be used in a dispersed state for the transparent conductive layer. As the dispersion medium for the conductive particle, use of a liquid with a boiling point of from 60 to 170° C. is preferred. Examples of the dispersion media include water, alcohol (for example, methanol, ethanol, isopropanol, butanol, and benzyl alcohol), ketone (for example, acetone, methyl ethyl ketone, methyl isobutyl ketone, and cyclohexanone), ester (for example, methyl acetate, ethyl acetate, propyl acetate, butyl acetate, methyl formate, ethyl formate, propyl formate, or butyl formate), aliphatic hydrocarbon (for example, hexane or cyclohexane), halogenated hydrocarbon (for example, methylene chloride, chloroform, and carbon tetrachloride), aromatic hydrocarbon (for example, benzene, toluene, and xylene), amide (for example, dimethyl formamide, dimethyl acetoamide, and n-methylpyrrolidone), ether (for example, diethyl ether, dioxane, and tetrahydrofuran), ether alcohol (for example, 1-methoxy-2-propanol). Among them, toluene, xylene, methyl ethyl ketone, methylisobutyl ketone, cyclohexanone, and butanol are particularly preferred. The conductive particle can be dispersed in the medium by using a dispersing machine. Examples of the dispersing machines include a sand grinder mill (for example, bead mill with pins), high speed impeller mill, pebble mill, roller mill, attritor, and colloid mill, the sand grinder mill and the high speed impeller mill being particularly preferred. Further, a preliminary dispersion treatment may also be conducted. Examples of the dispersing machines used for the preliminary dispersion treatment include a ball mill, three roll mill, kneader, and extruder.

Conductive particle can be added also to the anti-glare layer.

The conductive particles can also be added to the anti-glare layer.

### (Binder for Transparent Conductive Layer)

In the transparent conductive layer, a crosslinked polymer can be used as the binder. The crosslinked polymer preferably has an anionic group. The crosslinked polymer having the anionic group has a structure in which the main chain of the polymer having the anionic group is crosslinked. The anionic group has a function of keeping the dispersion state of the conductive particle. The crosslinked structure has a function of providing the film forming performance to the polymer and reinforcing the transparent conductive layer.

Examples of the polymer main chain include polyolefin (saturated hydrocarbon), polyether, polyurea, polyurethane, polyester, polyamine, polyamide and melamine resin. Polyolefin main chain, polyether main chain and polyurea main chain are preferred, the polyolefin main chain and the polyether main chain are more preferred and the polyolefin main chain is most preferred.

The polyolefin main chain comprises a saturated hydrocarbon. The polyolefin main chain can be obtained, for example, by addition polymerizing reaction of unsaturated polymerizable groups.

In the polyether main chain, recurring units are connected by way of the ether bond (—O—). The polyether main chain can be obtained, for example, by ring opening polymerizing reaction of an epoxy group.

In the polyurea main chain, recurring units are connected by urea bond (—NH—CO—NH—). The polyurea main chain is obtained, for example, by polycondensing reaction between the isocyanate group and the amino group. In the polyurethane, recurring units are connected by urethane bond (—NH—CO—O—).

The polyurethane main chain can be obtained, for example, by polycondensation reaction between the isocyanate group and the hydroxyl group (containing N-methylol group).

In the polyester main chain, recurring units are connected by way of the ester bond (—CO—O—). The polyester main chain can be obtained, for example, by polycondensation reaction between the carboxyl group (including acid halide group) and the hydroxyl group (including N-methylol group) and the hydroxyl group.

In the polyamine main chain, recurring units are connected by way of the imino bond (—NH—). The polyamine main chain is obtained, for example, by ring opening polymerizing reaction of ethylene imine groups.

In the polyamide main chain, recurring units are connected by way of the amide bond (—NH—CO—). The polyamide main chain can be obtained, for example, by reaction between isocyanate group and carboxylate group (including acid halide group).

The melamine resin main chain can be obtained, for example, by polycondensation reaction between triazine ring (for example, melamine) and aldehyde (for example, formaldehyde). In the melamine resin, the main chain per se has the crosslinked structure.

The anionic group is connected directly to the polymer main chain, or by way of a connection group to the main chain. The anionic group is preferably connected by way of a connection group as a side chain to the main chain.

Examples of the anionic groups include, for example, carboxylic acid group (carboxyl), sulfonic acid group (sulfo), and phosphoric acid group (phosphono) with the sulfonic acid group and the phosphoric group being preferred. The anionic group may be in the state of a salt. The cation forming the salt with the anionic group is preferably an alkali metal ion. Further, the proton of the anionic group may be dissociated.

The connection group for connecting the anionic group and the polymer main chain is preferably a bivalent group selected from —CO—, —O—, alkylene group, arylene group, and a combination thereof.

In the crosslinking structure, two or more main chains are chemically bonded (preferably, by covalent bond). The crosslinked structure preferably has three or more main chains in covalent bond. The crosslinked structure preferably comprises bivalent or higher valent groups selected from —CO—, —O—, —S—, nitrogen atom, phosphorous atom, aliphatic residue, aromatic residue, and a combination thereof. The crosslinked polymer having the anionic group is preferably a copolymer comprising recurring units having the anionic group and recurring units having the crosslinked structure. The ratio of the recurring units having the anionic group in the copolymer is, preferably, from 2 to 96 mass %, more preferably, from 4 to 94 mass % and, most preferably, from 6 to 92 mass %. The recurring unit may also have two or more anionic groups. The ratio of the recurring units having the crosslinked structure in the copolymer is, preferably, from 4 to 98 mass %, more preferably, from 6 to 96 mass % and most preferably, from 8 to 94 mass %.

The recurring units of the crosslinked polymer having the anionic group may have both the anionic group and the crosslinked structure. Further, other recurring units (recurring units with neither anionic group nor crosslinked structure) may also be contained.

As other recurring units, a recurring unit having an amino group or a quaternary ammonium group and a recurring unit having a benzene ring is preferred. The amino group or the quaternary ammonium group has a function of maintaining the dispersion state of fine inorganic particles like the anionic group. The amino group, the quaternary ammonium group, and the benzene ring can provide the same effect also in a case where it is contained in the recurring unit having the anionic group or in the recurring unit having the crosslinked structure.

In the recurring unit having the amino group or the quaternary ammonium group, the amino group or the quaternary ammonium group is bonded directly to the polymer main chain or bonded by way of a connection group. The amino group or the quaternary ammonium group is preferably bonded as the side chain by way of the connection group to the main chain.

The amino group or the quaternary ammonium group is preferably a secondary amino group, a tertiary amino group, or a quaternary ammonium group, with the tertiary amino group or the quaternary ammonium group being preferred. The group bonded to the nitrogen atom in the secondary amino group, the tertiary amino group, or the quaternary ammonium group is preferably an alkyl group, an alkyl group of 1 to 12 carbon atoms being preferred and an alkyl group of 1 to 6 carbon atoms being more preferred.

The counter ion of the quaternary ammonium group is preferably a halide ion. The connection group bonding the amino group or the quaternary ammonium group with the polymer main chain is preferably a bivalent group selected from —CO—, —NH—, —O—, alkylene group, arylene group, and a combination thereof. In a case where the crosslinked polymer having the anionic group contains recurring units having the amino group or the quaternary ammonium group, the ratio is preferably, from 0.06 to 32 mass %, more preferably, from 0.08 to 30 mass % and, most preferably, from 0.1 to 28 mass %.

For the binder described above, the following reactive organic silicon compound described, for example, in JP-A No. 2003-39586 can also be used in combination. The reactive organic silicon compound is used within a range from 10 to 100% by weight based on the total of the ionization radiation-curable resin and the reactive organic silicon compound. Particularly, in a case of using the ionization radiation-curable organic silicon compound of the following (3), it is possible to form a conductive layer by using only the same as the resin ingredient.

### (1) Silicon Alkoxide

This is a compound represented by RmSi(OR′)n in which R, R′ each represents an alkyl group of 1 to 10 carbon atoms and m and n are, respectively, integers providing: m+n=4. For example, the compound includes tetramethoxy silane, tetraethoxy silane, tetra-iso-propoxy silane, tetra-n-propoxy silane, tetra-n-butoxy silane, tetra-sec-butoxy silane, tetra-tert-butoxy silane, tetra-penta-ethoxy silane, tetra-penta-iso-propoxy silane, tetra-penta-n-propoxy silane, tetra-penta-n-butoxy silane, tetra-penta-sec-butoxy silane, tetra-penta-tert-butoxy silane, methyltrimethoxy silane, methyltriethoxy silane, methyltripropoxy silane, methyltributoxy silane, dimethyldimethoxy silane, dimethyldiethoxy silane, dimethylethoxy silane, dimethylmethoxy silane, dimethylpropoxy silane, dimethylbutoxy silane, methyldimethoxy silane, methyl diethoxy silane, and hexyltrimethoxy silane.

### (2) Silane Coupling Agent

For example, the coupling agent includes; γ-(2-aminoethyl)aminopropyl trimethoxy silane, y-(2-aminoethyl)aminopropylmethyl dimethoxy silane, β-(3,4-epoxycyclohexyl)ethyl trimethoxy silane, γ-aminopropyl triethoxy silane, γ-methcryaloxypropyltrimethoxy silane, N-β-(N-vinylbenzylaminoethyl-γ-aminopropylmethoxy silane•hydrochloric salt, γ-glycidoxypropyl trimethoxy silane, amino silane, methyltrimethoxy silane, vinyl triacetoxy silane, γ-mercaptopropyl trimethoxy silane, γ-chloropropyl trimethoxy silane, hexamethyl disilazane, vinyltris(β-methoxyethoxy)silane, octacedyldimethyl[3-(trimethoxysilyl)propyl] ammonium chloride, methyltrichloro silane, and dimethyldichloro silane.

### (3) Ionization Radiation-Curable Silicon Compound

The compound includes organic silicon compound having a molecular weight of 5,000 or less having a plurality of groups conducting reactive crosslinking by ionization radiation, for example, polymerizable double bond groups. The reactive organic silicon compound includes, for example, single terminal vinyl functional polysilane, both terminal vinyl functional polysilane, single terminal vinyl functional polysiloxane, both terminal vinyl functional polysiloxane, or vinyl functional polysilane formed by reacting the compounds, or vinyl functional polysiloxane.

Other compounds include, (meth)acryloxy silane compounds such as 3-(meth)acryloxypropyl trimethoxy silane and 3-(meth)acryloxypropyl methyldimethoxy silane.

For obtaining the antistatic function further, it is also preferred to disperse conductive particles in the anti-glare layer of the invention to provide a function as an anisotropic conductive film as disclosed in JP-A No. 2003-39586.

### <Transparent Support>

For the transparent support of the anti-glare and anti-reflection film of the invention, a plastic film is used preferably. The polymer forming the plastic film includes, cellulose acylate (for example, triacetyl cellulose, diacetyl cellulose, cellulose acetate propionate and cellulose acetate butyrate, typically TAC-TD80U, TD80UL, etc. manufactured by Fuji Photographic Film Inc.), polyamide, polycarbonate, polyester (for example, polyethylene terephthalate and polyethylene naphthalate), polystyren, polyolefin, norbornene resin (Arton: trade name of products manufactured by JSR Co.), amorphous polyolefin (Zeonex: trade name of products, manufactured by Nippon Zeon Co.), etc. Among them, triacetyl cellulose, polyethylene terephthalate, norbornene resin and amorphous polyolefin are preferred, triacetyl cellulose being particularly preferred, triacetyl cellulose being particularly preferred.

The cellulose acylate comprises a single or plural layers. The single layered cellulose acylate is prepared by drum casting, band casting, etc. as disclosed in JP-A No. 7-11055 and the latter cellulose acylate comprising plural layers is prepared by a so-called co-casting method disclosed for example in JP-A No. 61-94725, JP-B No. 62-43846 etc. of the patent laid-open publications. That is, the method includes dissolving starting material flakes in a solvent such as halogenated hydrocarbon (dichloromethane, etc.), alcohols (methanol, ethanol, butanol, etc.), esters (methyl formate, methyl acetate, etc.), ethers (dioxane, dioxolane, diethyl ether, etc.), optionally adding various additives such as plasticizer, UV-ray absorbent, aging inhibitor, slipping agent, releasing promotor, etc. to form a solution (referred to as a dope) and casting the same by dope supply means (referred to as a die) on a support comprising an endless metal belt of a horizontal endless type or a rotating drum, in which a single dope is cast as a single layer in a case of the single layer, a low concentration dope is co-cast on both sides of a cellulose ester dope at high concentration in a case of a plurality of layers, drying the dope to some extent on the support, peeling the film provided with rigidity from the support and then passing the same through a drying portion by various kind of conveying means to remove the solvent.

For the solvent for solving the cellulose acylate described above, dichloromethane is typical. However, with a view point of global environment or working environment, it is preferred that the solvent does not substantially contain halogenated hydrocarbons such as dichloromethane. “does not substantially contain” means that the ratio of the halogenated hydrocarbon in the organic solvent is less than 5 mass % (preferably, less than 2 mass %).

Various cellulose acylate films (films comprising triacetyl cellulose, etc.) as described above, as well as the manufacturing method thereof are described in Laid-Open Technical Report Publication No. 2001-1745 by Hatsumei Kyokai (published in Mar. 15, 2001).

The thickness of the cellulose acylate film is 40 μm to 200 μm, for example preferably from 40 μm to 120 μm. While about 80 μm is preferred in view of the handlability and the coatability, there is a great demand for reducing the thickness of a polarizing plates in view of the recent trend of reducing the thickness of a display device, and about 40 μm to 60 μm is preferred with a view point of reducing the thickness of the polarizing plate. In a case of using such a thin cellulose acylate film as the transparent support for the anti-glare and anti-reflecting film of the invention, it is preferred to solve the problems of the handlability and the coatability by optimizing the solvent for the layer directly coated on the cellulose acylate film, the film thickness, the crosslinking shrinkage, etc.

### <Other Layer>

Other layers which may also be provided between the transparent supply and the anti-glare layer of the invention includes a hard coat layer (in a case where the hardness is insufficient by the anti-glare layer alone), a moisture proof layer, an adhesion improving layer, iridescence unevenness (interference unevenness) preventive layer, etc.

The layers can be formed by known methods.

While the anti-glare and anti-reflection film of the invention can be formed by the following method but the method is not restrictive.

### [Preparation of Coating Solution]

At first, a coating solution containing ingredients for forming each of the layers is prepared. In this case, increase of the water content in the coating solution can be suppressed by minimizing the evaporation amount of the solvent. The water content in the coating solution is, preferably, 5% or less and, more preferably, 2% or less, in particular 1% or less. The evaporation amount of the solvent can be suppressed, for example, by improving the sealability during stirring after charging each of the materials in a tank, or minimizing the contact area with air of the coating solution during a liquid transfer operation. Alternatively, means for decreasing the water content in the coating solution during, before and after the coating may also be provided.

It is preferred to apply filtration in the coating solution forming the anti-glare layer capable of removing substantially all obstacles (that is, 90% or more) corresponding to the thickness of the drying film of the low refractive index layer (about 50 nm to 120 nm) formed directly thereon. Since the fine translucent particle for providing light diffusibility is equal with or greater than the thickness of the low refractive index layer, the filtration is conducted preferably to the intermediate liquid to which all the materials other than the fine translucent particles are added. Further, in a case where a filter capable of removing obstacles with a small particle size as described above is not available, it is preferred to apply filtration at least capable of removing substantially all the obstacles corresponding to thickness of the wet film (about 1 to 10 μm) formed directly thereon. With such means, spot defects of the layer formed directly thereon can be decreased.

### [Coating]

Then, a coating solution for forming an anti-glare layer and, optionally, a low refractive index layer or another layer is coated on a transparent supply port and heated and dried. Then, the monomer or the curable resin for forming the respective layers is cured by photo-irradiation and/or heating. Thus, the respective layers are formed.

The coating method for each layer of the film of the invention is not particularly limited, and there may be employed known methods such as a dip coating method, an air knife coating method, a curtain coating method, a roller coating method, a wire bar coating method, a gravure coating method, an extrusion coating method (die coating method)(see U.S. Pat. No. 2,681,294) and a micro-gravure coating method. Of these, the micro-gravure coating method and the die coating method are preferred, and for high productivity, a die coating method is used preferably. Particularly, description is to be made to a die coater that can be used preferably for a region with less wet coating amount (20 cc/m² or less) as in the case of the anti-glare layer or the anti-reflective layer of the invention.

### <Constitution of Die Coater>

FIG. 3 is a cross sectional view of a coater using a slot die for practicing the invention. A coater 10 forms a coating film 14b on a web W by coating a coating solution 14 from a slot die 13 as a bead 14a to a web W running continuously being supported on a back-up roll 11.

A pocket 15 and a slot 16 are formed inside the slot die 13. The pocket 15 has a cross section constituted with curves and straight lines and it may be a substantially circular shape, for example as shown in FIG. 3, or a semi-circular shape. The pocket 15 is a liquid reserving space for the coating solution extended with the cross sectional shape along the lateral direction of the slot die 13 and the effective extension length is generally identical with or somewhat longer than the coating width. The coating solution 14 is supplied to the pocket 15 from the lateral surface of the slot die 13 or from the center on the surface opposite to the slot opening 16a. Further, a stopper is provided to the pocket 15 for preventing the coating solution 14 from leaking.

The slot 16 is a flow channel of the coating solution 14 from the pocket 15 to the web W and it has a cross sectional shape in the lateral direction of the slot die 13 like the pocket 15. The opening 16a situated on the side of the web is controlled substantially to a width of a size substantially identical with the coating width by using a not-illustrated width control plate or the like. The angle at the top end of the slot 16 relative to a tangential line of the back-up roll 11 in the web running direction is preferably 30° or more and 90° or less.

The top end lip 17 of the slot die 13 at which the opening 16a of the slot 16 situates is formed into a tapered shape and the top end constitutes a flat portion 18 referred as a land 18. In view of the advancing direction of the web W relative to the slot 16, the upstream side is referred to as an upstream lip land 18a and the downstream side is referred to as a downstream side lip land 18b in the land 18.

FIG. 4 shows the cross sectional shape of the slot die 13 in comparison with the existent case, in which FIG. 4A shows the slot die 13 of the invention and FIG. 4B shows an existent slot die 30 in the existent slot die 30. In the existent slot die 30, the distance of the upstream lip land 31a and that of the downstream lip land 31b relative to the web is identical. Reference 32 denotes a pocket and 33 denotes a slot. On the contrary, in the slot die 13 of the invention, the length I_{LO} for the downstream side lip land is shortened by which coating at a moistened film thickness of 20 μm or less can be conducted accurately.

While the land length I_{UP} for the upstream side lip land 118a is not particularly limited, it is used preferably within a range from 500 μm to 1 mm. The land length I_{LO} for the downstream side lip land 18b is from 30 μm or more and 100 μm or less, preferably, 30 μm or more and 80 μm or less and, more preferably, 30 μm or more and 60 μm or less. In a case where the land length I_{LO} of the downstream side lip is shorter than 30 μm, the edge or the land at the top end lip tends to be chipped and tends to cause streaks in the coated film and, as a result, the coating becomes impossible. Further, setting for the position of the wetting line on the downstream is difficult to also result in a problem that the coating solution tends to be spread in the downstream side. The wet spreading of the coating solution on the downstream means that the wet line is not uniform and it has been known that this results in worsening of the shape such as streaks on the coating surface. On the other hand, in a case where the land length I_{LO} of the downstream side lip is longer than 100 μm, since the formation of beads per se is impossible, the thin film coating can not be conducted.

Further, since the downstream side lip land 18b is in an overbite shape which is closer to the web W than the upstream side lip land 18a, this can decrease the degree of pressure reduction and can form a bead suitable to the thin film coating. The difference of the distance between the downstream side lip land 18b and the upstream side lip land 18a relative to the web (hereinafter referred to as an overbite length LO) is, preferably, 30 μm or more and 120 μm or less, more preferably, 30 μm or more and 100 μm or less and, most preferably, 30 μm or more and 80 μm or less. In a case where the slot die 13 has an overbite shape, the gap G_{L} between the top end lip 17 and the web W shows the gap between the downstream side lip land 18b and the web W.

FIG. 5 is a perspective view showing the slot die and the periphery thereof in the coating step of practicing the invention. A pressure reduction chamber 40 is situated on the side opposite to the advancing direction of the web W at a position not in contact therewith, so that the pressure reduction can be controlled sufficiently for the bead 14a. The pressure reduction chamber 40 has a back plate 40a and a side plate 40b for maintaining the operation efficiency and gaps G_{B} and Gs are present between the back plate 40a and the web W and between the side plate 40b and the web W, respectively. FIG. 6 and FIG. 7 are cross sectional views showing the pressure reduction chamber 40 and web W closer to each other. The side plate and the back plate may be integrated with a chamber main body as shown in FIG. 6, or they may be of a structure fixed to the chamber by means of a screw 40c or the like so as to change the gap properly as shown in FIG. 7. In any of the structures, a portion actually present between the back plate 40a and the web W and that between the side plate 40b and the web W are defined as gaps G_{B}, and G_{S}, respectively. In a case where the pressure reduction chamber 40 is located below the web W and the slot die 13 as shown in FIG. 5, the gap G_{B} between the back plate 40a of the pressure reduction chamber 40 and the web W means the gap from the uppermost end of the back plate 40a to the web W.

The gap G_{B} between the back plate 40a and the web W is preferably made larger than the gap G_{C} between the top end lip 17 of the slot die 13 and the web W, by which the change of the degree of pressure reduction near the bead caused by the eccentricity of the back-up roll can be suppressed. For example, in a case where the gap G_{L} between the top end lip 17 of the slot die 13 and the web W is 30 μm or more and 100 μm or less, the gap G_{B} between the back plate 40a and the web W is preferably 100 μm or more and 500 μm or less.

### <Material, Accuracy>

As the length of the top end lip on the side of the advancing direction of the web in the web running direction is larger, it is disadvantageous for the formation of the bead and, when the length scatters between optional portions in the lateral direction of the slot die, the bead becomes instable even by slight external disturbance. Accordingly, it is preferred to design the length such that the fluctuation width in the lateral direction of the slot die is within 20 μm.

Further, with respect to the material for the top end lip of the slot die, in a case where a material such as a stainless steel is used, it sags in the die fabrication step and can not satisfy the accuracy for the top end lip even when the length of the slot die top end lip is defined within a range from 30 to 100 μm in the running direction of the web. Accordingly, for keeping the high fabrication accuracy, it is important to use a superhard material as described in JP No. 2817053. Specifically, it is preferred to form at least the top end lip of the slot die with a superhard alloy formed by bonding carbide crystals with an average grain size of 5 μm or less. The superhard alloy includes those bonding carbide crystal grains such as of tungsten carbide (hereinafter referred to as WC) with a bonding metal such as cobalt, and titanium, tantalum, niobium and mixed metals thereof can also be used for the bonding metal. The average grain size of WC crystals is further preferably 3 μm or less.

For attaining coating at high accuracy, scattering for the length of the land of the top end lip on the side of the web advancing direction and the gap relative to the web in the lateral direction of the slot die are also important factors. It is preferred to attain the combination of the two factors, that is, to attain a straightness within a range capable of restricting the fluctuation width of the gap to some extent. The straightness between the top end lip and back-up roll is defined such that the fluctuation width of the gap in the lateral direction of the slot die is 5 μm or less.

### <Coating Speed>

By attaining the accuracy for the back-up roll and the top end lip as described above, the coating system used preferably in the invention has high stability for film thickness during high speed coating. Further, since the coating system in the invention is a pre-metering system, the stable film thickness can, be ensured easily even during high speed coating. For the coating solution of a low coating amount such as in the anti-glare and anti-reflection film of the invention, the coating system of the invention can conduct coating at a high speed with good film thickness stability. While the coating is possible by other coating systems, a dip coating method inevitably undergoes vibrations of the coating solution in a liquid receiving tank tending to cause stepwise unevenness. A reverse roll coating method tends to cause stepwise unevenness due to the eccentricity or flexure of the roll concerned with the coating. Further, since the coating systems are post-metering system, it is difficult to ensure stable film thickness. It is preferred also in view of the productivity to apply coating at 25 m/min or more by using the manufacturing method of the invention.

### <Wet Coating Amount>

In a case of forming the anti-glare layer, it is preferred to coat the coating solution within a range of the wet coating thickness from 3 to 50 μm, for example 3 to 30 μm, directly or by way of other layer over a substrate film and, with a view point of preventing unevenness in the drying, a range from 3 to 20 μm is preferred, and a range of from 6 to 20 μm is more preferred. Further, in a case of forming the low refractive index layer, it is preferred to coat the coating composition within a range of from 1 to 10 μm as the wet coating thickness directly or by way of other layer over the anti-glare layer and it is coated, more preferably, within a range from 2 to 7 μm, and particularly preferably, within a range from 2 to 5 μm.

### [Drying]

The anti-glare layer and the low refractive index layer, after coated directly or by way of other layer over the substrate film, are transferred by the web to a heated zone for drying the solvent. In this case, the temperature for the drying zone is preferably from 25° C. to 140° C. and it is preferred that the temperature is relatively lower in the former half and relatively higher in the latter half of the drying zone. However, it is preferably lower than the temperature at which other ingredients than the solvent contained in the coating composition for each of the layers start to be evaporated. For example, commercial photo-radical generators to be used in combination with the UV-ray curable resin includes those which are evaporated by about several tens % within several minutes in a hot blow at 120° C. Further, mono-functional or 2-functional acrylate monomers include those in which evaporation proceeds in a hot blow at 100° C. In such a case, it is preferably at a temperature lower than that at which other ingredients than the solvent contained in the coating composition for each layer start evaporation.

The drying blow after coating the coating composition for each of the layers on the substrate film is preferably at a blow rate on the surface of the coating film within a range from 0.1 to 2 m/sec for the solid concentration of the coating composition between 1 to 50% in order to prevent unevenness in the drying.

Further, after coating the coating composition for each of the layers over the substrate film, it is preferred to control the temperature difference within 0° C. to 20° C. between the conveyor roll in contact with the substrate film on the side opposite to the coated surface thereof and the substrate film in the drying zone, since this can prevent unevenness in the drying caused by uneven heat conduction on the conveyor roll.

### [Curing]

After the drying zone for the solvent, the web is passed through a zone for curing each coating film by ionization radiation and/or heat to cure the coating film. For example, in a case where the coating film is UV-curable, UV-rays at an irradiation dose of from 10 mJ/cm² to 1000 mJ/cm² are preferably irradiated by UV-lamps to cure each of the layers. In this case, the distribution of the irradiation dose in the lateral direction of the web is preferably such a distribution of from 50 to 100% and, more preferably, a distribution of from 80 to 100% including as far as both ends relative to the maximum irradiation dose at the center. Further, in a case where it is necessary to lower the concentration of oxygen by purging a nitrogen gas or the like for promoting the surface cure, the oxygen concentration is preferably 5% or less, and particularly preferably from 0.01 to 5%. In particular, the oxygen concentration of the low refractive layer is preferably 0.1% or less, is more preferably 0.05% or less and is even more preferably 0.02% or less. The distribution of the oxygen concentration in the lateral direction is 2% or less.

In a case where the curing rate of the anti-glare layer (100—residual functional group content) reaches a certain value of less than 100%, when the low refractive index layer of the invention is disposed thereon and the curing rate of the anti-glare layer therebelow upon curing the low refractive index layer by ionization radiation and/or heat is increased more than that before forming the low refractive index layer, close adhesion between the anti-glare layer and the low refractive index layer is improved preferably.

The anti-glare and anti-reflection film of the invention manufactured as described above can be prepared into a polarizing plate and used in a liquid crystal display device. In this case, it is located to the uppermost surface of a display, for example, by providing a pressure sensitive adhesion layer on one surface. The anti-glare and anti-reflection film of the invention is preferably used for at least one of two protective films sandwiching the polarization film in the polarizing plate on both surfaces.

Since the anti-reflection film of the invention serves also as the protective film, the production cost for the polarizing plate can be decreased. Further, by the use of the anti-reflection film of the invention for the uppermost surface layer, transfer of external light can be prepared to provide a polarizing plate also excellent in scratch resistance and fouling resistance.

In a case of preparing a polarizing plate by using the anti-glare and anti-reflection film of the invention as one of the two surface protective films for the polarization film, it is preferred to improve the adhesion in the adhesive surface of the anti-glare and anti-reflection film by rendering the surface of the transparent support on the side opposite to the side having the anti-reflection structure, that is, the surface on the side bonded with the polarization film. The surface rendered hydrophilic is effective for improving the adhesion with the adhesive layer comprising polyvinyl alcohol as the main ingredient. As the treatment for rendering the anti-reflection film hydrophilic, the following saponifying treatment is preferably conducted.

### [Saponifying Treatment]

### (1) Method of Dipping in Alkali Solution

This is a method of dipping a light scattering film or an anti-reflection film in an alkali solution under an appropriate condition to apply a saponifying treatment for the entire surface of the film having reactivity with alkali and since this requires no special facility, it is preferred in view of the cost. The alkali solution is preferably an aqueous solution of sodium hydroxide. The concentration is, preferably, from; 0.5 to 3 mol/L and, particularly preferably, from 1 to 2 mol/L. The temperature of the alkali solution is, preferably, from 30 to 75° C. and, particularly preferably, from 40 to 60° C.

The combination of saponifying conditions is preferably a combination of relatively mild conditions to each other, which can be determined depending on the material and the constitution of the light scattering film and the anti-reflection film or the aimed angle of contact.

After dipping in the alkali solution, the film is preferably washed sufficiently with water so that the alkali ingredient does not remain in the film, or dipped in a diluted acid for neutralizing the alkali ingredient.

By saponification, the surface of the transparent support opposite to the surface having the anti-glare layer and the anti-reflection layer is rendered hydrophilic. The protective film for use in a polarizing plate is used while bringing the surface of the transparent substrate rendered hydrophilic in contact with the polarization film. The surface rendered hydrophilic is effective for improving the adhesion with the adhesive layer comprising polyvinyl alcohol as the main ingredient.

For the saponifying treatment, it is preferred that the angle of contact to water is lower at the surface of the transparent support on the side opposite to the side having the anti-glare layer and the low refractive index layer, in view of adhesion with the polarization film. On the other hand, since the surface having the anti-glare layer and the low refractive index layer as well as the inside thereof undergo the alkali damage in the dipping method, it is important to adopt minimum necessary reaction conditions. In a case of using the angle of contact to water of the transparent support at the surface on the side opposite to that having the anti-glare layer and the low refractive index layer as the index of damages given to each of the layers due to the alkali, it is preferably from 10° to 50°, more preferably, from 30° to 50° and, further preferably, from 40° to 50° particularly in a case where the transparent support is triacetyl cellulose. In a case, it is 50° or more, it is not preferred since this results in a problem in view of adhesion with the polarization film. On the other hand, in a case it is below 10°, it is not preferred since physical strength is deteriorated because the damage is excessively large.

### (2) Method of Coating Alkali Solution

As means for avoiding the damages to each of the films in the dipping method described above, an alkali solution coating method of coating the alkali solution only on the surface opposite to the surface having the anti-glare layer and the low refractive index layer, and heating, water washing and drying the same under appropriate conditions is preferably used. The coating in this case means that the alkali solution or the like is brought into contact only to the surface for applying saponification and this is also conducted, for example, by spraying or by contact with a liquid-containing belt other than the coating. Since facilities and steps for coating the alkali solution are additionally necessary by the use of such methods, they are inferior to the dipping method (1) in view of the cost. On the other hand, since the alkali solution is in contact only with the surface applied with the saponifying treatment, the opposite surface may have a layer using a material sensitive to the alkali solution. For example, while vapor deposition film or sol-gel film is not desirable in the dipping method since various disadvantageous effects such as corrosion, dissolution, peeling, etc. are caused by the alkali solution, they can be used with no troubles since they are not in contact with the solution in the case of the coating method.

Since any of the coating methods (1) and (2) can be conducted after forming each of the layers being rewound from the rolled support, it may be conducted as a series of operation in addition to the step of manufacturing the anti-glare and anti-reflection film described above. Further, by also conducting the bonding step to the polarizing plate comprising the rewound support in the same manner continuously, the polarizing plate can be prepared at a higher efficiency than conducting the same operation sheet by sheet.

(3) Saponifying Method by Protecting Anti-Glare Layer and Anti-Reflection Layer with Laminate Film

In the same manner (2) above, in a case where the anti-glare layer and/or low refractive index layer is insufficient for the durability to the alkali solution, by bonding a laminate film to a surface forming a final layer after forming the final layer and dipping them in the alkali solution, only the triacetyl cellulose surface on the side opposite to the surface formed with the final layer is rendered hydrophilic and then the laminate film is released subsequently. Also in this method, the hydrophilic treatment necessary for the polarizing plate protective film can be applied only to the surface of the triacetyl cellulose film opposite to the surface formed with the final layer with no damages to the anti-glare layer and the low refractive index layer. Compared with the method (2) described above, while the laminate film result in wastes, an advantage of requiring no special device for coating the alkali solution is provided.

(4) Method of Dipping into Alkali Solution After Forming as far as Anti-Glare Layer

In a case where the components as far as the anti-glare layer are resistant to the alkali solution but the low refractive index layer has insufficient resistance to the alkali solution, the components are formed as far as the anti-glare layer, and then they are dipped in the alkali solution to apply the hydrophilic treatment on both surfaces, and then the low refractive index layer can be formed on the anti-glare layer. While the manufacturing step is complicated, this provides an advantage capable of improving the interlayer adhesion between the anti-glare layer and the low refractive index layer particularly in a case where the low refractive index layer has hydrophilic layers such as a fluoro-containing sol-gel film.

### (5) Method of Forming Anti-Glare Layer and Anti-Reflection Layer to Previously Saponified Triacetyl Cellulose Film

A triacetyl cellulose film may be saponified, for example, by previously dipping into an alkali solution and then an anti-glare layer and a low refractive index layer may be formed directly or by way of other layer to one of the surfaces. In a case of saponification by dipping in the alkali solution, the inter-layer adhesion between the anti-glare layer or other layer and the triacetyl cellulose surface rendered hydrophilic by saponification is sometimes worsened. In such a case, this can be coped with by forming the anti-glare layer or other layer after removing the hydrophilic surface by applying a treatment such as corona discharge or glow discharge only to the surface on which the anti-glare layer or other layer is formed. Further, in a case where the anti-glare layer or other layer has hydrophilic groups, the inter-layer adhesion may sometimes be satisfactory.

Description is to be made to a polarizing plate using the light scattering film or the anti-reflection film of the invention, as well as a liquid crystal display device using the polarizing plate.

### [Polarizing Plate]

A preferred polarizing plate of the invention has the film of the invention as at least one of the protective films for the polarization film (protective film for use in polarizing plate). The protective film for use in the polarizing plate, preferably, has an angle of contact to water in a range from 10° to 50° at the surface of the transparent support on the side opposite to that having the anti-glare layer and the anti-reflection layer, that is, at the surface on the side appended with the polarization film.

By the use of the film of the invention as the protective film for use in the polarizing plate, polarizing plate having a light scattering function or an anti-reflection function excellent in physical strength and light fastness can be manufactured, making it possible for remarkable saving of the cost and reduction of the thickness of the display device.

Further, by manufacturing a polarizing plate using the film of the invention for one of protective films for use in the polarizing plate and an optical compensation film having optical anisotropy to be described later for the other of the protective films of the polarization film, a polarizing plate further improved with the visibility and the contrast of the liquid crystal display device in a bright room, and capable of greatly extending the view field angle in the vertical and right-to-left directions can be manufactured.

### [Optical Compensation Film]

By providing an optical compensation film (optical anisotropic film) to a polarizing plate, the view field angle characteristic of a liquid crystal display screen can be improved. The optical compensation film can preferably be used on the opposite side of the ant-glare, anti-reflection film of the invention with sandwiching the polarizer. The optical compensation film may be stuck, with an adhesive, onto one of the protective films for the polarizing plate on the opposite side to the side on which the film of the invention is used. From the view point of the thickness of the polarizing plate, it is particularly preferred to use the film of the invention as a protective film on one side of the polarizing plate and use the optical compensation film as a protective film on the opposite side of the polarizing plate with sandwiching the polarizer by the two films. As to the optical compensation film, the film itself may acquire a specific optical anisotropy by incorporating an optically anisotropic substance in the film itself, by stretching the film or by conducting both, or an optically anisotropic layer (retardation layer) may be provided on the film.

While known optical compensation layers can be used, in view of extending the view field angle, it is preferred to use an optical compensation layer having a layer with an optical anisotropy comprising a compound having a discotic structural unit in which the disk surface of the discotic compound is inclined relative to the surface of the protective film and the angle formed between the disk surface of the discotic compound and the surface of the protective film changes along with the distance from the surface of the protective film (changes in the direction of the depth of the optical anisotropic layer).

The angle preferably increases along with increase in the distance of the optical anisotropic layer comprising the discotic compound from the surface of the protective film.

Also, in order to improve contrast or tint of a liquid crystal display, it is also preferred to use a cellulose acylate film having such a small optical anisotropy (Re, Rth) that it substantially has an optical isotropy and showing a small wavelength dispersion of optical anisotropy (Re, Rth). With a reflection type display, it is also preferred to use a film having the function of a λ/4 plate composed of a single sheet or a plurality of sheets.

In a case of using the optical compensation layer as the protective film for the polarization film, the surface on the side bonded with the polarization film is preferably saponified and this is practiced in accordance with the saponification treatment.

### [Polarization Film]

As the polarization film, a known polarization film or a polarization film cut out from an elongate polarization film with an absorption axis of the polarization film being neither parallel nor perpendicular to the longitudinal direction may be used. The elongate polarization film with the absorption axis of the polarization film being neither parallel nor perpendicular to the longitudinal direction is prepared by the following method.

That is, the film can be manufactured by a stretching method of stretching a polarization film stretched by applying a tension while retaining both ends of a polymer film supplied continuously by retaining means by a factor at least from 1.1 to 20.0 times in the lateral direction of the film, and bending the film running direction in a state of retaining both ends of the film such that the difference of the running speed of the retaining devices between both ends of the film in the longitudinal direction is within 3%, and an angle formed between the traveling direction of the film at the exit of the step of retaining both ends of the film and the substantial stretching direction of the film is inclined by from 20 to 70°. Particularly, a film inclined at 45° is used preferably in view of the productivity.

The stretching method of the polymer film is described specifically in JP-A No. 2002-86554, in columns 0020 to 0030.

### <Liquid Crystal Display Device>

The polarizing plate using the film of the invention can be applied to image display devices such as a liquid crystal display device (LCD), a plasma display panel (PDP), electrolumiscence display device (ELD),a cathode ray tube display device (CRT), a field emission display (FED) and a surface-conduction electron-emitter display (SED). Since the film of the invention has a transparent support, it is used while bonding the side of the transparent support to the image display surface of the image display device.

The film of the invention can be applied, in a case of use for one side of the surface protective film of the polarization film, to transmission type, reflection type or semi-transmission type liquid crystal display devices such as in the modes of twisted nematic (TN), super-twisted nematic (STN), vertical alignment (VA), in-plane switching (IPS), optically compensated bend cell (OCB) and ECB etc. Particularly, it can be used preferably, for example, in VA, IPS, OCB, etc. and can be preferably used also for TN and STN in the application use of medium or small sized display devices of low fineness. For the application use such as in large-sized liquid crystal television sets, it is preferably used particularly to those in which the diagonal line of the display screen is preferably 20 inch or more and the fineness is XGA or less (1024×768 or less in a display device with 3:4 a longitudinal/lateral ratio). Since the film of the invention is substantially free from the internal haze, dazzling sometimes exceeds an allowable level in those of 20 inch size and with a fineness in excess of XGA (1024×768 in a display device at 3:4 longitudinal/lateral ratio), it is not preferred in a case where the importance is attached to dazzling. Further, since the degree of dazzling depends on the relation between the size of the pixel and the surface unevenness shape of the anti-glare film on the surface, it can be used preferably to a fineness of UXGA (1600×1200 in a display device at 3:4 longitudinal/lateral ratio) or less for the display device sized 30 inch and to a fineness of QXGA (2048×1536 in a display device at 3:4 longitudinal/lateral ratio) or less for the display device sized 40 inch.

The liquid crystal cell of VA mode includes (1) a liquid crystal cell of a VA mode in the narrow meaning in which bar-shape liquid crystalline molecules are oriented substantially perpendicularly upon not application of voltage and oriented substantially horizontally upon application of voltage (described in JP-A No. 2-176625) and, in addition, (2) liquid crystal cell of a multi-domained mode (MVA mode) for extending the view field angle (described in SID 97, Digest of tech. Papers (pre-text) 28 (1997) 845), and (3) liquid crystal cell of a mode (n-ASM mode) in which bar-shape liquid crystalline molecules are oriented substantially perpendicular upon not application of voltage and oriented in twisted multi-domained mode upon application of voltage (n-ASM mode) (described in the pre-text of Japan Liquid Crystal Discussion Meeting, Nos. 58 to 59, (1998)), and (4) a liquid crystal cell of a SURVIVAL mode (reported in LDC International 98).

The liquid crystal cell of the OCB mode is a liquid crystal display device using a liquid crystal cell of a bend orientation mode in which bar-shape liquid crystalline molecules are oriented in the direction substantially in the opposite directions between the upper portion and the lower portion (symmetrically) of the liquid crystal cell, which is disclosed in each of the specifications of U.S. Pat. Nos. 4,583,825 and 5,410,422. Since the bar-shape crystalline molecules are oriented in symmetry between the upper portion and the lower portion of the liquid crystal cell, the liquid crystal cell of the bend orientation mode has a self-optical compensation function. Accordingly, this liquid crystal mode is referred to also as the OCB (Optically Compensatory Bend) liquid crystal mode. The liquid crystal display device of the bend orientation mode has an advantage of high response speed.

In the liquid crystal cell of the ECB mode, the bar-shape liquid crystalline molecules are oriented substantially horizontally upon not application of voltage and have often been utilized for color TFT liquid crystal display device and described in number of literatures. For example, it is described in “DL, PDP, LCD display” issued from Toray Research Center (2001).

### EXAMPLE

The present invention is to be described specifically with reference to examples but the invention is not restricted to them. Unless otherwise specified, “parts” and “%” are on the mass basis.

### Example 1

### Synthesis of Perfluoroolefin Copolymer (1)

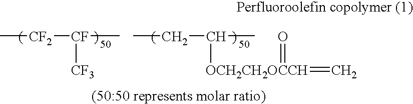

40 ml of ethyl acetate, 14.7 g of hydroxyethyl vinyl ether, and 0.55 g of dirauloyl peroxide were charged in an autoclave of 100 ml inner volume with a stirrer made of stainless steel and the inside of the system was deaerated and replaced with a nitrogen gas. Further, 25 g of hexafluoropropylene (HFP) was introduced into the autoclave and the temperature was elevated to 65° C. The pressure at the instance the temperature inside the autoclave reached 65° C. was 0.53 MPa (5.4 kg/cm²). Reaction was continued for 8 hours while keeping the temperature and heating was stopped at the instance the pressure reached 0.31 MPa (3.2 kg/cm²) and the system was allowed to cool. At the instance the internal temperature lowered to the room temperature, unreacted monomers were discharged, the autoclave was opened and the reaction solution was taken out. The obtained reaction solution was changed in a great excess of hexane and the solvent was removed by decantation to recover a precipitated polymer. Further, the residual monomer was moved completely by dissolving the polymer into a small amount of ethyl acetate and conducting re-precipitation twice from hexane. After drying, 28 g of the polymer was obtained. Then, after dissolving 20 g of the polymer in 100 ml of N,N-dimethyl acetoamide and dropping 11.4 g of acrylic acid chloride under ice cooling, they were stirred at a room temperature for 10 hours. Ethyl acetate was added to the reaction solution, washed with water, the organic layer was extracted and then concentrated and the obtained polymer was re-precipitated with hexane to obtain 19 g of the perfluoroolefin copolymer (1). The refractive index of the obtained polymer was 1.421.

### (Preparation of Sol Solution)

After admixing 120 parts of methyl ethyl ketone, 100 parts of acryloyloxy propyl trimethoxy silane (KBM-5103, manufactured by Shinetsu Chemical Industry Co.), and 3 parts of diisopropoxy aluminum ethyl acetoacetate to a reactor having a stirrer and a reflux cooler, 30 parts of ion changed water was added and reacted at 60° C. for 4 hours. Then they were cooled to a room temperature to obtain a sol solution a. The mass average molecular weight was 1600 and the ingredients with the molecular weight of from 1,000 to 20,000 were 100% in the oligomer or higher ingredients. Further, based on the gas chromatographic analysis, the starting material, acryloyloxy propyl trimethoxy silane was not remained at all.

### (Preparation of Coating Solution A for Use in Anti-Glare Layer)

25.4 g of a mixture of dipentaerythritol pentaacrylate and dipentaerythritol hexaacrylate (DPHA, manufactured by Nippon Kayaku Co.) was diluted with 46.3 g of methyl isobutyl ketone. Further, 1.3 g of a polymerization initiator (Ilugacure 184, manufactured by Ciba Speciality chemicals Co.) was added and mixed under stirring. Successively, 0.04 g of a surface modifying fluoro-agent (FP-149), 5.2 g of a silane coupling agent (KBM-5103, manufactured by Shinetsu Chemical Industry Co.), and 0.50 g of cellulose acetate butyrate with a molecular weight of 40,000 (CAB-531-1, manufactured by Eastman Chemical Co.) were added and stirred by air dispersion for 120 min to completely dissolve solutes. The refractive index of a coating film obtained by coating the solution and by UV-ray curing was 1.520.

Finally, after adding 21.0 g of a 30% methyl isobutyl ketone liquid dispersion of crosslinked poly(acryl-styrene) particles of an average grain size of 3.5 μm (copolymer compositional ratio=50/50, refractive index:1.536) dispersed by a polytron dispersing machine at 10,000 rpm for 20 min to the solution, they were stirred by air dispersion for 10 min.

The liquid mixture was filtered by a filter made of polypropylene of 30 μm pore size to prepare a coating solution A for use in an anti-glare layer.

### (Preparation of Coating Solution B for Use in Anti-Glare Layer)

A coating solution B for use in an anti-glare layer was prepared in the same manner as the coating solution A for use in the anti-glare layer except for changing methyl isobutyl ketone (vapor pressure at 21.7° C.: 16.5 mmHg) used as the main solvent from 46.3 g to 40.0 g, and adding 6.3 g of propylene glycol (vapor pressure at 20.0° C.: 0.08 mmHg) as the small amount solvent having hydroxyl groups.

### (Preparation of Coating Solution C for Use in Anti-Glare Layer)

12.7 g of a mixture of dipentaerythritol pentaacrylate and dipentaerythritol hexaacrylate (DPHA, manufactured by Nippon Kayaku Co.) was diluted with 16.7 g of methyl isobutyl ketone, and 42.3 g of a colloidal silica liquid dispersion MiBK-ST (commercial name of products, average grain size: 15 nm, solid concentration: 30%, manufactured by Nissan Chemical Co.) was added. Further, 1.3 g of a polymerization initiator (Ilugacure 184, manufactured by Ciba Speciality Chemicals Co.) was added and mixed under stirring. Successively, 0.04 g of a surface modifying fluoro-agent (EP-149), 5.2 g of a silane coupling agent (KBM-5103, manufactured by Shinetsu Chemical Industry Co.), and 0.50 g of cellulose acetate butyrate with a molecular weight of 40,000 (CAB-531-1, manufactured by Eastman Chemical Co.) were added and stirred by air dispersion for 120 min to completely dissolve solutes. The refractive index of the coating film obtained by coating a solution and by UV-ray curing was 1.500.

Finally, after adding 21.0 g of a 30% methyl isobutyl ketone liquid dispersion of crosslinked poly(methyl methacrylate) particles of an average grain size of 3.0 μm (containing 10% crosslinking agent=ethylene glycol dimethacrylate, refractive index: 1.492) dispersed by a polytron dispersing machine at 10,000 rpm for 20 min to the solution, they were stirred by air dispersion for 10 min.

The liquid mixture was filtered by a filter made of polypropylene of 30 μm pore size to prepare a coating solution C for use in an anti-glare layer.

### (Preparation of Coating Solution D for Use in Anti-Glare Layer)

A coating solution D for use in anti-glare layer was prepared in the same manner as the coating solution A for use in the anti-glare layer except for changing the crosslinked poly(acryl-styrene) particle with an average grain size of 3.5 μm (copolymer compositional ratio=50/50 refractive index 1.530) to crosslinked polystyrene particles (refractive index 1.607).

### (Preparation of Coating Solution E for Use in Anti-Glare Layer)

For the coating solution A for use in the anti-glare layer, a coating solution E for use in an anti-glare layer was prepared in the same manner as the coating solution A for use in the anti-glare layer except for changing the amount of the mixture of dipentaerythritol pentaacrylate and dipentaerythritol hexaacrylate (DPHA, manufactured by Nippon Kayaku Co.) to 24.3 g, that of methyl isobutyl ketone to 43.8 g, and a 30% methyl isobutyl ketone liquid dispersion of the crosslinked poly(acryl-styrene) particle (copolymer compositional ratio=50/50, refractive index: 1.536) to 24.6 g.

### (Preparation of Coating Solution F for Use in Anti-Glare Layer)

For the coating solution E for use in the anti-glare layer, a coating solution F for use in an anti-glare layer was prepared in the same manner as in the coating solution E for use in the anti-glare layer except for changing the crosslinked poly(acryl-styrene) particle (copolymer compositional ratio=50/50, refractive index: 1.536) an average grain size of 3.5 μm to that (copolymer compositional ratio=60/40, refractive index: 1.554).

### (Preparation of Coating Solution A for Use in Low Refractive Index Layer)

After adding and stirring 13 g of a heat crosslinking fluoro-containing polymer with a refractive index of 1.44 containing polysiloxane and hydroxyl groups (JTA113, solid concentration: 6%, manufactured by JSR Corp.), 1.3 g of colloidal silica liquid dispersion MEK-ST-L (commercial name of products, average grain size: 45 nm, solid concentration: 30%, manufactured by Nissan Chemical Co.), 0.6 g of the sol solution described above, 5 g of methyl ethyl ketone and 0.6 g of cyclohexanone, they were filtered through a filter made of polypropylene with a 1 μm pore size to prepare a coating solution for use in a low refractive index layer. The refractive index of the layer formed from the coating solution was 1.45.

### (Preparation of Coating Solution B for Use in Low Refractive Index Layer)

### (Preparation of Liquid Dispersion a)

After adding 30 g of acryloyloxy propyl trimethoxy silane (manufactured by Shinetsu Chemical Industry Co.) and 1.5 g of diisopropoxy aluminum ethyl acetate to 500 g of fine hollow silica particle sol (isopropyl alcohol silica sol, average grain size: 60 nm, shell thickness: 10 nm, silica concentration: 20 mass %, refractive index of silica particle: 1.31, according to Preparation Example 4 in JP-A No. 2002-79616 prepared while changing the size) and mixing them, 9 g of ion exchanged water was added. After reaction at 60° C. for 8 hours, they were cooled to a room temperature and 1.8 g of acetyl acetone was added. While adding cyclohexanone to 500 g of the liquid dispersion such that the silica content was substantially constant, solvent replacement was conducted by distillation under a reduced pressure at a pressure of 20 kPa. Obstacles were nor formed in the liquid dispersion and, when the solid concentration was controlled to 20 mass % with cyclohexane, the viscosity was 5 mPa·s at 25° C. When the residual amount of isopropyl alcohol in the obtained liquid dispersion A was analyzed by gas chromatography, it was 1.5%.

### (Preparation of Coating Solution B)

To 783.3 mass parts of Opstar-JTA113 (heat crosslinking fluoro-containing silicone polymer compositional solution (solid content: 6%): manufactured by JSR Corp.) (47.0 mass parts as the solid content), were added 195 mass parts of the liquid dispersion A (39.0 mass parts as: silica+surface treatment agent solid content), 30.0 mass parts of a colloidal silica dispersion (silica, MEK-ST of different grain size, average grain size: 45 nm, solid concentration: 30%, manufactured by Nissan Chemical Co.) (9.0 mass parts as solid content), and 17.2 mass parts of the sol solution a (5.0 mass parts as the solid content). The coating solution B for use in a low refractive index layer was prepared by dilution with cyclohexane and methyl ethyl ketone such that the ratio of cyclohexane and methyl ethyl ketone was 10:90. The refractive index of the layer formed from the coating solution was 1.39.

### (Preparation of Coating Solution C for Use in Low Refractive Index Layer)

After adding and stirring 15.2 g of a perfluoroolefin copolymer (1), 2.1 g of a hollow silica sol (refractive index: 1.31, average grain size: 60 nm, solid concentration 20%), 0.3 g of reactive silicone X-22-164B (commercial name of products: manufactured by Shinetsu Chemical Industry Co.), 7.3 g of sol solution a, 0.76 g of a photopolymerization initiator (Ilugacure 907 (commercial name of products), manufactured by Ciba Specialty Chemicals Co.), 301 g of methyl ethyl ketone, and 9.0 g of cyclohexane, they were filtered by a filter made of polypropylene with 5 μm pore size to prepare a coating solution C for use in a low refractive index layer. The refractive index of the layer formed from the coating solution was 1.40.

### Example 1

### (1) Coating of Anti-Glare Layer

A triacetyl cellulose film of 80 μm thickness (TAC-TD80U, manufactured by Fuji Photofilm Inc.) was unwound from a roll form as a transparent support, the coating solution A for use in the anti-glare layer was coated by a die coat method with the device constitution and the coating conditions described below and, after drying at 30° C. for 15 sec and 90° C. for 20 sec, UV-rays at an irradiation dose of 90 mJ/cm² were irradiated under nitrogen purge by using an air-cooled metal halide lamp (manufactured by I Graphics Co.) at 160 W/cm to cure the coating layer and an anti-glare layer of 6 μm thickness having an anti-glare property was formed and wound up.

### Basic Condition:

A slot die 13 having an upper stream lip land length lup of 0.5 mm, a down stream lip land length I_{LO} of 50 μm, the opening length of the slot 16 in the web running direction of 150 μm and a length of the slot 16 of 50 mm was used. The gap between the upstream lip land 18a and the web W was made longer by 50 μm than the gap between the downstream lip land 18b and the web W (hereinafter referred to as an overbite length of 50 μm), and the gap G_{L} between the down stream lip land 18b and web W was set to 50 μm. Further, the gap G_{S} between the side plate 40b of the pressure reduction chamber 40 and the web W, and the gap G_{B} between the back plate 40a and the web W was set each to 200 μm. In accordance with the liquid property of each of the coating solutions, coating was conducted at a coating speed=20 m/min, and at a wet coating amount=17.5 ml/m² in a case of coating solutions A, C, D for use in the anti-glare layer, at a coating speed=40 min/min and at a wet coating amount=21.0 ml/m² in a case of coating solution B for use in the anti-glare layer, and at a coating speed=40 m/min, and at a wet coating amount=5.0 ml/m² for the low refractive index layer. The coating width was 1300 nm and the effective width was 1280 nm.

### (2) Coating of Low Refractive Index Layer

The triacetyl cellulose film provided with the anti-glare layer by coating the coating solution A for use in the anti-glare layer was unwound again, the coating solution A for use in the low refractive index layer was coated under the basic conditions described above and, after drying at 120° C. for 150 sec, it was further dried at 140° C. for 8 min and UV-rays were irradiated at an irradiation dose of 300 mJ/cm² by using an air-cooled metal halide lamp at 240 W/cm (manufactured by I Graphic Co.) in an atmosphere of 0.1% oxygen concentration under nitrogen purge and a low refractive index layer of 100 nm thickness was formed and wound up.

### (3) Saponification Treatment for Anti-Glare and Anti-Reflection Film

After forming the film of the low refractive index layer, the following treatment was conducted for the specimens described above.

An aqueous 1.5 mol/L solution of sodium hydroxide was prepared and kept at a temperature of 55° C. An aqueous 0.01 mol/L solution of diluted sulfuric acid was prepared and kept at a temperature of 35° C. After dipping the prepared anti-glare anti-reflection film in the aqueous solution of sodium hydroxide for 2 min, it was dipped in water and aqueous sodium hydroxide solution was washed out sufficiently. Then, after dipping for one min in the aqueous solution of diluted sulfuric acid, it was dipped in water and the aqueous solution of diluted sulfuric acid was washed off sufficiently. Finally, the specimen was dried sufficiently at 120° C.

In this way, an anti-glare and anti-reflective film after saponification treatment was manufactured. This is Example 1-1.

An anti-glare layer was formed in the same manner as in Example 1-1 except for changing the coating solution A for use in the anti-glare layer to coating solutions B to F for use in the anti-glare layer and, further, coating and saponification treatment of the low refractive index layer were conducted in the same manner as in Example 1-1. Those coated with the coating solution B for use in the anti-glare layer are Example 1-2, those coated with the coating solution C for use in the anti-glare layer are Example 1-3, those coated with the coating solution E for use in the anti-glare layer is Example 1-4, those coated with the coating solution F for use in the anti-glare layer is Example 1-5, and those coated with the coating solution D for use in the anti-glare layer is Example 1-6 Examples 1-7 and 1-8 and Comparative Example 1-1 were prepared in the same manner as with Example 1-4 except for changing the coating amount of the coating solution E for use in the anti-glare layer and changing the thickness of the film.

Examples 1-9 and 1-10 and Comparative Example 1-2 were prepared in the same manner as with Example 1-5 except for changing the coating amount of the coating solution F for use in the anti-glare layer and changing the thickness of the film.

Comparative Example 1-3 was prepared in the same manner as with Example 1-6 except for changing the coating amount of the coating solution D for use in the anti-glare layer and changing the thickness of the film.

### (Evaluation for Anti-Glare Layer)

The thus obtained films were evaluated for the following items. The result is shown in Table 1.

### (1) Average Reflectivity

After roughening the rear face of the film with sand paper, it was treated with a black ink to eliminate rear face reflection and, in this state, the surface was measured for specular reflectivity at an incident angle of 5° in a wavelength region for 380 to 780 nm by using a spectrophotometer (manufactured by JASCO). For the result, an arithmetic average value for the specular reflectivity at 450 to 650 nm was used.

### (2) Haze

The total haze (H), internal haze, (Hi) and surface haze (Hs) of the obtained film were measured by the following measurement.

1. The total haze value (H) of the film obtained was measured according to JIS-K-7136.

2. Silicone oil was added by several drops to the obtained film at the surface and the rear face relative to the side of the low refractive index layer, they were sandwiched by using two sheets of glass plates each of 1 mm thickness (microslide glass #S 9111, manufactured by MATSUNAMI) on the surface and the rear face, to optically bring the two sheets of glass plates and the obtained film into close contact completely, and the haze was measured in a state of eliminating the surface haze. The value obtained by subtracting the haze measured by sandwiching only the silicone oil between the two sheets of glass plates measured separately was calculated as the internal haze (Hi) of the film.

3. The value obtained by subtracting the internal haze (Hi) calculated according to 2 from the total haze (H) calculated according to 1 was calculated as the surface haze (Hs).

The haze value referred to in the invention means the total haze (H) obtained by the method described above.

### (3) Image Clarity

The transparent image clarity was measured for an optical comb-width 0.5 mm according to JIS K7105.

### (4) Roughness Average Ra

The Roughness average Ra of the obtained film was measured according to ANSI/ASME B46, 1-1985.

(5) Anti-Glare Property

An exposed fluorescence lamp (8000 cd/m²) with no louver was reflected on the obtained film at an angle of 45° and the degree of blurring of the reflected images when observed in the direction of −45° was evaluated based on the following standards.

Profile of the fluorescence lamp can not be observed at all: ⊚
Profile of the fluorescence lamp can be observed slightly: ◯
The fluorescence lamp is blurred but the profile can be discriminated: Δ
The fluorescence lamp is scarcely blurred: X

### (6) Blackness

Commercially available two polarizing plates were stuck onto both sides of a glass substrate so that the absorption axes thereof were vertical to each other, and each of the films obtained was stuck onto one side of the polarizing plate with the support side of the film facing the polarizing plate using an adhesive. An exposed fluorescence lamp (8000 cd/m²) with no louver was reflected on the obtained film in a dark room at an angle of 60° above, and the state of black all over the surface (blackness) was visually evaluated from the front according to the following standard.

Blackness is very good: ⊚

Blackness is good: ◯

Blackness is somewhat bad: Δ

Blackness is bad: X

### (7) Internal White Turbidity

Each sample comprising the film obtained between two glass plates upon measurement of internal haze sandwiched with a silicone oil was placed in a dark room on a plane light source to evaluate the internal white turbidity of the film.

White turbidity was not obtrusive: ⊚

White turbidity was somewhat obtrusive: ◯

White turbidity was obtrusive: Δ

White turbidity was seriously obtrusive: X

TABLE 1

| | | | | | | | Anti- | | |
|---|---|---|---|---|---|---|---|---|---|
| | Average | Internal | Surface | Total | | | glare | | |
| | Reflectivity | Haze | Haze | Haze | | Image | Properties | | Internal |
| | (%) | (%) | (%) | (%) | Ra (μm) | Clarity (%) | (%) | Blackness | Turbidity |
| Example 1-1 | 1.8 | 10.0 | 5.2 | 15.2 | 0.18 | 15.3 | ⊚ | ⊚ | ⊚ |
| Example 1-2 | 1.7 | 10.2 | 4.9 | 15.1 | 0.18 | 16.2 | ⊚ | ⊚ | ⊚ |
| Example 1-3 | 1.9 | 5.1 | 6.2 | 11.3 | 0.13 | 28.0 | ◯ | ◯ | ⊚ |
| Example 1-4 | 1.8 | 20.8 | 8.3 | 29.1 | 0.23 | 14.4 | ⊚ | ◯ | ◯ |
| Example 1-5 | 1.7 | 28.4 | 10.7 | 39.1 | 0.27 | 13.8 | ⊚ | Δ | Δ |
| Example 1-6 | 1.7 | 38.5 | 8.5 | 47.0 | 0.20 | 11.5 | ⊚ | ◯ | Δ |
| Example 1-7 | 2.1 | 28 | 2 | 30 | 0.12 | 40 | ◯ | ⊚ | ◯ |
| Example 1-8 | 1.9 | 24 | 5 | 29 | 0.16 | 25 | ◯ | ⊚ | ◯ |
| Comparative | 0.9 | 18 | 23 | 41 | 0.31 | 14 | ⊚ | X | ◯ |
| Example 1-1 | | | | | | | | | |
| Example 1-9 | 2.2 | 37 | 3 | 40 | 0.14 | 30 | ◯ | ⊚ | Δ |
| Example 1-10 | 1.9 | 32 | 6 | 38 | 0.18 | 24 | ◯ | ⊚ | Δ |
| Comparative | 1.1 | 25 | 21 | 46 | 0.30 | 15 | ⊚ | X | ◯ |
| Example 1-2 | | | | | | | | | |
| Comparative | 2.0 | 45 | 5 | 50 | 0.16 | 26 | ◯ | ⊚ | X |
| Example 1-3 | | | | | | | | | |

In Examples of the invention, samples showing excellent blackness and reduced internal white turbidity were prepared.

Anti-glare films (1-11 to 1-20) were prepared in the same manner except for not forming the low refractive index layer in each of Examples 1-1 to 1-10. Although blackness was somewhat deteriorated in comparison with Examples 1-1 to 1-10, they showed good evaluation results with respect to blackness and internal white turbidity.

Further, when an anti-glare and anti-reflection film was prepared in the same manner except for replacing the coating solution A for use in the low refractive index layer of Example 1-1 with the coating solution B for use in the low refractive index layer, the average reflectivity was improved to 1.2%, and blackness was more improved than with Example 1-1.

Further, when an anti-glare and anti-reflection film was prepared in the same manner except for replacing the coating solution A for use in the low refractive index layer of Example 1-1 with the coating solution C for use in the low refractive index layer and for changing the drying time after the coating to 1 minute at 90° C. and changing the irradiation dose of the UV-rays after the coating to 900 mJ/cm², the average reflectivity was improved to 1.5%, and blackness was more improved than with Example 1-1. Further, the scratch resistance could be improved.

With the Example films, an average value Sm of intervals of peak-to-valley period determined from intersection points of the surface roughness curve and the average line was measured according to JIS-B0601 to find that the average value was within a range of from 55 to 120 μm with every film.

### Example 2

### Preparation of Polarizing Plate)

A polarizing plate was manufactured by bonding for protection a triacetyl cellulose film (TAC-TD80U, manufactured by Fuji Photofilm Co., hereinafter referred to as TAC film) of 80 μm thickness which was dipped in an aqueous 1.5 mol/L of NaOH solution at 55° C. for 2 min and then neutralized and washed with water, and each of anti-glare and anti-reflection films prepared in Example 1 (after saponification treatment: Example 1-1 to Example 1-10, Comparative Example 1-3) on both surfaces of a polarization film prepared from polyvinyl alcohol by adsorption of iodine and stretching. The surface of the transparent support of the anti-glare anti-reflection film prepared in Example 1 was bonded to the polarization film. They are Example 2-1 to Example 2-10 and Comparative Example 2-1 to Comparative Example 2-3, respectively.

Further, a polarizing plate was manufactured by using the triacetyl cellulose film after the saponification treatment for the protective films on both surfaces. This is Comparative Example 2-4.

### Example 3

### Evaluation for Polarizing Plate

Display devices were manufactured by peeling a portion of a polarizing plate in each of liquid crystal television sets on the viewing surface and replacing the portion with polarizing plates of Example 2-1 to Example 2-10, Comparative Example 2-1 to Comparative Example 2-4, and Comparative Example 2-2 manufactured in Example 2 by the combination as shown in the following Table 2. Evaluation of the following items was conducted for the obtained display devices. The result is shown in Table 2.

### (1) White Blurring

For LCD television panels having fineness and image size described in the table (each of VA mode), the polarizing plates on the side of the surface were replaced with polarizing plates using two sheets of TAC films having smooth surface as the protective film, and a fluorescence lamp (8000 cd/m²) with no louver was reflected from an angle of 60° above onto the panel in the state of whole black display. A white lightening state (white blurring) of the whole screen was visually evaluated from the front according to the following standard.

White blurring was not obtrusive, and favorable: ⊚

White blurring was slightly obtrusive, but relatively favorable: O

Whitening was somewhat obtrusive: Δ

Whitening was remarkable and not favorable: X

Whitening was serious and not practically usable: XX

### (2) Dark Room Contrast

For LCD panels having fineness and image size described in the table (each of VA mode), the polarizing plates on the side of the surface were replaced (repapered) with polarizing plates using two sheets of TAC films having smooth surface as the protective film, and the front contrast was measured in a dark room.

Successively, the front contrast was measured in the same manner being replaced with each of the polarizing plates of Example 2 and Comparative Example 2 and the lowering ratio of the front contrast relative to the contrast value measured for the polarizing plate using the smooth TAC film as the protective film was evaluated on the percentage. For example, the contrast values for Example 3-1 and Comparative Example 3-1 were 868, and 882 respectively, in which lowering ratio was: (868−882)/882×100=−2% and this is expressed as −2% in the table. Additionally, the value measured for the polarizing plate using the standard TAC film as the protective film was obtained with the same panel (size, fineness, etc.).

### (3) Dazzling

In a state of solid green display on the LCD panels having fineness and images size described in the table, the degree of a state where partial enlargement/contraction for each of B, G, and R pixels was observed not uniformly (dazzling) was evaluated visually based on the following standards.

Dazzling was not observed at all, and favorable: ⊚
Dazzling was slightly observed but relatively favorable: ◯
Dazzling was somewhat obtrusive: Δ
Dazzling was remarkable and not favorable: X

### (4) Image Reflection

An exposed fluorescence lamp (8000 cd/m²) with no louver was reflected on the obtained liquid crystal television set at an angle of 45° and the degree of reflection of the fluorescence lamp observed in the direction of −45′ was evaluated based on the following standards.

Not reflected to such an extent as the profile of the fluorescence lamp could not be recognized at all: ⊚

The profile of the fluorescent lamp was slightly recognized but not reflected substantially: ◯

The profile of the fluorescent lamp was blurred but slightly reflected: Δ

The fluorescence lamp was reflected completely: X

TABLE 2

| | | Panel | | | | | |
|---|---|---|---|---|---|---|---|
| | Polarizing | Size | Panel | White | Dark Room | | Image |
| Specimen No. | plate | (inch) | Fineness | Blurring | Contrast (%) | Dazzling | Reflection |
| Example 3-1 | Example 2-1 | 32 | VGA | ⊚ | −2 | ⊚ | ⊚ |
| Example 3-2 | Example 2-2 | 32 | VGA | ⊚ | −2 | ⊚ | ⊚ |
| Example 3-3 | Example 2-3 | 32 | VGA | ◯ | −1 | ⊚ | ◯ |
| Example 3-4 | Example 2-4 | 32 | VGA | Δ | −3 | ⊚ | ⊚ |
| Example 3-5 | Example 2-5 | 32 | VGA | X | −4 | ⊚ | ⊚ |
| Example 3-6 | Example 2-6 | 32 | VGA | Δ | −11 | ⊚ | ⊚ |
| Comparative | Comparative | 32 | VGA | ⊚ | 0 (standard) | ⊚ | X |
| Example 3-1 | Example 2-1 | | | | | | |
| Example 3-7 | Example 2-1 | 20 | XGA | ⊚ | −2 | ◯ | ⊚ |
| Example 3-8 | Example 2-1 | 45 | XGA | ⊚ | not | ⊚ | ⊚ |
| | | | | | measured | | |
| Example 3-9 | Example 2-2 | 20 | XGA | ⊚ | −2 | ⊚ | ⊚ |
| Example 3-10 | Example 2-3 | 20 | XGA | ◯ | −1 | ⊚ | ◯ |
| Example 3-11 | Example 2-4 | 20 | XGA | Δ | −3 | ⊚ | ⊚ |
| Example 3-12 | Example 2-5 | 20 | XGA | X | −4 | ⊚ | ⊚ |
| Example 3-13 | Example 2-6 | 20 | XGA | Δ | −10 | ⊚ | ⊚ |
| Comparative | Comparative | 20 | XGA | ⊚ | 0 (standard) | ⊚ | X |
| Example 3-2 | Example 2-1 | | | | | | |
| Example 3-14 | Example 2-7 | 32 | VGA | ⊚ | −5 | ⊚ | ◯ |
| Example 3-15 | Example 2-8 | 32 | VGA | ⊚ | −4 | ⊚ | ◯ |
| Comparative | Comparative | 32 | VGA | XX | −3 | ⊚ | ⊚ |
| Example 3-3 | Example 2-1 | | | | | | |
| Example 3-16 | Example 2-9 | 32 | VGA | ⊚ | −10 | ⊚ | ◯ |
| Example 3-17 | Example 2-10 | 32 | VGA | ◯ | −7 | ⊚ | ◯ |
| Comparative | Comparative | 32 | VGA | XX | −4 | ⊚ | ⊚ |
| Example 3-4 | Example 2-2 | | | | | | |
| Comparative | Comparative | 32 | VGA | ⊚ | −15 | ⊚ | ◯ |
| Example 3-5 | Example 2-3 | | | | | | |

The results shown in Table 2 reveal the following.

When applied to a 20-inch or larger liquid crystal TV set, the anti-glare and anti-reflection films of the invention can provide a high anti-glare property and reduce deterioration of dark room contrast, dazzling and white blurring. Comparative Examples 3-1 and 3-2 were at a level not suited for a practical use. With Comparative Example 3-4, white blurring was at a level not suited for a practical use. Examples 3-5 and 3-12 showed remarkable white blurring, and Examples 3-4, 3-6, 3-11 and 3-13 showed somewhat bad white blurring. However, for uses of viewing general images on a TV set, the white blurring was not at a level of exerting detrimental influences. With Comparative Example 3-5, the dark room contrast was deteriorated to a level not suited for a practical use. Examples 3-13 and 3-16 were not at a level of not causing practical problems for uses of viewing general images on a TV set in a bright room, but suffered so serious reduction in dark room contrast that contrast was deteriorated in a dark environment. Regarding dark room contrast, Examples 3-1 to 3-3, 3-7 to 3-10 showed the best characteristics and, even in a dark environment, suffered no deterioration of contrast and were revealed to be the most preferred for the use of a TV set of 20 inches or larger.

### Example 4

In a case of using the anti-glare and anti-reflection films of Examples 1-1 to 1-10 for the protective film on the viewing surface of the polarizing plate on the viewing surface of a transmission type TN liquid crystal cells and using a view field angle extending film (wide view film SA 12B, manufactured by Fuji Photofilm Co. Ltd.) as the protective film of the polarizing plate on the side of the liquid crystal cell on the viewing surface and as a protective film of the polarizing plate on the side of the liquid crystal cell on the back light surface of a transmission type TN liquid crystal cells, liquid crystal display devices with an extremely wide view field angle in the vertical and right-to-left directions, extremely excellent in the visibility and at high image quality could be obtained.

### Example 5

In a case of replacing JTA113 or JN7228 for the coating solutions A and B for use in the low refractive index layer in Example 1 with a solution formed by dissolving 80 g of a fluoro-containing heat-curing polymer, 20 g of Cymel 303 (manufactured by Nippon Cytec Industries Inc.) as a curing agent and 2.0 g of a CATALYST 4050 (manufactured by Nippon Cytec Industries Inc.) as a curing catalyst dissolved in MEK by 6% as described in Example 1 of JP-A No. 11-189621, the same result as described above was obtained.

### Reference Example

An anti-glare layer and a low refractive index layer of Example 1-1 were coated by a bar coat method. While a No. 10 bar was used for the anti-glare layer and a No. 2.9 bar was used for the low refractive index layer, streak-like planar unevenness occurred in the anti-glare layer at a coating speed of 15 m/min or more and streak-like planar unevenness occurred in the low refractive index layer at a coating speed of 20 m/min or more.

### [Preparation of Composition for Use in Example 6]

### (Synthesis of Perfluoroolefin Copolymer (1′))

The perfluoroolefin copolymer (1′) is the same as the perfluoroolefin copolymer (1) in Example 1.

### (Preparation of Sol Solution)

The sol solution is the same as the sol solution of Example 1.

### (Preparation of Coating Solution A′ for Use in Anti-Glare Layer)

24.5 g of a commercially available zirconia-containing UV-curable hard coat solution (Desolite Z7404, manufactured by JSR Corp., solid concentration: about 61%, solvent: substituted with methyl isobutyl ketone, ZrO₂ content in the solid: about 70%, polymerizable monomer, containing polymerization initiator) was added to 5.0 g of a mixture of dip entaerythritol pentaacrylate and dip entaerythritol hexaacrylate (DPHA, manufactured by Nippon Kayaku Co.), and diluted with 33.4 g of methyl isobutyl ketone. Further, 0.06 g of a polymerization initiator (Ilugacure 184, manufactured by Ciba Speciality Chemicals Co.) was added and mixed under stirring. Successively, 0.04 g of a surface modifying fluoro-agent (FP-149), 5.2 g of a silane coupling agent (KBM-5103, manufactured by Shinetsu Chemical Industry Co.), and 0.50 g of cellulose acetate butyrate with a molecular weight of 40,000 (CAB-531-1, manufactured by Eastman Chemical Co.) were added and stirred by air dispersion for 120 min to completely dissolve solutes. The refractive index of a coating film obtained by coating the solution and by UV-ray curing was 1.610.

Finally, after adding 21.0 g of a 30% methyl isobutyl ketone liquid dispersion of crosslinked polystyrene particles of an average grain size of 3.5 μm (refractive index: 1.60) dispersed by a polytron dispersing machine at 10,000 rpm for 20 min to the solution, they were stirred by air dispersion for 10 min.

The liquid mixture was filtered by a filter made of polypropylene of 30 μm pore size to prepare a coating solution A′ for use in an anti-glare layer.

### (Preparation of Coating Solution B′ for Use in Anti-Glare Layer)

A coating solution B′ for use in an anti-glare layer was prepared in the same manner as the coating solution A′ for use in the anti-glare layer except for replacing a portion of the solvent with methyl ethyl ketone and changing the ratio of methyl isobutyl ketone to methyl ethyl ketone to 70:30. The refractive index of the layer formed of the coating solution was 1.61.

### (Preparation of Coating Solution C′ for Use in Anti-Glare Layer)

15.8 g of a commercially available zirconia-containing UV-curable hard coat solution (Desolite Z7404, manufactured by JSR Corp., solid concentration: about 61%, solvent: methyl ethyl ketone, ZrO₂ content in the solid: about 70%, polymerizable monomer, containing polymerization initiator) was added to 16 g of a mixture of dipentaerythritol pentaacrylate and dipentaerythritol hexaacrylate (DPHA, manufactured by Nippon Kayaku Co.), and diluted with 39.8 g of methyl isobutyl ketone. Further, 0.66 g of a polymerization initiator (Ilugacure 184, manufactured by Ciba Speciality chemicals Co.) was added and mixed under stirring. Successively, 0.04 g of a surface modifying fluoro-agent (EP-149), 5.2 g of a silane coupling agent (KBM-5103, manufactured by Shinetsu Chemical Industry Co.), and 0.50 g of cellulose acetate butyrate with a molecular weight of 40,000 (CAB-531-1, manufactured by Eastman Chemical Co.) were added and stirred by air dispersion for 120 min to completely dissolve solutes. The refractive index of a coating film obtained by coating the solution and by UV-ray curing was 1.57.

Finally, after adding 21.0 g of a 30% methyl isobutyl ketone liquid dispersion of crosslinked poly(acryl-styrene) particles of an average grain size of 3.5 μm (copolymer compositional ratio=30/70, refractive index: 1.561) dispersed by a polytron dispersing machine at 10,000 rpm for 20 min to the solution, they were stirred by air dispersion for 10 min.

The liquid mixture was filtered by a filter made of polypropylene of 30 μm pore size to prepare a coating solution C′ for use in an anti-glare layer.

### (Preparation of Coating Solution D′ for Use in Anti-Glare Layer)

5.9 g of a commercially available zirconia-containing UV-curable hard coat solution (Desolite Z7404, manufactured by JSR Corp., solid concentration: about 61%, solvent: methyl ethyl ketone, ZrO₂ content in the solid: about 70%, polymerizable monomer, containing polymerization initiator) was added to 22.0 g of a mixture of dipentaerythritol pentaacrylate and dipentaerythritol hexaacrylate (DPHA, manufactured by Nippon Kayaku Co.), and diluted with 43.8 g of methyl isobutyl ketone. Further, 0.91 g of a polymerization initiator (Ilugacure 184, manufactured by Ciba Speciality chemicals Co.) was added and mixed under stirring. Successively, 0.04 g of a surface modifying fluoro-agent (EP-149), 5.2 g of a silane coupling agent (KBM-5103, manufactured by Shinetsu Chemical Industry Co.), and 0.50 g of cellulose acetate butyrate with a molecular weight of 40,000 (CAB-531-1, manufactured by Eastman Chemical Co.) were added and stirred by air dispersion for 120 min to completely dissolve solutes. The refractive index of a coating film obtained by coating the solution and by UV-ray curing was 1.550.

Finally, after adding 21.0 g of a 30% methyl isobutyl ketone liquid dispersion of crosslinked poly(acryl-styrene) particles of an average grain size of 3.5 μm (copolymer compositional ratio=50/50, refractive index: 1.536) dispersed by a polytron dispersing machine at 10,000 rpm for 20 min to the solution, they were stirred by air dispersion for 10 min.

The liquid mixture was filtered by a filter made of polypropylene of 30 μm pore size to prepare a coating solution D′ for use in an anti-glare layer.

### (Preparation of Coating Solution E′ for Use in Anti-Glare Layer)

24.5 g of a commercially available zirconia-containing UV-curable hard coat solution (Desolite Z7404, manufactured by JSR Corp., solid concentration: about 61%, solvent: methyl ethyl ketone, ZrO₂ content in the solid: about 70%, polymerizable monomer, containing polymerization initiator) was added to 5.0 g of a mixture of dipentaerythritol pentaacrylate and dipentaerythritol hexaacrylate (DPHA, manufactured by Nippon Kayaku Co.), and diluted with 33.4 g of methyl isobutyl ketone. Further, 0.06 g of a polymerization initiator (Ilugacure 184, manufactured by Ciba Speciality chemicals Co.) was added and mixed under stirring. Successively, 0.04 g of a surface modifying fluoro-agent (EP-149), 5.2 g of a silane coupling agent (KBM-5103, manufactured by Shinetsu Chemical Industry Co.), and 0.50 g of cellulose acetate butyrate with a molecular weight of 40,000 (CAB-531-1, manufactured by Eastman Chemical Co.) were added and stirred by air dispersion for 120 min to completely dissolve solutes. The refractive index of a coating film obtained by coating the solution and by UV-ray curing was 1.620.

Finally, after adding 21.0 g of a 30% methyl isobutyl ketone liquid dispersion of crosslinked poly(methyl methacrylate) particles of an average grain size of 3.5 μm (crosslinking agent=containing 10% ethylene glycol dimethacrylate, refractive index: 1.492) dispersed by a polytron dispersing machine at 10,000 rpm for 20 min to the solution, they were stirred by air dispersion for 10 min.

The liquid mixture was filtered by a filter made of polypropylene of 30 μm pore size to prepare a coating solution E′ for use in an anti-glare layer.

### (Preparation of Coating Solution F′ for Use in Anti-Glare Layer)

25.0 g of a mixture of dipentaerythritol pentaacrylate and dipentaerythritol hexaacrylate (DPHA, manufactured by Nippon Kayaku Co.) was diluted with 46.3 g of methyl isobutyl ketone. Further, 1.3 g of a polymerization initiator (Ilugacure 184, manufactured by Ciba Speciality chemicals Co.) was added and mixed under stirring. Successively, 0.04 g of a surface modifying fluoro-agent (EP-149), 5.2 g of a silane coupling agent (KBM-5103, manufactured by Shinetsu Chemical Industry Co.), and 0.50 g of cellulose acetate butyrate with a molecular weight of 40,000 (CAB-531-1, manufactured by Eastman Chemical Co.) were added and stirred by air dispersion for 120 min to completely dissolve solutes. The refractive index of a coating film obtained by coating the solution and by UV-ray curing was 1.520.

Finally, after adding 22.0 g of a 30% methyl isobutyl ketone liquid dispersion of crosslinked poly(acryl-styrene) particles of an average grain size of 3.5 μm (copolymer compositional ratio=50/50, refractive index: 1.536) dispersed by a polytron dispersing machine at 10,000 rpm for 20 min to the solution, they were stirred by air dispersion for 10 min.

The liquid mixture was filtered by a filter made of polypropylene of 30 μm pore size to prepare a coating solution F′ for use in an anti-glare layer.

### (Preparation of Coating Solution G′ for Use in Anti-Glare Layer)

A coating solution G′ for use in an anti-glare layer was prepared in the same manner as the coating solution A′ for use in the anti-glare layer except for replacing a portion of a 30% methyl isobutyl ketone liquid dispersion of the crosslinked polystyrene (refractive index: 1.60) particles with an average grain size of 3.5 μm in the coating solution A′ for use in the anti-glare layer with a 30% methyl isobutyl ketone liquid dispersion of the crosslinked poly(acryl-styrene) particles (copolymerization compositional ratio=50/50, refractive index: 1.536) of 3.5 μm, and controlling the internal haze value of the obtained anti-glare and anti-reflection film to 15.8%.

### (Preparation of Coating Solution H′ for Use in Anti-Glare Layer)

A coating solution H for use in an anti-glare layer was prepared in the same manner as the coating solution A′ for use in the anti-glare layer except for replacing a portion of a 30% methyl isobutyl ketone liquid dispersion of the crosslinked polystyrene (refractive index: 1.60) particles with an average grain size of 3.5 μm in the coating solution A′ for use in the anti-glare layer with a 30% methyl isobutyl ketone liquid dispersion of the crosslinked poly(acryl-styrene) particles (copolymerization compositional ratio=50/50, refractive index: 1.536) of 3.5 μm, and controlling the internal haze value of the obtained anti-glare and anti-reflection film to 23.2%.

### (Preparation of Coating Solution I′ for Use in Anti-Glare Layer)

A coating solution I′ for use in an anti-glare layer was prepared in the same manner as the coating solution A′ for use in the anti-glare layer except for replacing a portion of a 30% methyl isobutyl ketone liquid dispersion of the crosslinked polystyrene (refractive index: 1.60) particles with an average grain size of 3.5 μm in the coating solution A′ for use in the anti-glare layer with a 30% methyl isobutyl ketone liquid dispersion of the crosslinked poly(acryl-styrene) particles (copolymerization compositional ratio=50/50, refractive index: 1.536) of 3.5 μm, and controlling the internal haze value of the obtained anti-glare and anti-reflection film to 28.8%.

### (Preparation of Coating Solution I′ for Use in Anti-Glare Layer)

A coating solution J′ for use in an anti-glare layer was prepared in the same manner as the coating solution A′ for use in the anti-glare layer except for replacing a portion of a 30% methyl isobutyl ketone liquid dispersion of the crosslinked polystyrene (refractive index: 1.60) particles with an average grain size of 3.5 μm in the coating solution A′ for use in the anti-glare layer with a 30% methyl isobutyl ketone liquid dispersion of the crosslinked poly(acryl-styrene) particles (copolymerization compositional ratio=50/50, refractive index: 1.536) of 3.5 μm, and controlling the internal haze value of the obtained anti-glare and anti-reflection film to 33.5%.

### (Preparation of Coating Solution A′ for Use in Low Refractive Index Layer)

After adding and stirring 13 g of a heat crosslinking fluoro-containing polymer with a refractive index of 1.44 containing polysiloxane and hydroxyl groups (JTA113, solid concentration: 6%, manufactured by JSR Corp.), 1.3 g of colloidal silica liquid dispersion MEK-ST-L (commercial name of products, average grain size: 45 nm, solid concentration: 30%, manufactured by Nissan Chemical Co.), 0.6 g of the sol solution described above, 5 g of methyl ethyl ketone and 0.6 g of cyclohexanone, they were filtered through a filter made of polypropylene with a 1 μm pore size to prepare a coating solution A′ for use in a low refractive index layer. The refractive index of the layer formed from the coating solution was 1.45.

### (Preparation of Coating Solution B′ for Use in Low Refractive Index Layer)

### (Preparation of Liquid Dispersion A)

The liquid dispersion A is the same as the liquid dispersion A of Example 1.

### (Preparation of Coating Solution B′)

To 783.3 mass parts of Opstar-JTA113 (heat crosslinking fluoro-containing silicone polymer compositional solution (solid content: 6%): manufactured by JSR Corp.) (47.0 mass parts as the solid content), were added 195 mass parts of the liquid dispersion A-1 (39.0 mass parts as: silica+surface treatment agent solid content), 30.0 mass parts of a colloidal silica dispersion (silica, MBK-ST of different grain size, average grain size: 45 nm, solid concentration: 30%, manufactured by Nissan Chemical Co.) (9.0 mass parts as solid content), and 17.2 mass parts of the sol solution a (5.0 mass parts as the solid content). The coating solution B′ for use in a low refractive index layer was prepared by dilution with cyclohexane and methyl ethyl ketone such that the ratio of cyclohexane and methyl ethyl ketone was 10:90. The refractive index of the layer formed from the coating solution was 1.39.

### (Preparation of Coating Solution C′ for Use in Low Refractive Index Layer)

A coating solution C′ was prepared by the same method as the coating solution B′ except for increasing the addition amount of Opstar-JTA113 (heat crosslinking fluoro-containing silicone polymer compositional solution (solid content: 6%): manufactured by JSR Corp.), and decreasing the addition amount of the liquid dispersion A to change the refractive index of the layer formed with the coating solution to 1.36.

### (Preparation of Coating Solution D′ for Use in Low Refractive Index Layer)

After adding and stirring 15.2 g of a perfluoroolefin copolymer (1), 2.1 g of a hollow silica sol (refractive index: 1.31, average grain size: 60 nm, solid concentration 20%), 0.3 g of reactive silicone X-22-164B (commercial name of products: manufactured by Shinetsu Chemical Industry Co.), 7.3 g of sol solution A, 0.76 g of a photopolymerization initiator (Ilugacure 907 (commercial name of products), manufactured by Ciba Specialty Chemicals Co.), 301 g of methyl ethyl ketone, and 9.0 g of cyclohexane, they were filtered by a filter made of polypropylene with 5 μm pore size to prepare a coating solution D′ for use in a low refractive index layer. The refractive index of the layer formed from the coating solution was 1.40.

### Example 6

### (1) Coating of Anti-Glare Layer

A triacetyl cellulose film of 80 μm thickness (TAC-TD80U, manufactured by Fuji Photofilm Inc.) was unwound from a roll form as a transparent support, the coating solution A for use in the anti-glare layer was coated by a die coat method with the device constitution and the coating conditions described below and, after drying at 30° C. for 15 sec and 90° C. for 20 sec, UV-rays at an irradiation dose of 90 mJ/cm² were irradiated under nitrogen purge by using an air-cooled metal halide lamp (manufactured by I Graphics Co.) at 160 W/cm to cure the coating layer and an anti-glare layer of 6 μm thickness having an anti-glare property was formed and wound up.

### Basic Condition:

Coating was conducted by using the coater 10 shown in FIG. 3. A slot die 13 having an upper stream lip land length I_{UP} of 0.5 mm, a down stream lip land length I_{LO} of 50 μm, the opening length of the slot 16 in the web running direction of 150 μm and a length of the slot 16 of 50 mm was used. The gap between the upstream lip land 18a and the web W was made longer by 50 μm than the gap between the downstream lip land 18b and the web W (hereinafter referred to as an overbite length of 50 μm), and the gap G_{L} between the down stream lip land 18b and web W was set to 50 μm. Further, the gap G_{S} between the side plate 40b of the pressure reduction chamber 40 and the web W, and the gap G_{B} between the back plate 40a and the web W was set each to 200 μm. In accordance with the liquid property of each of the coating solutions, coating was conducted at a coating speed=20 m/min, wet coating amount=17.5 ml/m² in a case of coating solutions A, C, D for use in the anti-glare layer, at a coating speed=40 min and at a wet coating amount=21.0 ml/m² in a case of coating solution B for use in the anti-glare layer, and at a coating speed=40 m/min. The coating width was 1300 nm and the effective width was 1280 nm.

### (2) Coating of Low Refractive Index Layer

The triacetyl cellulose film provided with the anti-glare layer by coating the coating solution A′ for use in the anti-glare layer was unwound again, the coating solution A′ for use in the low refractive index layer was coated under the basic conditions described above (at coating speed=40 m/min, wet coating amount=5.0 ml/m²) and, after drying at 120° C. for 150 sec, it was further dried at 140° C. for 8 min and UV-rays were irradiated at an irradiation dose of 300 mJ/cm² by using an air-cooled metal halide lamp at 240 W/cm (manufactured by I Graphic Co.) in an atmosphere of 0.1% oxygen concentration under nitrogen purge and a low refractive index layer of 100 nm thickness was formed and wound up.

### (3) Saponification Treatment for Anti-Reflection Film

After forming the film of the low refractive index layer, the following treatment was conducted for the specimens described above.

An aqueous 1.5 mol/L solution of sodium hydroxide was prepared and kept at a temperature of 55° C. An aqueous 0.01 mol/L solution of diluted sulfuric acid was prepared and kept at a temperature of 35° C. After dipping the prepared anti-glare anti-reflection film in the aqueous solution of sodium hydroxide for 2 min, it was dipped in water and aqueous sodium hydroxide solution was washed out sufficiently. Then, after dipping for one min in the aqueous solution of diluted sulfuric acid, it was dipped in water and the aqueous solution of diluted sulfuric acid was washed off sufficiently. Finally, the specimen was dried sufficiently at 120° C.

In this way, an anti-glare and anti-reflection film after saponification treatment was manufactured. This is Example 6-1.

An anti-glare layer was formed in the same manner as in Example 6-1 except for changing the coating solution A′ for use in the anti-glare layer to coating solutions C′, D′, F′ for use in the anti-glare layer and, further, applied with coating and saponification of the low refractive index layer were conducted in the same manner as in Example 6-1. Those coated with the coating solution C′ for use in the anti-glare layer are Example 6-2, those coated with the coating solution D′ for use in the anti-glare layer are Example 6-3, and those coated with the coating solution F′ for use in the anti-glare layer are Example 6-4

Further, those formed with an anti-glare layer in the same manner as in Example 6-1 except for changing the coating solution A′ for use in the anti-glare layer to the coating solutions E for use in the anti-glare layer and, further, applied with coating and saponification of the low refractive index layer in the same manner as in Example 6-1 are Comparative Example 6-1.

### (Evaluation for Anti-Glare Layer)

The thus obtained films were evaluated for the following item. The results shown in Table 3.

### (1) Average Reflectivity

After roughening the rear face of the film with sand paper, it was treated with a black ink to eliminate rear face reflection and, in this state, the surface was measured for specular reflectivity at an incident angle of 50 in a wavelength region for 380 to 780 nm by using a spectrophotometer (manufactured by JASCO). For the result, an arithmetic average value for the specular reflectivity at 450 to 650 nm was used.

### (2) Haze

The total haze (H), internal haze, (Hi) and surface haze (Hs) of the obtained film were measured by the following measurement.

1. The total haze value (H) of the film obtained was measured according to JIS-K-7136.

2. Silicone oil was added by several drops to the obtained film at the surface and the rear face relative to the side of the low refractive index layer, they were sandwiched by using two sheets of glass plates each of 1 mm thickness (microslide glass #S 9111, manufactured by MATSUNAMI) on the surface and the rear face, to bring the two sheets of glass plates and the obtained film into optically close contact, and the haze was measured in a state of removing the surface haze. The value obtained by subtracting the haze measured by sandwiching only the silicone oil between the two sheets of glass plates measured separately was calculated as the internal haze (Hi) of the film.

3. The value obtained by subtracting the internal haze (Hi) calculated according to 2 from the total haze (H) calculated according to 1 was calculated as the surface haze (Hs).

### (3) Image Clarity

The transparent image clarity was measured for an optical comb-width 0.5 mm according to JIS K7105.

### (4) Roughness Average Ra

The average centerline roughness Ra of the obtained film was measured according to ANSI/ASME B46, 1-1985.

### (5) Anti-Glare PropertyΩAnti-Reflection Property

An exposed fluorescence light (8000 cd/m²) with no louver was reflected on the obtained film at an angle of 45° and the degree of blurring of the reflected images and the intensity of reflection light when observed in the direction of −45° was evaluated based on the following standards.

Profile of the fluorescence lamp is not obtrusive and the intensity of the surface reflection is not obtrusive particularly: ⊚
Profile of the fluorescence lamp is not obtrusive but the intensity of the surface reflection is obtrusive slightly: ◯
Profile of the fluorescence lamp is not obtrusive but the intensity of the surface reflection is obtrusive: Δ
Profile of the fluorescence lamp was not obtrusive, but intensity of surface reflection was extremely obtrusive: Δ′
Profile of the fluorescence lamp was obtrusive: X

### (6) Blackness

Commercially available two polarizing plates were respectively stuck onto both sides of a glass substrate so that the absorption axes thereof were vertical to each other, and each of the obtained films was stuck onto one side of the polarizing plate with the support side of the film facing the polarizing plate using an adhesive. An exposed fluorescence lamp (8000 cd/m²) with no louver was reflected on the obtained film in a dark room at an angle of 60° above, and the state of black all over the surface (blackness) was visually evaluated from the front according to the following standard.

Blackness was extremely good: ⊚↑

Blackness was very good: ◯

Blackness was good: O

Blackness was somewhat bad: Δ

Blackness was not favorable: X

### (7) Internal White Turbidity

Each sample comprising the film obtained between two glass plates upon measurement of internal haze sandwiched with a silicone oil was placed in a dark room on a plane light source to evaluate the internal white turbidity of the film.

White turbidity was not obtrusive: ⊚

White turbidity was somewhat obtrusive: O

White turbidity was obtrusive: Δ

White turbidity was seriously obtrusive: X

TABLE 3

| | Average | Internal | Surface | Total | | Image | Anti-glare | | Internal |
|---|---|---|---|---|---|---|---|---|---|
| Specimen | Reflectivity | Haze | Haze | Haze | Ra | Clarity | Properties | | White |
| No. | (%) | (%) | (%) | (%) | (μm) | (%) | (%) | Blackness | Turbidity |
| Example | 1.2 | 5.2 | 5.3 | 10.5 | 0.18 | 29.0 | ⊚ | ⊚↑ | ⊚ |
| 6-1 | | | | | | | | | |
| Example | 1.4 | 6.7 | 5.1 | 11.8 | 0.17 | 28.2 | ◯ | ⊚↑ | ⊚ |
| 6-2 | | | | | | | | | |
| Example | 1.4 | 5.8 | 6.0 | 11.8 | 0.20 | 27.0 | ◯ | ⊚↑ | ⊚ |
| 6-3 | | | | | | | | | |
| Comparative | 1.2 | 42.5 | 10.1 | 52.5 | 0.22 | 9.5 | Δ | ◯ | X |
| Example | | | | | | | | | |
| 6-1 | | | | | | | | | |
| Example | 1.6 | 7.1 | 5.2 | 12.3 | 0.18 | 15.2 | Δ′ | ⊚↑ | ⊚ |
| 6-4 | | | | | | | | | |

Example 6-4 was not at a level of not causing practical problems for uses of viewing general images on a TV set in a bright room, but showed intense surface whitening by a reflected light in a bright room. It was found that, when the surface haze value exceeded 10%, there was involved some problem with respect to reflection whitening. Comparative Example 6-4 showed an intense surface reflected light and serious surface whitening. It was found that particularly preferred anti-reflection performance was obtained when the difference in refractive index between the anti-glare layer and the low refractive index layer was 0.08 or more. Example 6-4 was at a level where profile of the fluorescence lamp was not obtrusive, though showing an intense surface reflection, thus involving no practical problems.

It has been confirmed that the average centerline roughness is at a value between 0.15 and 0.30 μm for each of Examples 6-1 to 6-3.

Further, in a case of preparing an anti-glare and anti-reflection film 6-5 in the same manner except for replacing the coating solution A′ for use in the low refractive index layer in Example 6-1 with the coating solution B′ for use in the low reflective index layer, the average reflectivity was improved to 0.6%, and anti-glare properties and blackness were more improved.

Further, in a case of preparing an anti-glare and anti-reflection film 6-6 in the same manner except for replacing the coating solution A′ for use in the low refractive index layer in Example 6-1 with the coating solution C′ for use in the low reflective index layer, the average reflectivity was improved to 0.5%, and anti-glare properties and blackness were more improved.

Further, in a case of preparing an anti-glare and anti-reflection film 6-7 in the same manner except for replacing the coating solution A′ for use in the low refractive index layer in Example 6-1 with the coating solution D′ for use in the low reflective index layer, and changing the irradiation dose of UV-rays after coating to 900 mJ/cm², the average reflectivity was improved to 0.7%. Further, the scratch resistance could be improved.

An anti-glare layer was formed in the same manner as in Example 6-1 except for changing the coating solution A′ for use in the anti-glare layer to the coating solutions G′, H′, I′, and I′ for use in the anti-glare layer and, further, application of coating and the saponification of the low refractive index layer was conducted in the same manner as in Example 6-1. Those coated with the coating solution G′ for use in the anti-glare layer are Example 6-8, those coated with the coating solution H′ for use the in anti-glare layer are Example 6-9, those coated with the coating solution I′ for use in the anti-glare layer are Example 6-10, and those coated with the coating solution J′ for use in the anti-glare layer are Example 6-11. The average reflectivity for the films of Examples 6-8 to 6-11 was 1.2.

### Example 7

A polarizing plate was manufactured by bonding for protection a triacetyl cellulose film (TAC-TD80U, manufactured by Fuji Photofilm Inc.) of 80 μm thickness which was dipped in an aqueous 1.5 mol/L NaOH solution at 55° C. for 2 min and then neutralized and washed with water, and each of anti-glare and anti-reflection films prepared in Example 6 (after saponification treatment: Example 6-1 to Example 6-11, Comparative Example 6-1) to polarization films each prepared from polyvinyl alcohol by adsorption of iodine and stretching. They are Example 7-1 to Example 7-11 and Comparative Example 7-1, respectively.

Further, a polarizing plate was manufactured by using the triacetyl cellulose film after the saponification treatment for the protective films on both surfaces. This is Comparative Example 7-2.

### Example 8

### Evaluation for Polarizing Plate

Display devices were manufactured by peeling a portion of a polarizing plate in each of liquid crystal television sets on the viewing surface and replacing the portion with polarizing plates of Example 7-1 to Example 7-11, Comparative Example 7-1 to Comparative Example 7-2, manufactured in Example 7 by the combination as shown in the following Table 4. They were Example 8-1 to Example 8-11, and Comparative Example 8-1 to Comparative Example 8-3. Evaluation of the following items was conducted for the obtained display devices. The result is shown in Table 4.

### (1) Dark Room Contrast

For LCD panels having fineness and image size described in the table (each of VA mode), the polarizing plates on the side of the surface were replaced (repapered) with polarizing plates each using two sheets of TAC films ((TAC-TD80U, manufactured by Fuji Photofilm Inc.) having smooth surface as the protective film (Comparative Example 6-3), and the front contrast was measured in a dark room.

Successively, the front contrast was measured in the same manner while being replaced with each of the polarizing plates of Example 7 and Comparative Example 5 and the lowering ratio of the front contrast relative to the contrast value measured for the polarizing plate using the smooth TAC film as the protective film was evaluated on the percentage.

(2) Dazzling

In a state of solid green display on the LCD panels having fineness and images size described in the table, the degree of a state where partial enlargement/contraction for each of B, G, and R pixels was observed not uniformly (dazzling) was evaluated visually based on the following standards.

Dazzling was not observed at all, and favorable: ⊚
Dazzling was slightly observed but relatively favorable: ◯
Dazzling was somewhat obtrusive: Δ
Dazzling was remarkable and not favorable: X

### (3) Image Reflection

An exposed fluorescence lamp (8000 cd/m²) with no louver was reflected on the obtained liquid crystal television set at an angle of 45° and the degree of reflection of the fluorescence lamp observed in the direction of −45° was evaluated based on the following standards.

Not reflected to such an extent as the profile of the fluorescence lamp could not be recognized at all, surface reflection was extremely small: ⊚
Not reflected to such an extent as the profile of the fluorescence lamp could not be recognized distinctly: ◯
The profile of the fluorescent lamp could not be recognized clearly but the reflection amount at the surface is slightly obtrusive: Δ
The profile of the fluorescent lamp could not be recognized clearly but the reflection amount at the surface is obtrusive: X
The fluorescence lamp was reflected completely: XX

TABLE 4

| | | | | Dark room | | |
|---|---|---|---|---|---|---|
| | | | | contrast | | |
| Specimen | Polarizing | Panel size | Panel | lowering | | Image |
| No. | plate | (inch) | fineness | ratio (%) | Dazzling | reflection |
| Example 8-1 | Example 7-1 | 32 | VGA | −1 | ⊚ | ◯ |
| Example 8-2 | Example 7-2 | 32 | VGA | −1 | ⊚ | ◯ |
| Example 8-3 | Example 7-3 | 32 | VGA | −2 | ⊚ | Δ |
| Example 8-4 | Example 7-4 | 32 | VGA | −1 | ⊚ | ◯ |
| Example 8-5 | Example 7-5 | 32 | VGA | −1 | ⊚ | ⊚ |
| Example 8-6 | Example 7-6 | 32 | VGA | −1 | ⊚ | ⊚ |
| Example 8-7 | Example 7-7 | 32 | VGA | −1 | ⊚ | ⊚ |
| Comp. | Comp. | 32 | VGA | −14 | ⊚ | ◯ |
| Example 8-1 | Example 7-1 | | | | | |
| Example 8-8 | Example 7-8 | 32 | VGA | −3 | ⊚ | X |
| Comp. | Comp. | 32 | VGA | 0 (standard) | ⊚ | XX |
| Example 8-2 | Example 7-2 | | | | | |
| Example 8-9 | Example 7-1 | 20 | XGA | −1 | ◯ | ◯ |
| Example 8-10 | Example 7-1 | 45 | XGA | −2 | ⊚ | ◯ |

In a case of using polarizing plates of Example 7-8 to Example 7-11 manufactured in Example 7 instead of the polarizing plate (Example 7-1) used in Example 8-1, the lowering ratio of the dark room contrast was −6%, −8%, −10%, and −11%, respectively and the dark room contrast was favorable compared with that of Comparative Example 8-1 although inferior to that of Example 8-1.

From the result shown in Table 4, the followings can be seen.

The anti-glare and anti-reflection film according to the invention can provide compatibility between high anti-glare property, and lowering of the worsening for the dark room contrast and improvement of dazzling when it is applied to liquid crystal television sets of 20 inch or greater.

### Example 9

In a case of using a view field angle extending film (wide view film SA 12B, manufactured by Fuji Photofilm Co. Ltd.) as the protective film for the polarizing plate on the side of the liquid crystal cell on the viewing surface and as a protective film of the polarizing plate on the side of the liquid crystal cell on the back light surface of a transmission type TN liquid crystal cells, liquid crystal display devices with an extremely wide view field angle in the vertical and right-to-left directions, extremely excellent in the visibility and at high image quality could be obtained.

### Reference Example

An anti-glare layer and a low refractive index layer of Example 6-1 were coated by a bar coat method. While a No. 10 bar was used for the anti-glare layer and a No. 2.9 bar was used for the low refractive index layer, streak-like planar unevenness occurred in the anti-glare layer at a coating speed of 15 m/min or more and streak-like planar unevenness occurred in the low refractive index layer at a coating speed of 20 m/min or more.

### Example 10

In a case of replacing JTA113 for the coating solutions A, B and C for use in the low refractive index layer in Example 6 with a solution formed by dissolving 80 g of a fluoro-containing heat-curing polymer, 20 g of Cymel 303 (manufactured by Nippon Cytec Industries Inc.) as a curing agent and 2.0 g of a CATALYST 4050 (manufactured by Nippon Cytec Industries Inc.) as a curing catalyst dissolved in MEK by 6% as described in Example 1 of JP-A No. 11-189621, the same result as described above was obtained.

### Example 11

### Synthesis of Perfluoroolefin Copolymer (1″))

Perfluoroolefin copolymer (1″) is the same as the Perfluoroolefin copolymer (1) of Example 1.

### (Preparation of Sol Solution)

The sol solution is the same as the sol solution of Example 1.

### (Preparation of Coating Solution A″ for Use in Anti-Glare Layer)

25.4 g of a mixture of dipentaerythritol pentaacrylate and dipentaerythritol hexaacrylate (DPHA, manufactured by Nippon Kayaku Co.) was diluted with 52.6 g of methyl isobutyl ketone. Further, 1.3 g of a polymerization initiator (Ilugacure 184, manufactured by Ciba Speciality chemicals Co.) was added and mixed under stirring. Successively, 0.04 g of a surface modifying fluoro-agent (FP-149), 5.2 g of a silane coupling agent (KBM-5103, manufactured by Shinetsu Chemical Industry Co.), and 0.50 g of cellulose acetate butyrate with a molecular weight of 40,000 (CAB-531-1, manufactured by Eastman Chemical Co.) were added and stirred by air dispersion for 120 min to completely dissolve solutes. The refractive index of a coating film obtained by coating the solution and by UV-ray curing was 1.520.

Finally, after adding 21.0 g of a 30% methyl isobutyl ketone liquid dispersion of crosslinked poly(acryl-styrene) particles of an average grain size of 3.5 μm (copolymer compositional ratio=50/50, refractive index: 1.536) dispersed by a polytron dispersing machine at 10,000 rpm for 20 min to the solution, they were stirred by air dispersion for 10 min.

The liquid mixture was filtered by a filter made of polypropylene of 30 μm pore size to prepare a coating solution A″ for use in an anti-glare layer.

(Preparation of Coating Solution B″for Use in Anti-Glare Layer) A coating solution B″ for use in an anti-glare layer was prepared in the same manner as the coating solution A″ for use in the anti-glare layer except for changing methyl isobutyl ketone (vapor pressure at 21.7° C.: 16.5 mmHg) used as the main solvent from 52.6 g to 46.3 g, and adding 6.3 g of propylene glycol (vapor pressure at 20.0° C.: 0.08 mmHg) as the small amount solvent having hydroxyl groups.

### (Preparation of Coating Solution C″ for Use in Anti-Glare Layer)

11.4 g of a mixture of dipentaerythritol pentaacrylate and dipentaerythritol hexaacrylate (DPHA, manufactured by Nippon Kayaku Co.) was diluted with 25.7 g of methyl isobutyl ketone and 38.1 g of colloidal silica liquid dispersion MiBK-ST (commercial name of products, average grain size: 15 nm, solid concentration: 30%, manufactured by Nissan Chemical Co.) was added. Further, 1.2 g of a polymerization initiator (Ilugacure 184, manufactured by Ciba Speciality chemicals Co.) was added and mixed under stirring. Successively, 0.04 g of a surface modifying fluoro-agent (EP-149), 4.7 g of a silane coupling agent (KBM-5103, manufactured by Shinetsu Chemical Industry Co.), and 0.50 g of cellulose acetate butyrate with a molecular weight of 40,000 (CAB-531-1, manufactured by Eastman Chemical Co.) were added and stirred by air dispersion for 120 min to completely dissolve solutes. The refractive index of a coating film obtained by coating the solution and by UV-ray curing was 1.500.

Finally, after adding 18.9 g of a 30% methyl isobutyl ketone liquid dispersion of crosslinked poly(methyl methacrylate) particles of an average grain size of 3.0 μm (containing 10% crosslinking agent=ethylene glycol methacrylate, refractive index: 1.492) dispersed by a polytron dispersing machine at 10,000 rpm for 20 min to the solution, they were stirred by air dispersion for 10 min.

The liquid mixture was filtered by a filter made of polypropylene of 30 μm pore size to prepare a coating solution C″ for use in an anti-glare layer.

### (Preparation of Coating Solution D″ for Use in Anti-Glare Layer)

A coating solution D″ for use in an anti-glare layer was prepared in the same manner as the coating solution A″ for use in the anti-glare layer except for changing the crosslinked poly(acryl-styrene) particle with an average grain size of 3.5 μm (copolymer compositional ratio=50/50 refractive index 1.530) to crosslinked polystyrene particles (refractive index 1.607) and crosslinked poly(acryl-styrene) particles (copolymer compositional ratio=30/70 refractive index 1.570) respectively each to 12.5 g using the same liquid dispersion.

### (Preparation of Coating Solution A″ for Use in Low Refractive Index Layer)

After adding and stirring 13 g of a heat crosslinking fluoro-containing polymer with a refractive index of 1.44 containing polysiloxane and hydroxyl groups (JTA113, solid concentration: 6%, manufactured by JSR Corp.), 1.3 g of colloidal silica liquid dispersion MEK-ST-L (commercial name of products, average grain size: 45 nm, solid concentration: 30%, manufactured by Nissan Chemical Co.), 0.6 g of the sol solution a 5 g of methyl ethyl ketone and 0.6 g of cyclohexanone, they were filtered through a filter made of polypropylene with a 1 μm pore size to prepare a coating solution A″ for use in a low refractive index layer. The refractive index of the layer formed from the coating solution was 1.45.

### (Preparation of Coating Solution B″ for Use in Low Refractive Index Layer)

### (Preparation of Liquid Dispersion A)

The liquid dispersion A is the same as the liquid dispersion A of Example 1.

### (Preparation of Coating Solution B″)

To 783.3 mass parts of Opstar-JTA113 (heat crosslinking fluoro-containing silicone polymer compositional solution (solid content: 6%): manufactured by JSR Corp.) (47.0 mass parts as the solid content)), were added 195 mass parts of the liquid dispersion A (39.0 mass parts as: silica+surface treatment agent solid content), 30.0 mass parts of a colloidal silica dispersion (silica, MEK-ST of different grain size, average grain size: 45 nm, solid concentration: 30%, manufactured by Nissan Chemical Co.) (9.0 mass parts as solid content)), and 17.2 mass parts of the sol solution a (5.0 mass parts as the solid content). The coating solution B″ for use in a low refractive index layer was prepared by dilution with cyclohexane and methyl ethyl ketone such that the ratio of cyclohexane and methyl ethyl ketone was 10:90. The refractive index of the layer formed from the coating solution was 1.39.

### (Preparation of Coating Solution C″ for Use in Low Refractive Index Layer)

After adding and stirring 15.2 g of a perfluoroolefin copolymer (1″), 2.1 g of a hollow silica sol (refractive index: 1.31, average grain size: 60 nm, solid concentration 20%), 0.3 g of reactive silicone X-22-164B (commercial name of products: manufactured by Shinetsu Chemical Industry Co.), 7.3 g of the sol solution A, 0.76 g of a photopolymerization initiator (Ilugacure 907 (commercial name of products), manufactured by Ciba Specialty Chemicals Co.), 301 g of methyl ethyl ketone, and 9.0 g of cyclohexane, they were filtered by a filter made of polypropylene with 5 μm pore size to prepare a coating solution C″ for use in a low refractive index layer. The refractive index of the layer formed from the coating solution was 1.40.

### (1) Coating of Anti-Glare Layer

A triacetyl cellulose film of 80 μm thickness (TAC-TD80U, manufactured by Fuji Photofilm Inc.) was unwound from a roll form, the coating solution A″ for use in the anti-glare layer was coated by a die coat method with the device constitution and the coating conditions described below and, after drying at 30° C. for 15 sec and 90° C. for 20 sec, UV-rays at an irradiation dose of 90 mJ/cm² were irradiated under nitrogen purge by using an air-cooled metal halide lamp (manufactured by I Graphics Co.) at 160 W/cm to cure the coating layer and an anti-glare layer of 6 μm thickness having an anti-glare property was formed and wound up.

### Basic Condition:

A slot die 13 having an upper stream lip land length I_{UP} of 0.5 mm, a down stream lip land length I_{LO} of 50 μm, the opening length of the slot 16 in the web running direction of 150 μm and a length of the slot 16 of 50 mm was used. The gap between the upstream lip land 18a and the web W was made longer by 50 μm than the gap between the downstream lip land 18b and the web W (hereinafter referred to as an overbite length of 50 μm), and the gap G_{L} between the down stream lip land 18b and web W was set to 50 μm. Further, the gap G_{S} between the side plate 40b of the pressure reduction chamber 40 and the web W, and the gap G_{B} between the back plate 40a and the web W was set each to 200 μm. In accordance with the liquid property of each of the coating solutions, coating was conducted at a coating speed=20 m/min, and at a wet coating amount=17.5 ml/m² in a case of coating solutions A″, C″, D″ for use in the anti-glare layer, at a coating speed=40 min/min and at a wet coating amount=17.3 ml/m² in a case of coating solution B″ for use in the anti-glare layer, and at a coating speed=40 m/min, and at a wet coating amount=5.0 ml/m² for the low refractive index layer. The coating width was 1300 nm and the effective width was 1280 nm.

### (2) Coating of Low Refractive Index Layer

The triacetyl cellulose film provided with the anti-glare layer by coating the coating solution A″ for use in the anti-glare layer was unwound again, the coating solution A for use in the low refractive index layer was coated under the basic conditions described above and, after drying at 120° C. for 150 sec, it was further dried at 140° C. for 8 min and UV-rays were irradiated at an irradiation dose of 300 mJ/cm² by using an air-cooled metal halide lamp at 240 W/cm (manufactured by I Graphic Co.) in an atmosphere of 0.1% oxygen concentration under nitrogen purge and a low refractive index layer of 100 nm thickness was formed and wound up.

### (3) Saponification Treatment for Anti-Reflection Film

After forming the film of the low refractive index layer, the following treatment was conducted for the specimens described above.

An aqueous 1.5 mol/L solution of sodium hydroxide was prepared and kept at a temperature of 55° C. An aqueous 0.01 mol/L solution of diluted sulfuric acid was prepared and kept at a temperature of 35° C. After dipping the prepared anti-glare anti-reflection film in the aqueous solution of sodium hydroxide for 2 min, it was dipped in water and aqueous sodium hydroxide solution was washed out sufficiently. Then, after dipping for one min in the aqueous solution of diluted sulfuric acid, it was dipped in water and the aqueous solution of diluted sulfuric acid was washed off sufficiently. Finally, the specimen was dried sufficiently at 120° C.

In this way, an anti-glare and anti-reflection film after saponification treatment was manufactured. This is Example 11-1.

An anti-glare layer was formed in the same manner as in Example 12-1 except for changing the coating solution A″ for use in the anti-glare layer to coating solutions B″, C″, D″ for use in the anti-glare layer and, further, coating and application of coating and saponification of the low refractive index layer was conducted in the same manner as in Example 11-1. Those coated with the coating solution B″ for use in the anti-glare layer are Example 11-2, those coated with the coating solution C″ for use in the anti-glare layer are Example 11-3, and those coated with the coating solution D″ for use in the anti-glare layer are Example 11-4.

### (Evaluation for Anti-Glare Layer)

The thus obtained films were evaluated for the following items. The result is shown in Table 5.

### (1) Reflection Photogoniometer

To both surface and rear face of a glass plate of 1 mm thickness (microslide glass #S 9111, manufactured by MATSUNAMI), polarizing plates each with a smooth surface were bonded in crossed nichols, and an anti-glare and anti-reflection film of the invention was bonded to one side thereof at the surface opposite to the side coated with an anti-reflection layer by an adhesive sheet to manufacture a sample piece for measurement. Successively, an incident light amount I₀ in a case with no sample piece was measured at first by using “Goniophotometer” manufactured by Murakami Kizai Kenkyusho Co.

Successively, the amount of reflection light was measured each by 0.1° stepwise in a range from 40° to 50° relative to an incident light of optical amount I₀ being inclined at −60° relative to the perpendicular direction from the side of the low refractive index layer of the sample piece while setting the incident angle to −60°, and numerical values were read for the light amount I^{45°} reflected to the direction inclined at 45°, light amount I^{50°} reflected in the direction inclined at 50°, and the light amount I^{40°} reflected in the direction inclined at 40° to calculate values for −LOG₁₀(I/I₀) at respective angles.

### (2) Average Reflectivity

After roughening the rear face of the film with sand paper, it was treated with a black ink to eliminate rear face reflection and, in this state, the surface was measured for specular reflectivity at an incident angle of 50 in a wavelength region for 380 to 780 nm by using a spectrophotometer (manufactured by JASCO). For the result, an arithmetic average value for the specular reflectivity at 450 to 650 nm was used.

### (3) Haze

The total haze (H), internal haze, (Hi) and surface haze (Hs) of the obtained film were measured by the following measurement.

[1] The total haze value (H) of the film obtained was measured according to JIS-K-7136.

[2] Silicone oil was added by several drops to the obtained film at the surface and the rear face relative to the side of the low refractive index layer, they were sandwiched by using two sheets of glass plates each of 1 mm thickness (microslide glass #S 9111, manufactured by MATSUNAMI) on the surface and the rear face, to bring the two sheets of glass plates and the obtained film into optically close contact completely, and the haze was measured in a state of removing the surface haze. The value obtained by subtracting the haze measured by sandwiching only the silicone oil between the two sheets of glass plates measured separately was calculated as the internal haze (Hi) of the film.

[3] The value obtained by subtracting the internal haze (Hi) calculated according to (2) from the total haze (H) calculated according to (1) was calculated as the surface haze (Hs).

### (4) Image Clarity

The transparent image clarity was measured for an optical comb-width 0.5 mm according to JIS K 7105.

(5) Roughness Average Ra

The Roughness Average Ra of the obtained film was measured according to ANSI/ASME B46, 1-1985.

### (6) Anti-Glare Property

An exposed fluorescence lamp (8000 cd/m²) with no louver was reflected on the sample piece for use in photogoniometer measurement at an angle of 45° and the degree of blurring of the reflected images when observed in the direction of −45′ was evaluated based on the following standards.

Profile of the fluorescence lamp could not be observed at all: ⊚
Profile of the fluorescence lamp could be observed slightly: ◯
The fluorescence lamp blurred but the profile could be discriminated: Δ
The fluorescence lamp scarcely blurred: X

### (7) Blackness

Commercially available two polarizing plates were respectively stuck onto both sides of a glass substrate so that the absorption axes thereof were vertical to each other, and each of the obtained films was stuck onto one side of the polarizing plate with the support side of the film facing the polarizing plate using an adhesive. An exposed fluorescence lamp (8000 cd/m²) with no louver was reflected on the obtained film in a dark room at an angle of 60° above, and the state of black all over the surface (blackness) was visually evaluated from the front according to the following standard.

Blackness was extremely good: ⊚↑

Blackness was very good: ⊚

Blackness was good: O

Blackness was somewhat bad: Δ

Blackness was not favorable: X

### (8) Internal White Turbidity

Each sample comprising the film obtained between two glass plates upon measurement of internal haze sandwiched with a silicone oil was placed in a dark room on a plane light source to evaluate the internal white turbidity of the film.

White turbidity was not obtrusive: ⊚

White turbidity was somewhat obtrusive: O

White turbidity was obtrusive: Δ

White turbidity was seriously obtrusive: X

TABLE 5

| | | Average | Internal | Surface | Total | | Image | Anti-glare | | Internal |
|---|---|---|---|---|---|---|---|---|---|---|
| | −LOG₁₀(I/I₀) | Reflectivity | Haze | Haze | Haze | Ra | Clarity | Properties | | White |
| Specimen No. | 40°/45°/50° | (%) | (%) | (%) | (%) | (μm) | (%) | (%) | Blackness | Turbidity |
| Example | 5.0/4.5/3.7 | 1.8 | 10.0 | 5.2 | 15.2 | 0.13 | 27.3 | ◯ | ⊚ | ⊚ |
| 11-1 | | | | | | | | | | |
| Example | 5.0/4.5/3.7 | 1.8 | 10.2 | 4.9 | 15.1 | 0.13 | 27.2 | ◯ | ⊚ | ⊚ |
| 11-2 | | | | | | | | | | |
| Example | 4.9/4.3/3.6 | 1.7 | 5.1 | 6.2 | 11.3 | 0.15 | 22.0 | ⊚ | ◯ | ⊚ |
| 11-3 | | | | | | | | | | |
| Example | 4.7/3.9/3.3 | 1.7 | 38.5 | 11.0 | 47.0 | 0.20 | 11.5 | ⊚ | Δ | Δ |
| 11-4 | | | | | | | | | | |

Further, while the sample piece used for the photogoniometer showed appearance approximate to the black indication of the panel since the reflection light at the rear face is cut by the crossing polarizing plate, the sample pieces of Examples 11-1 to 11-3 were decreased for white blurring in visual observation and appeared as tight black. On the other hand, the sample piece of Example 11-4 glistened white from the vicinity of the specular reflection to a region with deviation of axis and showed an appearance approximate to white blurring.

Further, when an anti-glare and anti-reflection film was prepared in the same manner except for replacing the coating solution A″ for use in the low refractive index layer of Example 12-1 with the coating solution B″ for use in the low refractive index layer, the average reflectivity was improved to 1.2%.

Further, when an anti-glare and anti-reflection film was prepared in the same manner except for replacing the coating solution A″ for use in the low refractive index layer of Example 12-1 with the coating solution C″ for use in the low refractive index layer and for changing the drying time after the coating to 1 minute at 90° C. and changing the irradiation dose of the UV-rays after the coating to 900 mJ/cm², the average reflectivity was improved to 1.5%. Further, the scratch resistance could be improved.

### Example 12

### Preparation of Polarizing Plate

A polarizing plate was manufactured by bonding for protection a triacetyl cellulose film (TAC-TD80U, manufactured by Fuji Photofilm Co.) of 80 μm thickness which was dipped in an aqueous 1.5 mol/L of NaOH solution at 55° C. for 2 min and then neutralized and washed with water, and each of anti-glare and anti-reflection films prepared in Example 1 (after saponification: Example 11-1 to Example 11-4) on both surfaces of a polarization film prepared from polyvinyl alcohol by adsorption of iodine and stretching. They are Example 12-1 to Example 12-4, respectively.

Further, a polarizing plate was manufactured by using the triacetyl cellulose film after the saponification treatment for the protective films on both surfaces. This is Comparative Example 12-1.

### Example 13

### Evaluation for Polarizing Plate

Display devices were manufactured by peeling a portion of a polarizing plate in each of liquid crystal television sets on the viewing surface and replacing the portion with polarizing plates of Example 12-1 to Example 12-4 and Comparative Example 12-1 manufactured in Example 12 by the combination as shown in the following Table 6. Evaluation of the following items was conducted for the obtained display devices. The result is shown in Table 6.

### (1) White Blurring

For LCD television panels (VA mode) having the fineness and the image size described in the table, the polarizing plate on the surface was replaced (repapered) with the polarizing plate using two TAC films with smooth surface as the protective film and under the black indication for the entire surface, an exposed fluorescence lamp (8000 cd/m²) with no louver was reflected at the angle of 60° from above in a dark room and white glistening state (white blurring) on the entire surface upon visual observation from the front was evaluated by the following standard.

White blurring was not obtrusive, which is favorable: ⊚
White blurring is obtrusive slightly but relatively favorable: ◯
White blurring is obtrusive somewhat: Δ
White blurring was remarkable and not favorable: X

### (2) Dark Room Contrast

The front contrast was measured in a dark room by using the LCD panels manufactured in (1) above.

Successively, the front contrast was measured in the same manner while being replaced with each of the polarizing plates of Example 2 and Comparative Example 2 and the lowering ratio of the front contrast relative to the contrast value measured for the polarizing plate using the smooth TAC film as the protective film was evaluated on the percentage. For example, the contrast values for Example 3-1 and Comparative Example 3-2 were 882, and 868 respectively, in which the lowering ratio was: (882−868)/882×100=2% and this is expressed as −2% in the table.

### (3) Dazzling

In a state of solid green display on the LCD panels having fineness and images size described in the table, the degree of a state where partial enlargement/contraction for each of B, G, and R pixels was observed not uniformly (dazzling) was evaluated visually based on the following standards.

Dazzling was not observed at all and favorable: ⊚
Dazzling was slightly observed but relatively favorable: ◯
Dazzling was somewhat obtrusive: Δ
Dazzling was remarkable and not favorable: X

### (4) Image Reflection

An exposed fluorescence lamp (8000 cd/m²) with no louver was reflected on the obtained liquid crystal television set at an angle of 45° and the degree of reflection of the fluorescence lamp observed in the direction of −45° was evaluated based on the following standards.

Not reflected to such an extent as the profile of the fluorescence lamp could not be recognized at all: ⊚
The profile of the fluorescent lamp was slightly recognized but not reflected substantially: ◯
The profile of the fluorescent lamp was blurred but slightly reflected: Δ
The fluorescence lamp was reflected completely: X

TABLE 6

| | | | | | Dark room | | |
|---|---|---|---|---|---|---|---|
| | | | | | contrast | | |
| | | Panel | | | lowering | | |
| | | size | Panel | White | ratio | | Image |
| Specimen No. | Polarizing plate | (inch) | fineness | blurring | (%) | Dazzling | reflection |
| Example 13-1 | Example 12-1 | 32 | VGA | ⊚ | −2 | ⊚ | ◯ |
| Example 13-2 | Example 12-2 | 32 | VGA | ⊚ | −2 | ⊚ | ◯ |
| Example 13-3 | Example 12-3 | 32 | VGA | ◯ | −1 | ⊚ | ⊚ |
| Example 13-4 | Example 12-4 | 32 | VGA | X | −11 | ⊚ | ⊚ |
| Comp. | Comp. | 32 | VGA | ⊚ | 0 (standard) | ⊚ | X |
| Example 13-1 | Example 12-1 | | | | | | |

From the result shown in Table 6, the followings can be seen.

The anti-glare and anti-reflection film according to the invention can decrease white blurring in black display and can provide compatibility between high anti-glare property, and lowering of the worsening for the dark room contrast and improvement of dazzling when it is applied to liquid crystal television sets of 20 inch or greater. Example 13-4 was not at a level of exerting detrimental influence for uses of viewing general images on a TV set, but was suffered serious white blurring, serious reduction in dark room contrast, and deterioration of contrast in a dark environment.

### Example 14

In a case of using a view field angle extending film (wide view film SA 12B, manufactured by Fuji Photofilm Co. Ltd.) as the protective film of the polarizing plate on the side of the liquid crystal cell on the viewing surface and as the protective film of the polarizing plate on the side of the liquid crystal cell on the back light surface of a transmission type TN liquid crystal cells, liquid crystal display devices with an extremely wide view field angle in the vertical and right-to-left directions, extremely excellent in the visibility and at high image quality could be obtained.

### Reference Example

An anti-glare layer and a low refractive index layer of Example 11-1 were coated by a bar coat method. While a No. 10 bar was used for the anti-glare layer and a No. 2.9 bar was used for the low refractive index layer, streak-like planar unevenness occurred in the anti-glare layer at a coating speed of 15 m/min or more and streak-like planar unevenness occurred in the low refractive index layer at a coating speed of 20 m/min or more.

### Example 15

### Preparation of Coating Solution E″ for Use in Anti-Glare Layer)

31 g of a mixture of dipentaerythritol pentaacrylate and dipentaerythritol hexaacrylate (PET 30, manufactured by Nippon Kayaku Co.) was diluted with 38 g of methyl isobutyl ketone. Further, 1.5 g of a polymerization initiator (Ilugacure 184, manufactured by Ciba Speciality chemicals Co.) was added and mixed under stirring. Successively, 0.04 g of a surface modifying fluoro-agent (FP-149), and 6.2 g of a silane coupling agent (KBM-5103, manufactured by Shinetsu Chemical Industry Co.) were added. The refractive index of a coating film obtained by coating the solution and by UV-ray curing was 1.520.

Finally, 39.0 g of a 30% cyclohexanone liquid dispersion of crosslinked poly(acryl-styrene) particles of an average grain size of 3.5 μm (copolymer compositional ratio=50/50, refractive index: 1.540) dispersed by a polytron dispersing machine at 10,000 rpm for 20 min was added to the solution to prepare a final solution.

The liquid mixture was filtered by a filter made of polypropylene of 30 μm pore size to prepare a coating solution E″ for use in an anti-glare layer.

### (Preparation of Coating Solution F″ for Use in Anti-Glare Layer)

31 g of a mixture of dipentaerythritol pentaacrylate and dipentaerythritol hexaacrylate (PET 30, manufactured by Nippon Kayaku Co.) was diluted with 38 g of methyl isobutyl ketone. Further, 1.5 g of a polymerization initiator (Ilugacure 184, manufactured by Ciba Speciality chemicals Co.) was added and mixed under stirring. Successively, 0.04 g of a surface modifying fluoro-agent (FP-149), and 6.2 g of a silane coupling agent (M-5103, manufactured by Shinetsu Chemical Industry Co.) were added. The refractive index of a coating film obtained by coating the solution and by UV-ray curing was 1.520.

Finally, 26.0 g of a 30% cyclohexanone liquid dispersion of crosslinked poly(acryl-styrene) particles of an average grain size of 3.5 μm (copolymer compositional ratio=50/50, refractive index: 1.540) dispersed by a polytron dispersing machine at 10,000 rpm for 20 min was added to the solution to prepare a final solution.

The liquid mixture was filtered by a filter made of polypropylene of 30 μm pore size to prepare a coating solution F″ for use in an anti-glare layer.

An anti-glare layer was formed in the same manner as in Example 11-1 except for changing the anti-glare coating solution A″ to the anti-glare coating solutions E″, F″ and, further, application of coating and saponification of the low refractive index layer was conducted in the same manner as in Example 11-1. Those coated with the coating solution E″ for used in the anti-glare layer are Example 16-1 and those coated with the coating solution F″ for used in the anti-glare layer are Example 16-2.

Table 7 shows the result of evaluation for Examples 16-1, 16-2 as the sample of the invention in the same manner as in Example 12.

TABLE 7

| | | Average | Internal | Surface | Total | | Image | Anti- |
|---|---|---|---|---|---|---|---|---|
| | −LOG₁₀(I/I₀) | reflectivity | haze | haze | haze | Ra | clarity | glare |
| Specimen No. | 40°/45°/50° | (%) | (%) | (%) | (%) | (μm) | (%) | property |
| Example 16-1 | 4.9/4.2/3.6 | 1.80 | 28.0 | 7.6 | 34.6 | 0.17 | 17.0 | ⊚ |
| Example 16-2 | 4.8/4.1/3.5 | 1.70 | 23.1 | 8.9 | 31.0 | 0.16 | 17.0 | ⊚ |

### Example 17

Polarizing plates manufactured from Examples 16-1 to 16-2 in the same method as in Example 12 as the specimens of the invention are Examples 17-1 and 17-2.

### Example 18

Further, evaluation was conducted on Examples 17-1 and 17-2 as the polarizing plates by the same method as in Example 13. The results are shown in Table 8.

TABLE 8

| | | | | | Dark | | |
|---|---|---|---|---|---|---|---|
| | | | | | room | | |
| | | | | | contrast | | |
| | | Panel | | | lowering | | |
| | Polarizing | size | Panel | White | ratio | | Image |
| Specimen | plate | (inch) | fineness | blurring | (%) | Dazzling | reflection |
| Example | Example 17-1 | 32 | VGA | ◯ | −7 | ⊚ | ⊚ |
| 18-1 | | | | | | | |
| Example | Example 17-2 | 32 | VGA | ◯ | −6 | ⊚ | ⊚ |
| 18-2 | | | | | | | |

### Example 19

### Reinforcement of Agglomerated Silica

### [Preparation of Coating Solutions A″′ and B″′ for Use in Anti-Glare Layer]

TABLE 9

Name of
Coating Solution

| | | |
|---|---|---|
| Name of Starting Material | A″′ | B″′ |

| | | | |
|---|---|---|---|
| Binder | PET-30 | 22.5 | 20.00 |
| | DPHA | 22.5 | 20.00 |
| Particles | Agglomeratable | — | 5.00 |
| | silica (secondary | | |
| | agglomerate size: | | |
| | 1.5 μm) | | |
| Initiator | Irgacure 184 | 1.00 | 1.00 |
| | Irgacure 907 | 0.20 | 0.20 |
| Leveling agent | FP-7 | 0.08 | 0.08 |
| Solvent | Methyl isobutyl | 45.00 | 45.00 |
| | ketone | | |
| | Cyclohexanone | 10.00 | 10.00 |

Coating solutions A″′ and B″′ for use in anti-glare layer were prepared according to the above table. Numerals in the table are % by weight. Additionally, PET-30 is a mixture of pentaerythritol triacrylate and pentaerythritol tetraacrylate [manufactured by Nippon Kayaku K.K.], DPHA is a mixture of dipentaerythritol hexaacrylate and dipentaerythritol pentaacrylate [manufactured by Nippon Kayaku K.K.], mono-disperse silica is SEAHOSTAR KE-P150 of 1.5 μm in particle size [manufactured by Nippon Shokubai K.K.], agglomeratable silica has a secondary agglomeration size of 1.5 μm (primary particle size: several-ten nm) [manufactured by Nippon Silica K.K.], Ilugacure 184 is a polymerization initiator [manufactured by Ciba Specialty Chemicals], and Ilugacure 907 is a polymerization initiator [manufactured by Ciba Specialty Chemicals]. Each solution having been sufficiently mixed was filtered through a polypropylene-made filter of 30 μm in pore size to complete coating solutions A″′ and B″′ for use in anti-glare layer.

An anti-glare layer was formed in the same manner as with Example 1-1 except for changing the coating solution A for use in anti-glare layer to the coating solution B″′ for use in anti-glare layer and changing the coated amount thereof to a cured thickness of 2.6 μm. Further, a low refractive index layer was provided by coating and saponification treatment was conducted in the same manner as with Example 1-1 to prepare Example 19-1.

Comparative Example 19-1 was prepared in the same manner as with Example 19-1 except for changing the coating solution B″′ for use in anti-glare layer to the coating solution A″′ for use in anti-glare layer.

Examples 19-2 to 19-4 and Comparative Example 19-2 different from each other in surface haze value were prepared in the same manner as with Example 19-1 except for changing the coating amount of the coating solution B″′ for use in anti-glare layer used for Example 19-1 to thereby change the film thickness.

The anti-glare films were evaluated in the same manner as with Example 1-1. Results are shown in Table 10.

TABLE 10

| | Average | Internal | Surface | Total | | Image | Anti- | | Internal |
|---|---|---|---|---|---|---|---|---|---|
| | Reflectivity | Haze | Haze | Haze | | Clarity | glare | | White |
| | (%) | (%) | (%) | (%) | Ra | (%) | Properties | Blackness | Turbidity |
| Comparative | 2.7 | 0 | 0 | 0 | 0.01 | 99 | X | ⊚ | ⊚ |
| Example | | | | | | | | | |
| 19-1 | | | | | | | | | |
| Example | 2.2 | 2 | 1 | 3 | 0.08 | 52 | Δ | ⊚ | ⊚ |
| 19-1 | | | | | | | | | |
| Example | 2.0 | 2 | 4 | 6 | 0.14 | 26 | ◯ | ⊚ | ⊚ |
| 19-2 | | | | | | | | | |
| Example | 1.8 | 2 | 6 | 8 | 0.16 | 23 | ◯ | ◯ | ⊚ |
| 20-3 | | | | | | | | | |
| Example | 1.6 | 2 | 11 | 13 | 0.19 | 17 | ⊚ | Δ | ⊚ |
| 19-4 | | | | | | | | | |
| Comparative | 0.9 | 1 | 25 | 26 | 0.31 | 10 | ⊚ | X | ⊚ |
| Example | | | | | | | | | |
| 19-2 | | | | | | | | | |

Polarizing plates (Examples 20-1 to 20-4 and Comparative Examples 20-1 and 20-2) were prepared in the same manner as with Example 2-1 using the anti-glare films of Examples 19-1 to 19-4 and Comparative Examples 19-1 and 19-2, and were evaluated in the same manner as with Example 3-1. Results of the evaluation are shown in Table 11.

TABLE 11

| | | | | | Dark | | |
|---|---|---|---|---|---|---|---|
| | | Panel | | | Room | | |
| | Polarizing | Size | Panel | White | Contrast | | Image |
| Specimen No. | plate | (inch) | Fineness | Blurring | (%) | Dazzling | Reflection |
| Comparative | Comparative | 32 | VGA | ⊚ | 0 | ⊚ | X |
| Example | Example | | | | | | |
| 21-1 | 20-1 | | | | | | |
| Example | Example | 32 | VGA | ⊚ | −1 | ⊚ | Δ |
| 21-1 | 20-1 | | | | | | |
| Example | Example | 32 | VGA | ⊚ | −1 | ⊚ | ◯ |
| 21-2 | 20-2 | | | | | | |
| Example | Example | 32 | VGA | ◯ | −1 | ⊚ | ◯ |
| 21-3 | 20-3 | | | | | | |
| Example | Example | 32 | VGA | X | −1 | ⊚ | ⊚ |
| 21-4 | 20-4 | | | | | | |
| Comparative | Comparative | 32 | VGA | XX | 0 | ⊚ | ⊚ |
| Example | Example 20-2 | | | | | | |
| 21-2 | | | | | | | |
| Example | Example 20-1 | 20 | XGA | ⊚ | −1 | ⊚ | Δ |
| 21-5 | | | | | | | |
| Example | Example 20-2 | 20 | XGA | ⊚ | −1 | Δ | ◯ |
| 21-6 | | | | | | | |
| Example | Example | 20 | XGA | ◯ | −1 | Δ | ◯ |
| 21-7 | 20-3 | | | | | | |
| Example | Example | 20 | XGA | X | 0 | X | ⊚ |
| 21-8 | 20-4 | | | | | | |

As is clear from Table 11, all samples of Examples gave good evaluation results. Although Examples 21-4 and 21-8 showed deteriorated white blurring and therefore suffered some influences for use in a bright room, it was at a level of causing no practical problems. Although Example 21-8 gave some dazzling and was not favorable, it involved no problems for uses of viewing general images on a TV set. Comparative Example 21-1 gave image reflection at a level not suited for practical use. Comparative Example 21-3 gave white blurring at a level of not suited for practical use. Comparative Examples 21-1 and 21-2 were at a level not practically usable for uses of viewing general images on a TV set.

### INDUSTRIAL APPLICABILITY

The invention provides an anti-glare film or an anti-reflection film capable of decreasing of the worsening of the contrast in a dark room, improving the dazzling, suppressing the surface whitening in a bright room and preventing the transfer of reflected images to the surface.

Further, the invention provides a manufacturing method capable of manufacturing the film at a high productivity.

Further, the present invention provides a polarizing plate, an image display device, particularly, a liquid crystal display device using the film capable of decreasing of the worsening of the contrast in a dark room, improving for dazzling, suppression of surface whitening in a bright room and prevention of image reflecting in the surface.

The entire disclosure of each and every foreign patent application from which the benefit of foreign priority has been claimed in the present application is incorporated herein by reference, as if fully set forth.

1. A film comprising:
a transparent support; and
an anti-glare layer having a haze value due to internal scattering of from 0 to 40% and a haze value due to surface scattering of from 0.3 to 20%.

2. A film according to claim 1, further comprising a low refractive index layer,
wherein the transparent support, the anti-glare layer and the low refractive index layer are provided in this order.

3. A film according to claim 1,
wherein the anti-glare layer has the haze value due to the internal scattering of from 5 to 30% and the haze value due to surface scattering of from 1 to 15%.

4. A film according to claim 1, which has Roughness Average Ra of from 0.03 to 0.35 μm.

5. A film according to claim 4, wherein the Roughness Average Ra is from 0.08 to 0.30 μm.

6. A film according to claim 1, which has an average top-to-bottom distance Sm of from 50 to 150 μm.

7. A film according to claim 1, which has an image clarity, according to JIS K 7105, of from 5 to 90% as measured at an optical comb width of 0.5 mm.

8. A film according to claim 7, wherein the image clarity according to JIS K 7105 is from 5 to 30% as measured at an optical comb width of 0.5 mm.

9. A film according to claim 1,
wherein the anti-glare layer comprises a translucent resin and fine translucent particles, and
the translucent resin comprises three or higher functional (meth)acrylate monomer as a main ingredient.

10. A film according to claim 9,
wherein at least one kind of fine translucent particles with an average particle size of from 0.5 to 10 μm are dispersed in the translucent resin.

11. A film according to claim 9,
wherein the fine translucent particles are contained by 3 to 30 mass % in the entire solid content of the anti-glare layer.

12. A film according to claim 9,
wherein an absolute value for the difference in refractive index between the fine translucent particles and the translucent resin is from 0.001 to 0.050.

13. A film according to claim 9,
wherein the fine translucent particles are acrylic particles, styrene particles, or acrylic-styrene particles.

14. A film according to claim 13,
wherein the fine translucent particles comprise a crosslinked poly(meth)acrylate polymer with an acrylic content of from 50 to 100 mass %.

15. A film according to claim 9,
wherein at least one kind of fine inorganic particles are contained in the anti-glare layer, and
at least one of said at least one kind of the fine inorganic particles has a refractive index higher than that of the translucent resin.

16. A film according to claim 6,
wherein at least one kind of fine inorganic particles are contained in the anti-glare layer, and
at least one of said at least one kind of the fine inorganic particles has a refractive index lower than that of the translucent resin.

17. A film according to claim 1,
wherein the anti-glare layer is formed by using a solvent comprising plural kinds of solvents,
the plural kinds of solvents comprise a main solvent not dissolving the transparent support and a small amount solvent, and
weight ratio between the main solvent and the small amount solvent is between 99:1 and 50:50.

18. A film according to claim 1,
wherein the anti-glare layer has a refractive index (na) of 1.50 or more.

19. A film according to claim 18,
wherein the anti-glare layer has the refractive index (na) of 1.55 or more.

20. A film according to claim 9,
wherein the fine translucent particles comprise a crosslinked poly(styrene-acryl) copolymer with a styrene content of from 50 to 100 mass %.

21. A film according to claim 2,
wherein the low refractive index layer comprises a fluoro-containing compound containing fluorine atoms within a range from 35 to 80 mass % and containing a crosslinkable or polymerizable functional group.

22. A film according to claim 2,
wherein a curing composition used upon forming the low refractive index layer is a composition containing at least two of a fluoro-containing compound, fine inorganic particles and an organosilane compound.

23. A film according to claim 22,
wherein the low refractive index layer comprises fine inorganic particles, and
the fine inorganic particles has an average particle size of 10% or more and 100% or less of a thickness of the low refractive index layer.

24. A film according to claim 22,
wherein the fine inorganic particles comprises, as a main ingredient, silicon oxide having a hollow structure and having a refractive index of from 1.17 to 1.40.

25. A film according to claim 2,
wherein the low refractive index layer has an refractive index (nb) of 1.45 or less.

26. A film according to claim 1,
wherein at least one of the anti-glare layer and the low refractive index layer comprises at least one member selected from the group consisting of organosilane, hydrolyze of the organosilane and partial condensate of the hydrolyzate of the organosilane.

27. A film according to claim 1, further comprising a transparent conductive layer,
wherein the transparent conductive layer is present between the anti-glare layer and the transparent support, or between the anti-glare layer and the low refractive index layer.

28. A film according to claim 1, further comprising a transparent conductive layer between the anti-glare layer and the transparent support,
wherein the anti-glare layer comprises conductive particles.

29. A film according to claim 2,
wherein a difference na−nb between a refractive index (na) of the anti-glare layer and a refractive index (nb) of the low refractive index layer is 0.08 or more and 0.35 or less.

30. A film according to claim 1,
wherein a light amount I^{45°} reflected in a direction inclined at +45° relative to a light amount I₀ which is incident being inclined at −60° relative to a vertical direction from the side of the low refractive index layer satisfies the following equation (1):
5.0≧LOG₁₀(I^{45°}/I₀)≧3.8 Equation (1)

31. A film according to claim 30,
wherein a light amount I^{50°} reflected in a direction inclined at +50° and a light amount I^{40°} reflected in the direction being inclined at +40° relative to the light amount I₀ satisfy the following equations (2) and (3):
4.0≧LOG₁₀(I^{50°}/I₀)≧3.0 Equation (2)
5.5>−LOG₁₀(I^{40°}/I₀)≧4.5 Equation (3)

32. A method of manufacturing a film according to claim 1 comprising:
coating a coating composition for use in an anti-glare layer containing fine translucent particles, a translucent resin and a solvent and/or a coating composition for use in a low refractive index layer while bringing a land at a top end lip of a slot die closer to a surface of a web of the transparent support running continuously being supported by a back-up roll, from a slot of the top end lip, to coat the anti-glare layer and/or low refractive index layer on the transparent support.

33. A polarizing plate comprising:
a polarization film; and
two protective films attached to both of a front face and a rear face of the polarization film to protect the front and rear faces,
wherein one of the two protective films is a film according to any one of claim 1.

34. A polarizing plate according to claim 33,
wherein one of the two protective films is a film comprising:
a transparent support; and
an anti-glare layer having a haze value due to internal scattering of from 0 to 40% and a haze value due to surface scattering of from 0.3 to 20%;
and the other one of the two protective films is an optical compensation film.

35. An image display device comprising a film comprising:
a transparent support; and
an anti-glare layer having a haze value due to internal scattering of from 0 to 40% and a haze value due to surface scattering of from 0.3 to 20%;
or a polarizing plate according to claim 33.

36. A liquid crystal display device comprising at least one of a film comprising:
a transparent support; and
an anti-glare layer having a haze value due to internal scattering of from 0 to 40% and a haze value due to surface scattering of from 0.3 to 20%;
and a polarizing plate according to claim 33.
